(19) United States
(12) Patent Application Publication
(10) Pub. No.: US 2013/0141428 A1
(43) Pub. Date: Jun. 6, 2013

(54) COMPUTER-IMPLEMENTED APPARATUS, SYSTEM, AND METHOD FOR THREE DIMENSIONAL MODELING SOFTWARE

(71) Applicant: Dale L. Gipson, Bonney Lake, WA (US)

(72) Inventor: Dale L. Gipson, Bonney Lake, WA (US)

(21) Appl. No.: 13/679,660

(22) Filed: Nov. 16, 2012

Related U.S. Application Data
(60) Provisional application No. 61/561,695, filed on Nov. 18, 2011.
(60) Provisional application No. 61/666,707, filed on Jun. 29, 2012.

(51) Int. Cl. G06T 15/00

(52) U.S. Cl. 345/419

(57) ABSTRACT

A computer-implemented method, computer-readable medium, and a system for building a 3D interactive environment are disclosed. In one aspect, the computer includes a processor and a memory coupled to the processor. According to the method, the processor generates first and second 3D virtual spaces. A portal graphics engine links the first and second 3D virtual spaces using a portal. The portal causes the first and second 3D virtual spaces to interact as a single, continuous zone.

### CROSS REFERENCE TO RELATED APPLICATIONS

This application claims the benefit, under 35 U.S.C. §119(e), of U.S. provisional patent application Nos. 61/561,695, filed Nov. 18, 2011, entitled “COMPUTER-IMPLEMENTED APPARATUS, SYSTEM AND METHOD FOR THREE DIMENSIONAL MODELING SOFTWARE” and 61/666,707, filed Jun. 29, 2012, entitled “COMPUTER-IMPLEMENTED APPARATUS, SYSTEM AND METHOD FOR THREE DIMENSIONAL MODELING SOFTWARE.”

### TECHNICAL FIELD

The present disclosure pertains to improvements in the arts of computer-implemented user environments, namely three-dimensional interactive environments.

### BACKGROUND

Three-dimensional (3D) virtual reality (VR) environments have been available to computer users in various forms for many years now. Many video games employ 3D virtual reality techniques to create a type of realism that engages the user, and many people find that a 3D presentation is more appealing than a flat (or 2D) presentation, such as that common in most websites. A 3D environment is an attractive way for users to interact online, such as, for online commerce, viewing data, social interaction, and most other online user interactions. Many attempts have been made to employ 3D environments for such purposes, but there have been technical limitations, resulting in systems that may be visually attractive, but ineffective for the users.

One problem of VR lies in the fact that the user in a 3D environment inherently has a “line of sight” field of view. They see in one direction at a time. Anything that happens on the user's behalf will only be noticeable to them when it happens within their field of vision. The user, however, may not notice the change when something changes outside the user's field of view. More importantly, the user should not have to search around to try to notice a change. To be effective, the user must notice a change, and to notice it, it must lie within the user's field of view.

The problem with 3D virtual reality interfaces is not the basic 3D display. It is the communication with the user, in a way that is consistent with the virtual reality being presented. When the user has to “leave” the illusion of the 3D environment to perform some action, much of the effectiveness of the interface is lost. As an example, suppose a user is doing an online commerce transaction. The user wishes to purchase a product, and some accessories to go with it. They can choose a product, perhaps by selecting it on a virtual shelf with a mouse click. Using a mouse click is a simple, well-established technique, and easy to implement on modern computer systems.

A problem with current 3D VR displays lies in how to display possible product accessories due to the distance and field of view. When an online store has a large number of products, many with possible accessories, displaying them in a 3D world is difficult, for example, due to the use of space it would take to display all of the products and accessories. Any solution that involves changing the display to offer such accessories must be visible to the user, from the angle they are looking and within proximity to the product the user has chosen. If the contents of the shelf were changed to show the accessories, the user might not notice as the change may occur off-screen. If the contents of the shelf were rearranged, a new problem of when to switch the contents of the shelf back to its original form is introduced. Any modification of the user's environment has consequences, and this has been the great limitation of 3D environments for online commerce.

A further complication is that the field of view is a function of how far away a user is from the thing that they are trying to see. In order for the users to see what is being offered or suggested, it is necessary for the user to be far enough back that the view angle encloses what needs to be seen. This in turn requires that the room or spatial area be large enough that the user can back up enough to get the proper field of view. Any spatial areas that are used for display must be quite large so that a user can obtain the proper field of view, which can force distortions of the shape of spatial areas to accommodate the necessary distances to let the user see the displayed content.

A common solution in past user interface designs has been the notion of a menu, such as a right-mouse click context menu. While such a system can be effective in offering the user simple contextual choices, it breaks the illusion created by the virtual reality environment. Even more importantly, a two-dimensional (2D) menu has limited visual real-estate upon which to display user choices. A 3D display is capable of displaying a far greater number of simultaneous choices, and choices of greater complexity. A menu interface defeats much of the power of a 3D VR interface.

Another problem that has reduced the effectiveness of 3D environments has been the need to have some pre-existing physical layout. There have been a number of solutions to creating 3D environments for purposes such as “virtual stores,” or even “virtual malls.” These solutions usually require someone to create a logical layout for such a store or mall. But what is a logical layout for one person may not be for another. Such systems rarely allow the user to customize the virtual store or mall to suit their tastes, because of the problem of the physical proximity of the rooms or stores to each other. When a new room or store is added, there is a layout decision as to where locate it, where to put the door to it, and what happens to the other rooms or stores nearby; and conversely, what to do with the door when a room or store is removed. It becomes even more complicated when the user wants to add a store next to another, but whose orientation is rotated to a different angle. These decisions are generally too complex to put in front of a casual online user.

A further complication is that to create a working layout for a spatial complex, such as a (virtual) store, mall, city, building or other virtual structures, it is necessary to arrange the components (rooms, stores, floors etc) in a way that a user can move from one to another in an easy manner. But placing large rooms next to each other cause layout issues. For example, a small room surrounded by much larger rooms would have to have long corridors to reach them. This is because the larger rooms require space, and cannot overlap each other. So for example, creating constructs such as “virtual malls” will often lead to frustrating experiences for the users, as the layout of one store might affect the location, position, and distance of the store from other stores. Making custom changes to such a virtual mall would be far too complicated for the average user. It is even more difficult to create and add rooms or stores dynamically, as it requires modification or distortion of the user environment, which can be quite disturbing to the user.

Another complication is that modern user interfaces often require communication with other external remote resources, such as, users and data sites in a form of shared environment. The shared environment may require presenting the external remote resources as if they were part of the user's local environment. Examples of these kinds of remote resources include but are not limited to: social networking sites, external online stores, web pages, and other remote network content. In a 3D VR environment, these remote resources must be integrated with the local environment in a form that is visually compatible with the 3D effect. For example, full integration of two network sites in a 3D environment would require that the users be able to see into and move freely between the two sites in the same manner that they would between two locations within their local site.

External resources are controlled remotely and the local environment has no control over the external resources' shapes, access points, or physical orientations. The local environment must integrate the external resources in whatever layout and orientation those resources require. In most cases, orientation of the external resources causes spatial conflicts, of which only some can be resolved using well-defined interface standards.

Another complication with remote resources such as websites is that the VR must interact with the external resource's components in the same manner as it does with its own components. This requires not just displaying images, but establishing a communication link to the remote resource so that content and user interaction can be exchanged.

What is needed is a 3D VR environment without the need to predefine any layouts and the ability to attach new content or resources as needed. What is needed is a way to present choices to the user that are always directly in their line of sight, specific to what they are trying to achieve at that moment, and flexible enough that the user can easily decide what they want to see or not see.

### SUMMARY

The present disclosure solves the problem of presenting choices and results of actions that remain within the user's field of view in a 3D virtual reality environment by creating and opening virtual doorways or “portals” directly in front of where the user is looking, in place of that location's current contents, in a way that will restore those contents when the portal is closed.

The present disclosure also provides a mechanism for integrating new local or remote resources to the existing 3D VR environment, by creating a portal to the new local or remote resource, without modifying the current 3D layout.

In one embodiment, a computer-implemented method for building a 3D interactive environment is provided. The computer comprises a processor and a memory coupled to the processor. According to one embodiment of the method, the processor generates a first 3D virtual space and a second 3D virtual space. A portal graphics engine links the first and second 3D virtual spaces using a portal. The portal causes the first and second 3D virtual spaces to interact as a single, continuous zone.

### BRIEF DESCRIPTION OF THE DRAWINGS

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1 shows a typical layout problem when adding rooms in a three-dimensional (3D) environment.

FIG. 2 shows a typical layout problem involving three rooms.

FIGS. 3A-3B show a prior art solution to the layout problem of FIG. 2.

FIG. 4 shows a typical layout problem involving four rooms.

FIGS. 5A-5B show a field of view distance problem encountered in 3D environments.

FIG. 6 shows a prior art solution to the field of view distance problem.

FIG. 7 shows a layout of three-dimensional environment incorporating the solution of FIG. 6

FIGS. 8A-8C show one embodiment of a solution to the field of view problem using portals.

FIGS. 9A-9D show one embodiment of a solution to the four-room layout problem using portals.

FIGS. 10A-10E show one embodiment of joining two zones using a portal.

FIGS. 10E-10G show one embodiment of joining two zones using a portal defined on a panel.

FIG. 11 shows one embodiment of a Portal Graphics Engine architecture.

FIG. 12 shows one embodiment of a relationship between site, zone and plan objects.

FIG. 13 shows one embodiment of the use of item image maps and item records.

FIGS. 14A-14B show one embodiment of a 3D environment which uses cell values for determining cell behavior.

FIGS. 15A-15B show one embodiment of a portal record.

FIG. 16 shows one embodiment of event-driven processing.

FIG. 17 shows one embodiment of a real-time ray-trace timer loop.

FIG. 18 shows one embodiment of a perspective rendering of a user view.

FIG. 19 shows one embodiment of a ray-trace screen slicing algorithm.

FIGS. 20 and 21 show one embodiment of a 2D low-resolution ray-trace.

FIG. 22 shows one embodiment of a perspective determination for wall height as seen by a user.

FIGS. 23A-23B show one embodiment of a ray-tracing algorithm modified to interact with portals.

FIG. 24A shows one embodiment of a user view utilizing a ray-tracing technique modified to interact with portals.

FIG. 24B shows one embodiment of a user view utilizing a ray-tracing technique modified to interact with surface portals

FIGS. 25-26 show one embodiment of a user view in a 3D virtual reality room with an open portal.

FIGS. 27A-27B show one embodiment of the change in a user view when a portal is opened.

FIGS. 28A-28B show one embodiment of a semi-transparent wall to indicate the presence of a portal.

FIGS. 29A-29J show one embodiment of a junction room.

FIGS. 30A-30H show one embodiment of an exit junction room.

FIGS. 31A-31G show one embodiment of the method of generating a 3D virtual reality space implemented as an online storefront.

FIGS. 32A-320 show one embodiment of the method of generating a 3D virtual reality space using an icon on a portal to indicate the portal's open/close status.

FIGS. 33A-33H show one embodiment of a virtual store comprising a Home Zone (Lobby) starting with closed doors which may open as a user approaches the doors.

FIG. 33I shows one embodiment of a virtual store Home Zone (Lobby) having a four-sided kiosk.

FIGS. 34A-C show one embodiment of a “Console” window provided for the user, that allows direct access to specific areas.

FIGS. 35A-35B show one embodiment of the results of content displayed from a Console query, near a wall.

FIG. 36A shows one embodiment of a console window display where the console window is used to open a portal that is far from a wall.

FIG. 36B shows one embodiment of a display where a portal opens to a Results Room in the middle of the room, directly in front of the user.

FIGS. 37A-37E show one embodiment of a user opening a portal to a different website, entering the portal, and interacting with the different website.

FIGS. 38A-38D show one embodiment of a component object moving automatically in response to a user action.

FIGS. 38E-38M show one embodiment of a component object moving independently as an avatar.

FIG. 39 shows one embodiment of a computing device which can be used in one embodiment of the system and method for creating a 3D virtual reality environment.

### DETAILED DESCRIPTION

The present disclosure describes embodiments of a method and system for generating three-dimensional (3D) virtual reality (VR) spaces and connecting those spaces. In particular, the present disclosure is directed towards embodiments of a method and system for linking 3D VR spaces through the use of one or more portals.

It is to be understood that this disclosure is not limited to the particular aspects or embodiments described, and as such may vary. It is also to be understood that the terminology used herein is for the purpose of describing particular aspects or embodiments only, and is not intended to be limiting, since the scope of the method and system for generating and linking 3D VR spaces using portals is defined only by the appended claims.

In one embodiment, the present disclosure provides a method and system for generating and linking 3D virtual reality spaces using one or more portals. A portal is a dynamically created doorway that leads to another 3D location, or “zone.” In one embodiment, the portal is created in a wall. In another embodiment, a portal may be created in open space. The other zone may be a room or corridor in a local environment or a remote environment. The portal joins the two zones (or locations) together in a seamless manner, so that a user may move freely between the two zones and see through to the other zone as if it were located adjacent to the current zone. The other zone may serve many different kinds of purposes, such as offering users choices, presenting results of user actions, or providing an interactive environment for a user. In one embodiment, a portal may be opened directly in front of the user, regardless of where the user is or what the user is facing at the moment. In one embodiment, by opening a portal in the user's line of sight into a zone having a necessary depth to display content from the user's current location, the use of portals may solve the distance problem of keeping visual presentations within the user's field of view. A portal may restore the portal location's original content when closed, allowing a practical means to implement a wide range of user interface features.

It will be appreciated that 3D virtual reality spaces according to the present disclosure may be shown within the user's line of sight (field of vision), with a view distance that allows the user to see the content. In one aspect, the portals connect rooms and zones, as described hereinbelow. In one embodiment, portals attempt to open directly in front of the user, such that a forward motion will bring the user to the content.

In one embodiment of a 3D environment, a portal may be opened within a wall. The portal may open to a spatial area that exists within the current zone (space), and is constrained to fit within the zones remaining space. In another embodiment, portals may open to other zones of arbitrary size and location, as the other zones do not lie within the physical space of the current zone. In this embodiment, the portal may be a splice between the two locations.

By opening a portal directly in front of the user, the user can clearly see the portal and see into the portal, which solves the problem of ensuring that the user will notice any changes. The zone that the portal opens to can have arbitrary depth, content, or choices and can be presented to users with a distance that is appropriate to the angle of the user's field of vision, and will therefore be visible to the user. Because a portal can open to a potentially large space, the same kind of contextual choices that might have appeared on a drop-down context menu can be presented as doorways, hallways, rooms, other spaces, shapes or objects visible through a portal door, with a degree of sophistication not possible in a drop-down menu. Some or all of such choices may be visible to a user as they lie directly in the user's line of sight. Additionally, those choices may remain open and available to the user for later access, which is not possible in a drop-down menu. In one embodiment, one or more portals may create a visually engaging alternative to software menus for presenting the user with choices.

In one embodiment, a portal may behave like a “magic door.” The portal may allow a user to pass through and see through the portal into a physically remote space, with the effect that the user is able to move and see through what is essentially a hole in space. To help the user understand the generation and placement of a portal, a portal may display as a semi-transparent “ghost” image, such as a semi-transparent image of the original wall the portal opened into. A portal may open to, for example, any size space or room, a store, a website, or any other type of area. Portals present visual and physical anomalies, as a portal may open to a location that appears to occupy the same space as the room which the user is currently in.

Portals have a unique property in that they can connect two locations or “zones” which are completely independent of each other, and only occupy a minimal amount of space within either zone, regardless of the spatial size of either. While the portal itself occupies a small amount of space within each zone, the second zone past the portal occupies no space at all within the first one. A user who moves through a portal is transported to the second zone. In one embodiment, the second zone does not exist at all within the space occupied by the first zone, and so uses no space within the first zone. The magical aspect to portals is that the visual scenes within each zone are also transported across the portal, so that the two zones appear to be adjacent to each other, when in fact they are not.

The fact that zones connected through portals use no space in the other zone allows construction of complex physical layouts without those zones (e.g. rooms) colliding with one another. A room within one zone can have portals to any number of other zones, each of arbitrary size. In a traditional 3D environment, large rooms next to each other would require large hallways or other connectors to space the large rooms away from each other. In a 3D world with portals across zones, portals use no space in the original zone and therefore the zones do not compete with each other for space. Portals solve the problem of complex architectural layout, as no predefined layout is necessary, because zones do not intersect with other zones.

In one embodiment, a portal may be created at any time on any wall or in any open space. Portals need not be pre-defined and may be created as needed. The flexibility of portals allows users to traverse to other locations from any point, by creating portals on-the-fly. Because portals can be created as needed, the result is that any point in the 3D VR spatial area can link to any other point in a local or remote 3D special areal, at any time.

In one embodiment, a spatial region, such as a wall or open space, may have any number of portals to any number of other zones. In this embodiment, only one of the portals may be open at a specific spatial region at any given time. A portal can be closed and another portal opened in the first portal's place. The second portal may connect to a different one than the first portal. By opening and closing portals in the same spatial area, there may be a large number of portals available to the user at a given point, without consuming any permanent amount of space in the current zone.

The physical anomalies possible with portals may be disconcerting, as a portal may not follow the rules of a three-dimensional world. For example, if a zone has a first portal leading to a first zone next to a second portal leading to a second zone on the same wall, a user may have a field of view allowing the user to “see” into a room in the first zone and a room in the second one at the same time. The first zone and the second zone may visually project into one another. The first and second zones may appear to overlap each other visually, and the user may look though one portal for a distance that would clearly lie inside of the other room if both rooms were located in the same zone. But the zones (and therefore the rooms) do not physically overlap, because they exist in different spaces. The effect may be disorienting to a user, as the visual anomalies may appear to violate the laws of a physical 3D world. Portals may, in effect, jump through space, making the 3D VR world appear to be a four-dimensional (4D) world, with the portal operating as a “wormhole.”

In one embodiment, the “wormhole”-like nature of the portal may allow disjoint objects or places to be joined together temporarily or permanently. Like a wormhole, a portal may not only traverse space, but a portal may also change orientation. In one embodiment, for example, a portal in a first room in zone “A” on a wall on the first room's East side could connect to a counterpart portal in a second room in zone “B” on a wall on the second room's South side. The portal would not only translate the coordinates between the two zones, but would also rotate the coordinates (and therefore the user's orientation) according to the difference of the angles of the two walls. To the user, there may appear to be no angle change; the user merely sees straight ahead.

A Portal may have other properties that mimic a wormhole effect. In one embodiment, a portal may be “one-way.” A one-way portal may allow a user to pass through the portal in one direction, but encounter a solid wall if attempting to pass through in the opposite direction. A one-way portal may be created, as once a user enters a portal, the user has changed physical locations (zones). The new location may not have a return portal in the same position as where the user arrives in the zone. For example, a portal in the middle of a room might be semi-transparent on all sides (so that it can be seen), and a user may enter the portal from any angle. Once a user passes through the portal, the user is no longer inside of the original room but has been transported to a new zone. In one embodiment, the new location may have one exit door which leads back to where the user came from. The exit door may be located in a different part of the new zone than where the user entered the zone. A user may pass through a portal that is a passable doorway on one side, and an impassible wall on the other.

A Portal may provide a mechanism by which new content, in the form of additional zones, may be added to a current user 3D environment. Because portals may eliminate the possibility of overlap between zones and rooms within the zones, the new zone may have any arbitrary size without conflicting with any other currently existing zones or requiring a change in the layout of the current zone. Because the portal can be closed after use, large sections of walls or other space may be opened as a single portal, without permanently modifying the original environment. This provides a simple mechanism for presenting data to a user, with a varying size view angle depending on the presented data, by creating a zone (room) for the data and opening a portal to the created zone. In one embodiment, zones may be created to take the place of menus. A zone may be generated with hallways, doorways, items on walls and/or objects inside of the rooms, which may comprise one or more portal locations leading to additional zones or presenting additional choices. Zones can be created to display results. For example, results of a user query may be displayed in a generated room, connected by a portal. The results may be displayed in a visually striking way, such as displaying the results upon the walls of the generated room and/or as objects within the generated room. New zones may be created for a variety of purposes and in any number. Portals may be closed and re-opened, operating similar to a door. A Portal Graphics Engine 4 may store the locations and connections of one or more portals. When a portal is closed, the original content at the portal's location may be restored.

In one embodiment, a portal may be opened anywhere, and therefore the actual shape of the user's environment may not be fixed. The actual shape of a user's 3D environment may depend upon what that user did during that session. For example, in a traditional “virtual mall,” the layout may include “stores” that the user never visits. Using portals, the user need only see the “stores” (zones/rooms) that the user actually uses. In effect, the “mall” may be built up as the user goes about the user's tasks. It is not necessary to pre-design the layout of a 3D environment using portals; the user may create a layout as the user interacts with the environment, specific to the user's choices and preferences.

In one embodiment, a user may create a personal environment that has multiple purposes, such as, but not limited to, a combination of favorite stores, portals to one or more 3D sites of friends in a social network, one or more special zones for special purposes such as picture galleries or displaying personal data, or any other suitable zone. Whereas a 2D website can only show one page of content at a time, a personal environment created with portals can display many types of content simultaneously, with some visible close-up, and some at a distance.

In one embodiment, a portal may be opened in any location, such as, for example, the middle of a wall, the middle of a room or at the location of an object. The portal may lead to any location, such as, for example, a room within the current zone, a room in a different zone, or a remote website. The new locations may be created dynamically when the portal is generated or may exist statically separate from the 3D environment.

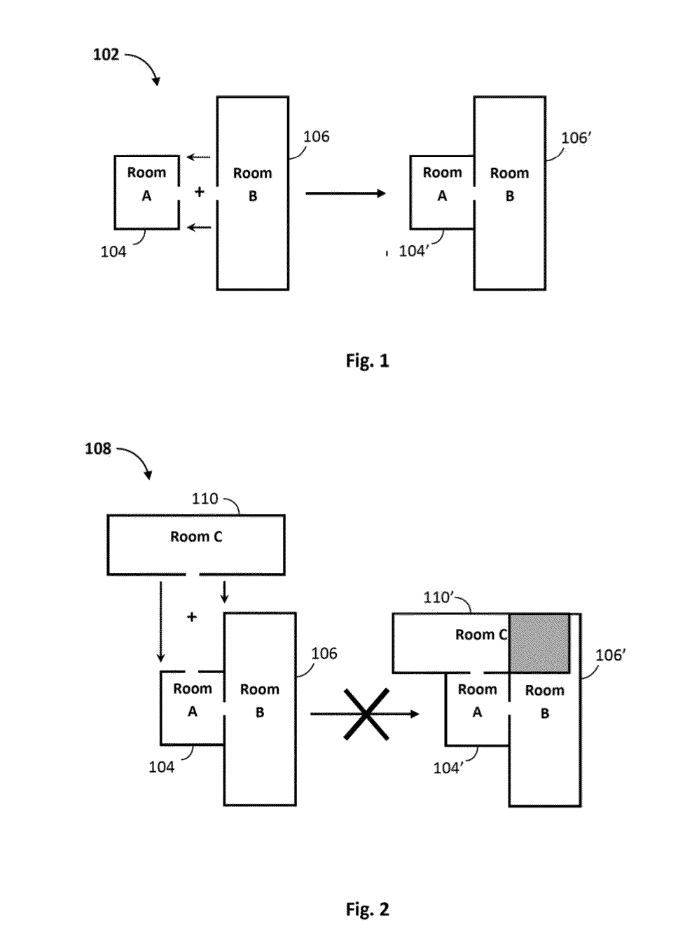

FIG. 1 shows a typical layout problem for adding additional rooms in a 3D environment. In a two-room layout 102, two rooms may be joined together without interference. Room A 104 is smaller than Room B 106 and can be attached to Room B 106 at any point without causing an overlap of Room A 104 and Room B 106. A connection of Room A 104′ and Room B 106′ is shown. However, in a three-room layout 108, as shown in FIG. 2, the addition of Room C 110 creates an interference problem. When Room A 104′ and Room C 110 are to be connected, Room C 110 would have to be placed in a position that would cause a portion of Room C 110′ to overlap with Room B 106′. This layout creates unacceptable interference and therefore cannot be used in building a 3D environment layout.

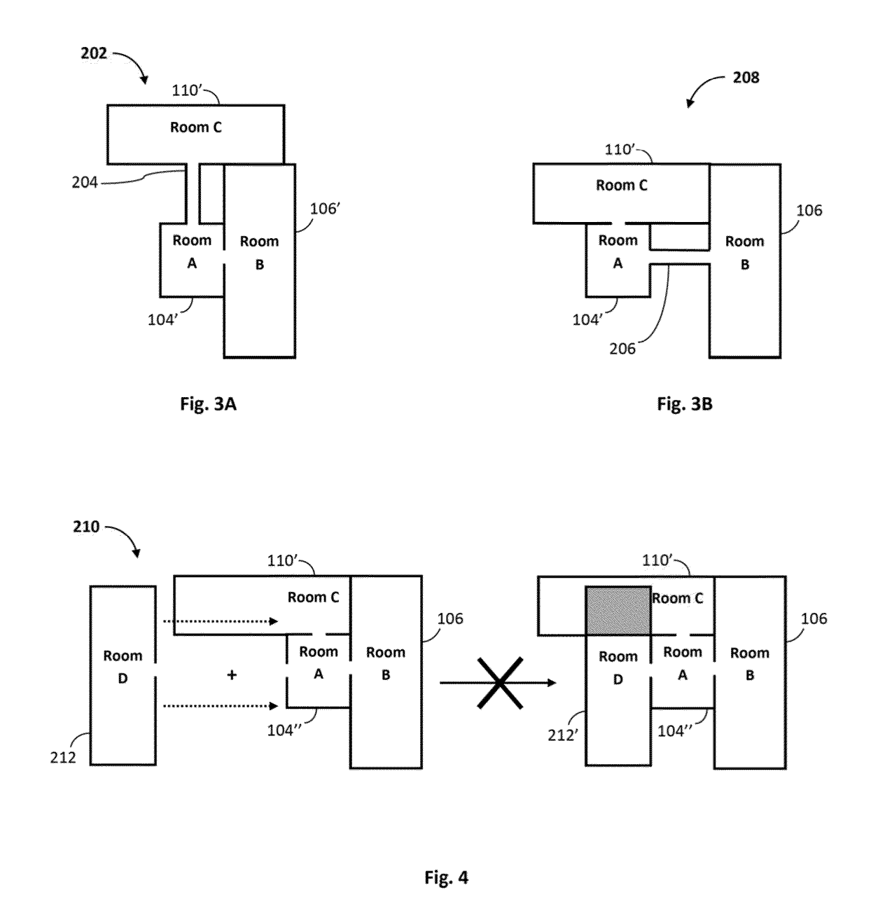

FIGS. 3A, 3B, and 4 show two typical solutions to the interference problem created by the three-room layout 108. In one embodiment, a long corridor 204 may be added to connect rooms which cannot be directly linked due to interference. The first layout 202, shown in FIG. 3A, maintains the original orientation of Room A 104′ and Room B 106′. A long corridor 204 is added between Room A 104′ and Room C 110′, allowing a connection between Room A 104′ and Room C 110′ without creating interference between Room C 110′ and Room B 106′. In the second layout 208, shown in FIG. 3B, Room A 104′ and Room C 110′ are directly connected, and a long corridor 206 may be added between Room A 104′ and Room B 106. Using a corridor is sub-optimal solution, as at least one of the rooms must be located further away than the other rooms. Furthermore, adding additional rooms or corridors causes the need to add more corridors or adjust the current layout, changing the appearance of the space.

FIG. 4 illustrates another embodiment in which the interference issue is solved by relocating the doorways within the rooms so no corridors are required. As shown in the third layout 210, Room A 104″ has been moved into a position which places the room in contact with both Room B 106 and Room C 110′, without creating interference between any of the existing rooms, by relocating the doorway between Room C110′ and Room A 104″. Although this solution eliminates the need for long corridors, the addition of a fourth room, Room D 212, presents the same interference problems and requires reorientation of the layout. Adding additional rooms would require additional adjustments of the layout. Each modification may require redesign of the rooms being joined, as the doorways can interfere with the look and utility of the rooms. This can make automated layout difficult or impossible, often requiring a predefined manual layout design.

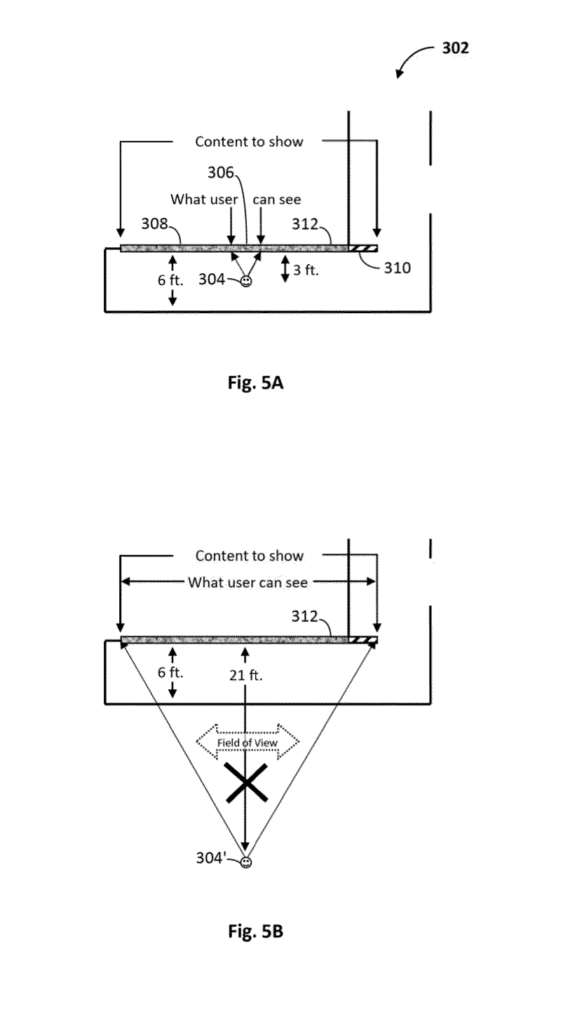

FIGS. 5A and 5B show one embodiment of a field of view issue present in three-dimensional environments. As shown in FIG. 5A, when displaying content to a user in a three dimensional space 302, the user 304 may only see in one direction, and in a perspective that presents significantly less than a 180 degree wide view, giving the user a small effective viewing area 306. Content that is to be displayed to the user may extend beyond the small effective viewing area 306 of the user 304 and may extend along the entirety of a virtual wall 308 or may extend beyond the space available 310. When a user 304 is too close to the content, the user 304 may see only a fraction of the content at a time. Anything present outside of the small effective viewing area 306 may be unnoticed by the user 304.

In order for a user 304 to be able to view all of the content, the user must be able to navigate to a position within the 3D environment 304′ that allows the field of view to extend along the entire content area 312, such as the position shown in FIG. 5B. In order for a user 304 to navigate to the position within the 3D environment 304′, the 3D space must be large enough and must not include a wall or other obstacle preventing the user from navigating to the correct location. Ensuring space and line of sight puts restrictions upon the layout design and shape used.

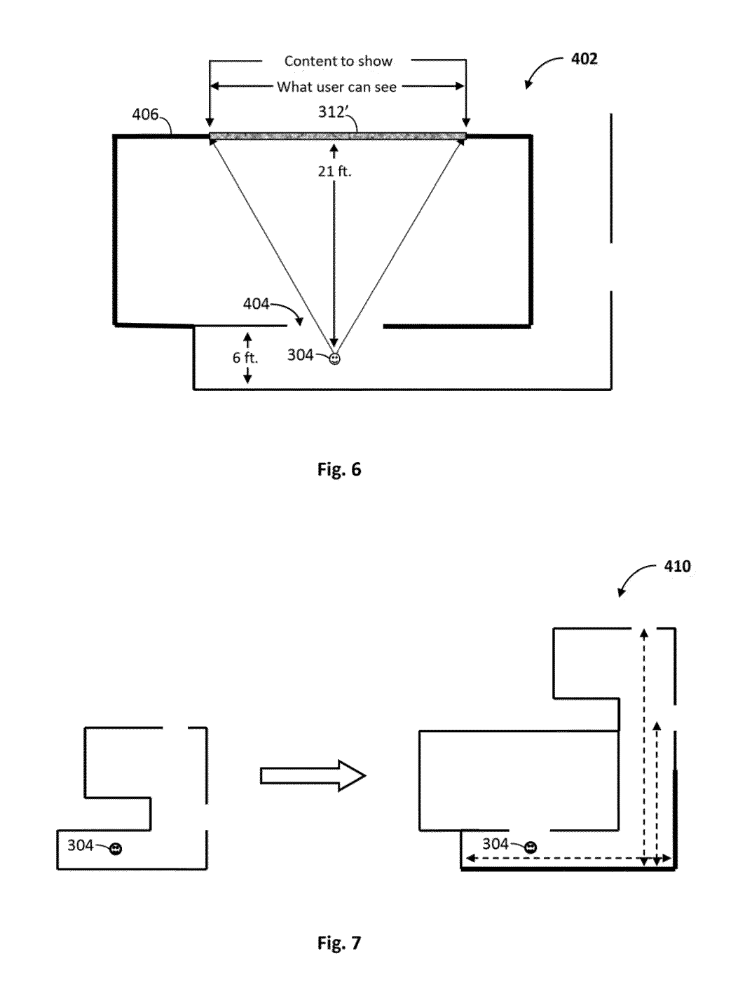

FIG. 6 shows one possible solution to the field of view issue created in three-dimensional environments 402. In one embodiment, the content area 312 is removed from the original wall, and a doorway 404 is placed in the space where the content area 312 was located. The doorway 404 opens into a larger room 406 which is sized to give the user a field of view capable of showing the entire content area 312′. In another embodiment, the size of the original space may be adjusted to accomplish the same affect. In both solutions, the current user space must be modified to make room for the larger room displaying the content area 312′. This can create a layout conflict if the space needed for the larger room overlaps with another room within the three-dimensional environment 402. This non-portal layout solution also creates user confusion, as the shape of the spatial area is larger and parts of the special area have been moved farther way, creating the hallway problem discussed above.

A further complication is that the field of view is a function of the distance of a user from the content that the user is trying to see, as is shown in FIG. 5A. In order for the users to see what is being offered or suggested, it may be necessary for the user to be far enough from the content that the view angle encloses what needs to be seen. Ensuring the proper view angle requires that the room or spatial area be large enough that the user can be at the proper distance to get the correct field of view. Any spatial areas that are used for display must often be quite large so that a user may be at a correct distance to see the content. Large spatial areas can force distortions of the shape of the 3D environment to accommodate the necessary distances to let the user see the content, as shown in FIG. 7.

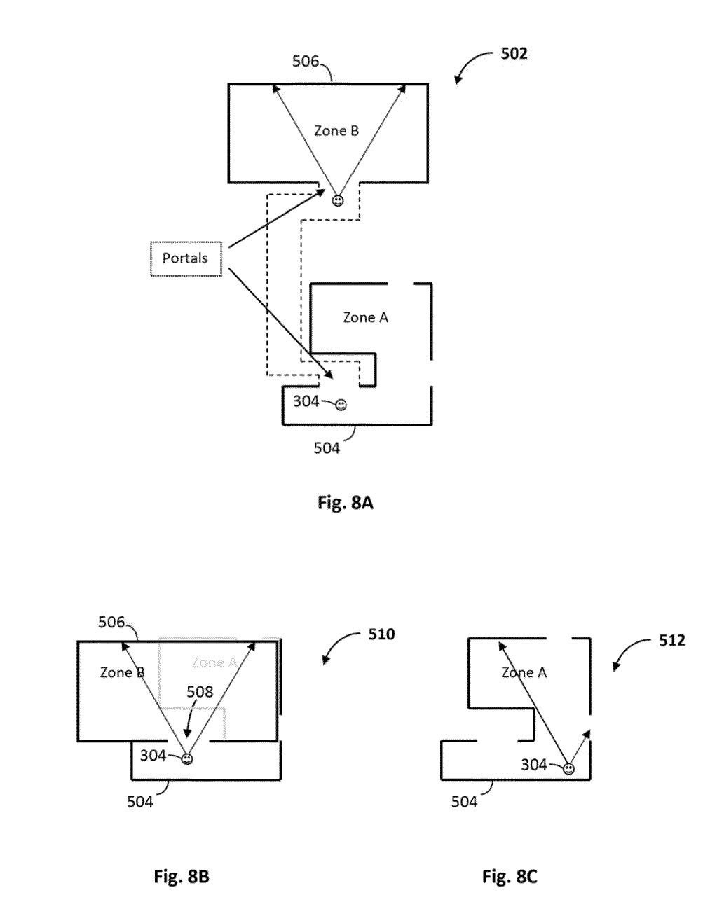

FIGS. 8A-8C show one embodiment of a solution to the field of view problem using a portal. In one embodiment, as shown by layout 502, the Portal Graphics Engine 4 creates a separate Zone B 506 which is located in a different space than Zone A 504. The Portal Graphics Engine 4 may create a portal 508 to Zone B 506 within the wall of Zone A 504. Because Zone B 506 does not lie within Zone A's 504 spatial area, there are no layout conflicts. Furthermore, the size and shape of Zone A 504 does not change by the addition of Zone B 506. The portal 508 may be closable, allowing Zone A 504 to return to an original state when a user closes the portal 508. The portal 508 effectively splices Zone A 504 and Zone B 506 together, causing the two zones Zone A 504, Zone B 506, to be perceived by the user as a single zone. FIG. 8B illustrates the zone layout 510 of the two zones as perceived by a user 304 when looking through the portal 508. When the user 304 looks through the portal 508, the user 304 sees Zone B 506 as a continuous part of Zone A 504. FIG. 8C illustrates the zone layout perceived by a user 304 when the user 304 is not looking through the portal 508. When not looking through the portal 508, the user 304 sees only the Zone A layout 512.

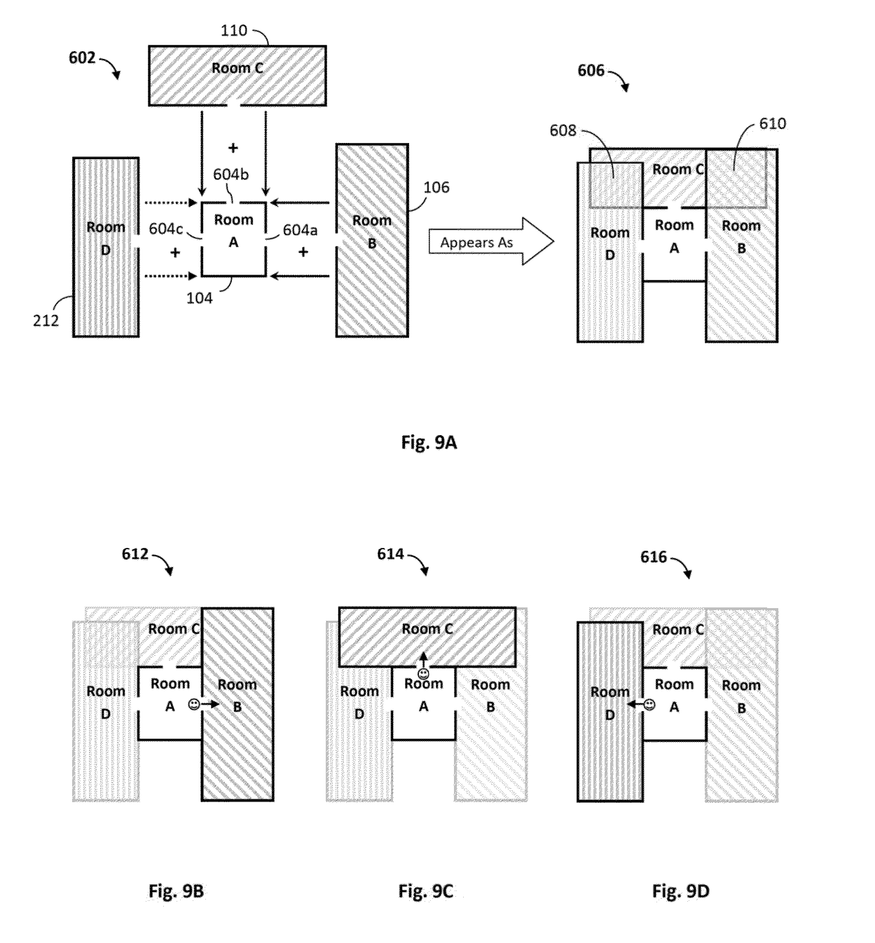

FIGS. 9A-9D show one embodiment of a solution to the layout problem, discussed with respect to FIG. 4, using portals. A layout 602 is created with Rooms A 104, B 106, C 110, and D 212. None of the rooms are in direct contact. Room A 104 contains three portals 604a,b,c. Each portal 604a,b,c connects to one of the other rooms created in the layout 602. In the embodiment shown, the portals 604a,b,c connect to the room which is located in the same direction as the portal, e.g., the portal 604c located on the western wall connects to Room D 212 located to the west of Room A 104. One skilled in the art will appreciate that any of the portals 604a,b,c may connect to any of the other rooms, e.g., the portal 604c located on the western wall may connect to Room B 106, located to the east of Room A 104. The virtual layout 606 shows the layout of the 3D environment as perceived by a user within the 3D environment. From the perspective of the user, Rooms B 106, C 110, and D 212 are located immediately adjacent to Room A 104. Rooms B 106 and C 110 and Rooms D 212 and C 110 appear to extend into overlapping space 608, 610. Although the Rooms B 106 and C 110 and Rooms D 212 and C 110 appear to overlap to the user, the rooms are located in different spaces, and therefore do not actually overlap. FIGS. 9B-9D illustrate various virtual layouts 612, 614, and 616 illustrating the image seen by a user looking through portals 604a, 604b, and 604c.

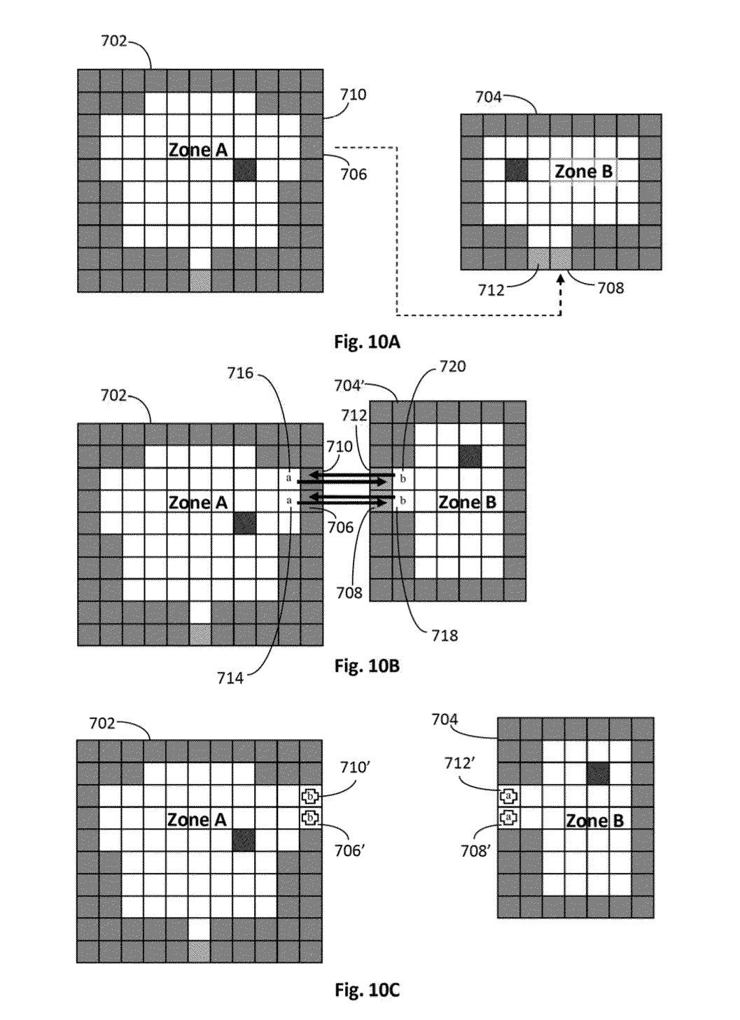

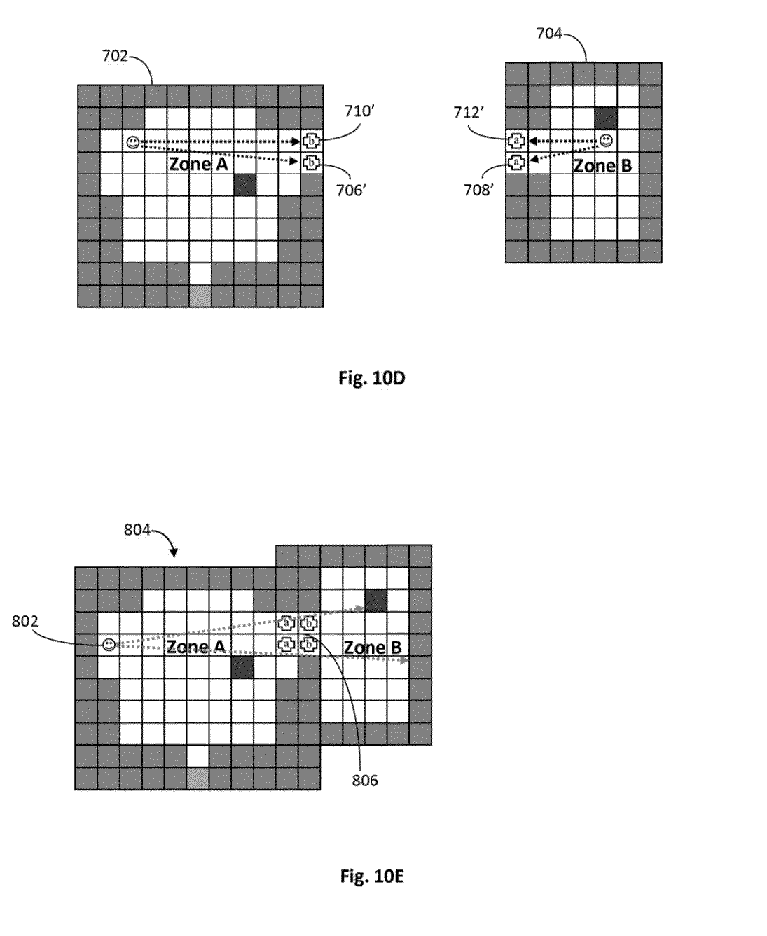

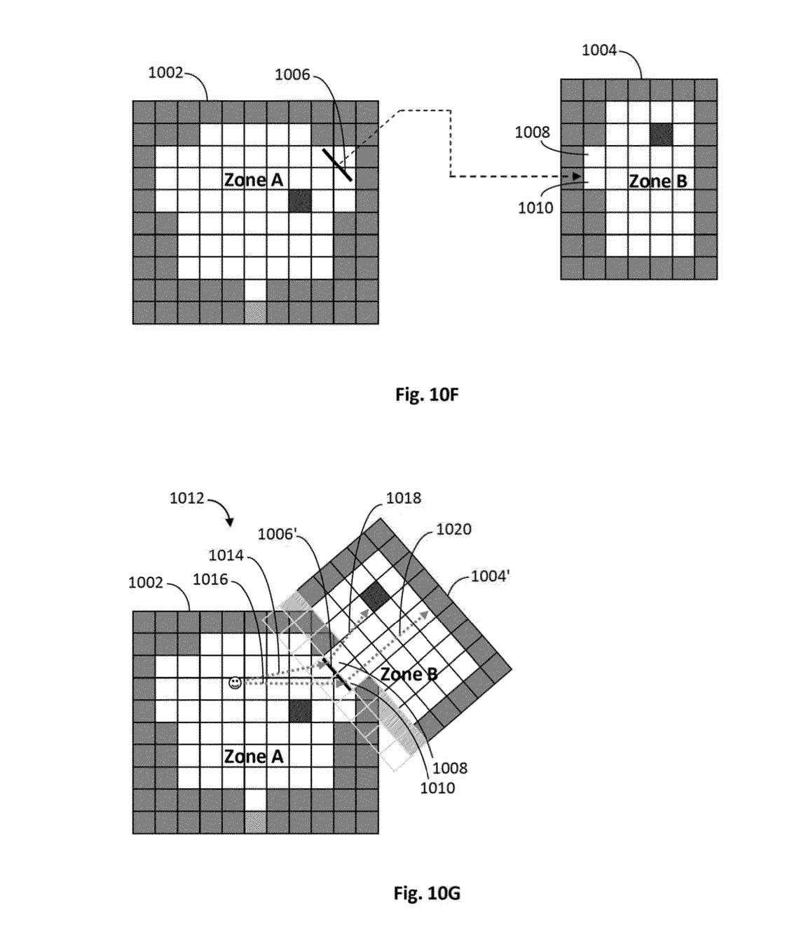

FIGS. 10A-10E show one embodiment of a portal connecting two zones at a zone cell boundary (‘cell portal’). As shown in FIG. 10A, a first zone, Zone A 702 and a second zone, Zone B 704, are to be joined. A user may initiate the creation of a portal by interacting with a portal trigger location consisting of a first cell 706 and a second cell 710. A portal trigger may be, for example, a user motion towards a predetermined section of the user environment, such as a particular wall or an object within the room, the user interacting with a section of the environment (for example, by clicking on a section of the environment using an input device such as a mouse), or the user interacting with a dialog mechanism such as a dialog box or an avatar. After the user initiates the creation of a portal to Zone B 704, the Portal Graphics Engine 4 may locate the default portal location of Zone B, such as, for example, a third cell 708 and a fourth cell 712. As shown in FIG. 10B, the Portal Graphics Engine 4 may apply a portal orientation correction and swap the composite numerical value (CSV) of the first and second cells 706, 710 with the CSV of the corresponding cells directly in front of the default portal location of Zone B, such as, for example, a fifth cell 718 and a sixth cell 720. The portal graphics engine 4 may swap the CSV of the third and fourth cells 708, 712 with those of the two cells directly in front of the portal cells of Zone A, for example, a seventh cell 714 and an eighth cell 716. The portal orientation correction is a calculation applied by the navigation and screen-image composition layers when traversing the boundaries of the portal cells 706′, 708′, 710′, 712′, which are discussed in greater detail below. The composite numerical value (CSV) is a number representing information about each cell within a layout. The portal orientation correction and CSV are discussed in greater detail below. After the CSV values have been swapped, Zone B 704′ acts as though the zone has been rotated to match the orientation of Zone A 702. Before the CSV values are swapped, the Portal Graphics Engine 4 loads the image files for Zone B 704′. After the image files have been loaded, Zone A 702 and Zone B 704 appear to the user as a single zone connected, with the first cell 706′ and the third cell 708′ being continuous and the second cell 710′ and the fourth cell 712′ being continuous, as illustrated in FIG. 10E.

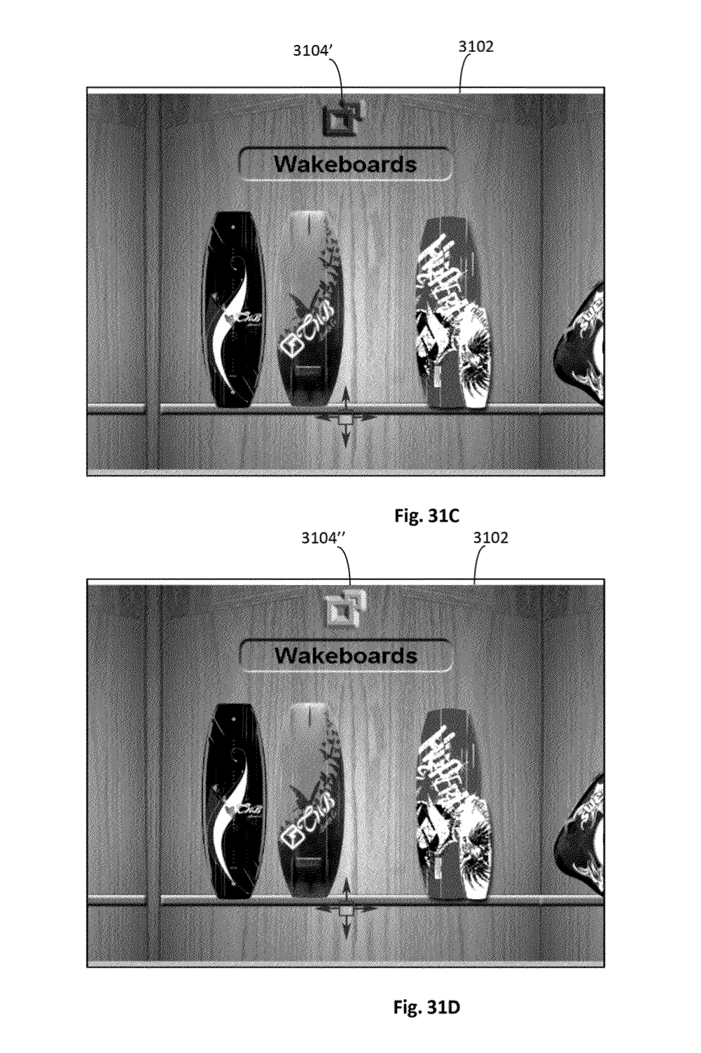

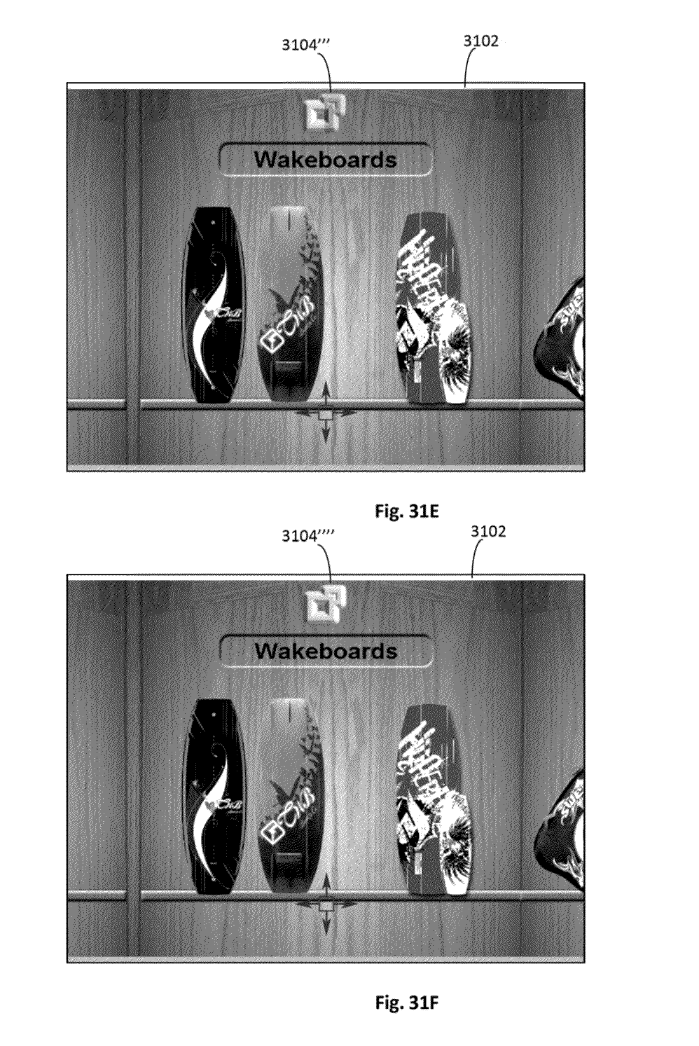

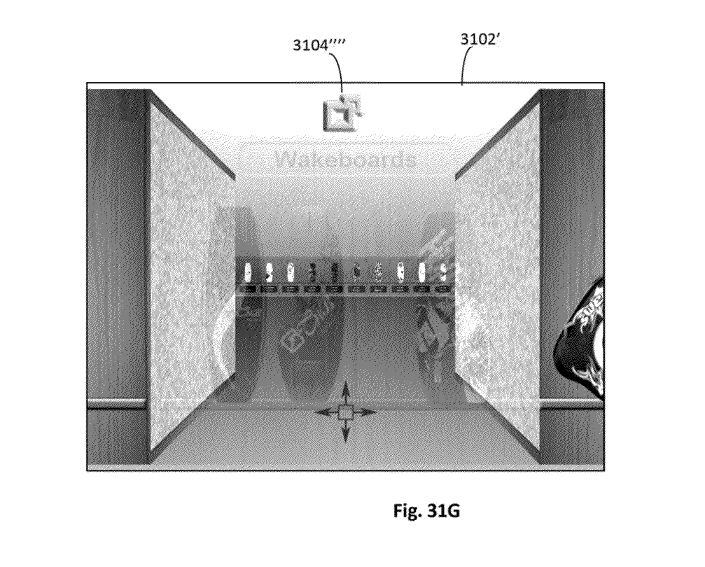

In one embodiment, a visual cue is presented to the user, as an aid to understanding that an action is taking place. Because loading a new zone may involve a noticeable amount of elapsed time for the user, such a visual cue can let the user know the status of the zone loading. In one embodiment, a graphical icon is displayed as the portal is opening, such as, for example the icon 3104 shown in FIGS. 31A-31G, whose image indicates the status of the loading. In one embodiment, this status is indicated by the icon changing colors as the loading proceeds, so that the user can know when the zone is ready to enter. In one embodiment, an application may choose to display such an icon, such as, for example, the icon 3104, on walls that are pre-defined portals, as a visual cue to the user as to which walls are meant to be used as portals, such as, for example, the wall shown in FIG. 31A. In one embodiment, portals so marked open automatically merely by the user moving towards them.

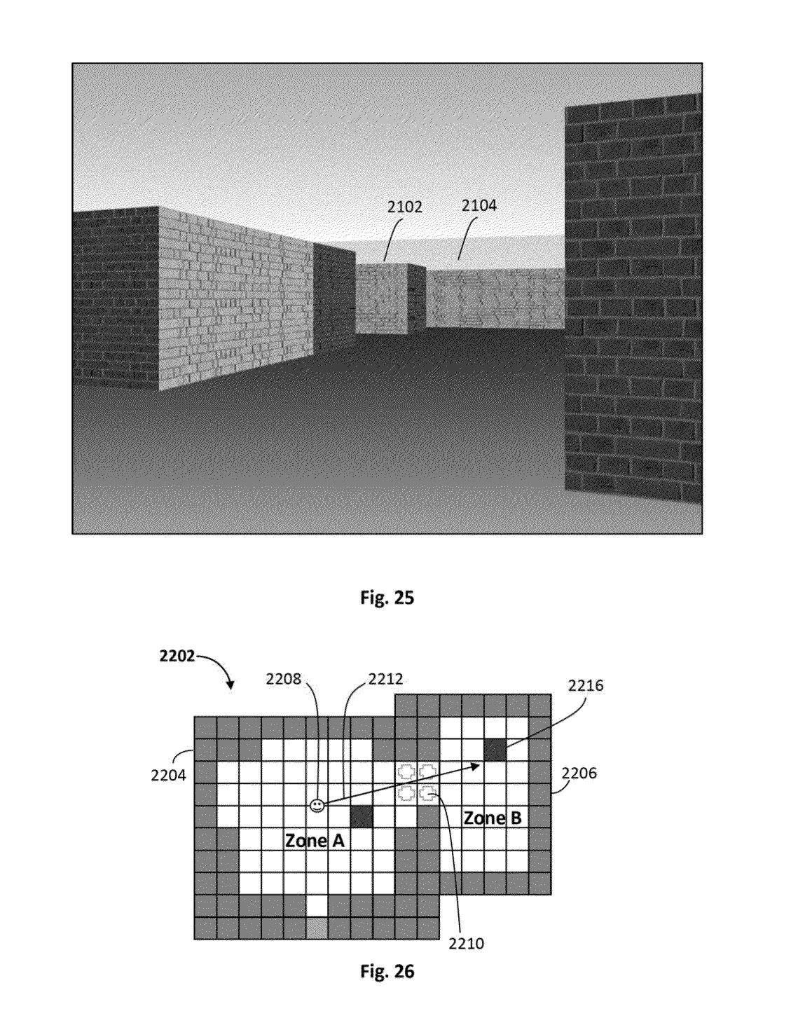

FIGS. 10D-10E further show how two zones may be spliced together using a portal. In one embodiment, after the portal has been opened at the portal trigger location 706′, 710′ and the default portal location 708′, 712′, a user 802 observing the environment from Zone A 702 would see a single, continuous space from Zone A 702 to Zone B 704, shown in FIGS. 25 and 26. The single continuous space results because each zone contains cells that have CSVs for the other and therefore a ray-trace (discussed below) or user motion in the direction of the cells will cross a CSV value that does not belong to the first zone. In effect, the user 802 would perceive only a single, large zone 804 containing the layout of Zone A 702 and Zone B 704 connected at the portal trigger location comprising first cell 706′, the second cell, 710′ and default portal location comprising third cell 708′ and fourth cell 712′.

FIGS. 10E-10G show one embodiment of a portal connecting two zones at a location other than at zone cell boundaries, by creating one or both sides of the portal at the location of a surface panel of a component object 1006 (‘surface portal’). As shown in FIG. 10F, Zone A 1002 and Zone B 1004 are to be joined. A user may initiate the creation of a portal by interacting with a portal trigger location consisting of a surface panel of a component object 1006 in Zone A 1002. After the user initiates the creation of a portal to Zone B 1004, the Portal Graphics Engine 4 may locate the default portal location of Zone B 1004, such as, for example, a first cell 1008 and a second cell 1010. As another example, the portal location may be a surface panel location in Zone B 1004. In some embodiments, a second surface panel is created in the second zone when the default portal location is defined as cells, so that both sides of the portal are associated with surface panels. As shown in FIG. 10G, the Portal Graphics Engine 4 may apply a similar portal orientation correction for surface portals as it does for portals defined upon cell boundaries. This is illustrated in FIG. 10G by the deflection of rays 1014, 1016 in Zone A 1002 as they cross the portal and become rays 1018, 1020 in Zone B 1004. Surface portals may attach the orientation corrections to the surface panel objects instead of replacing the CSV values of cells. The application of the portal orientation correction for surface portals is discussed in greater detail below. After the orientation corrections have been applied to each side of the portal, Zone B 1004′ acts as though the zone has been rotated to match the orientation of the surface panel 1006′ in Zone A 1002. Since a surface portal may be defined on a surface panel that is a flat surface, a visual effect may be generated such that the surface is a hole in space joining the two zones together, as illustrated in FIG. 10G.

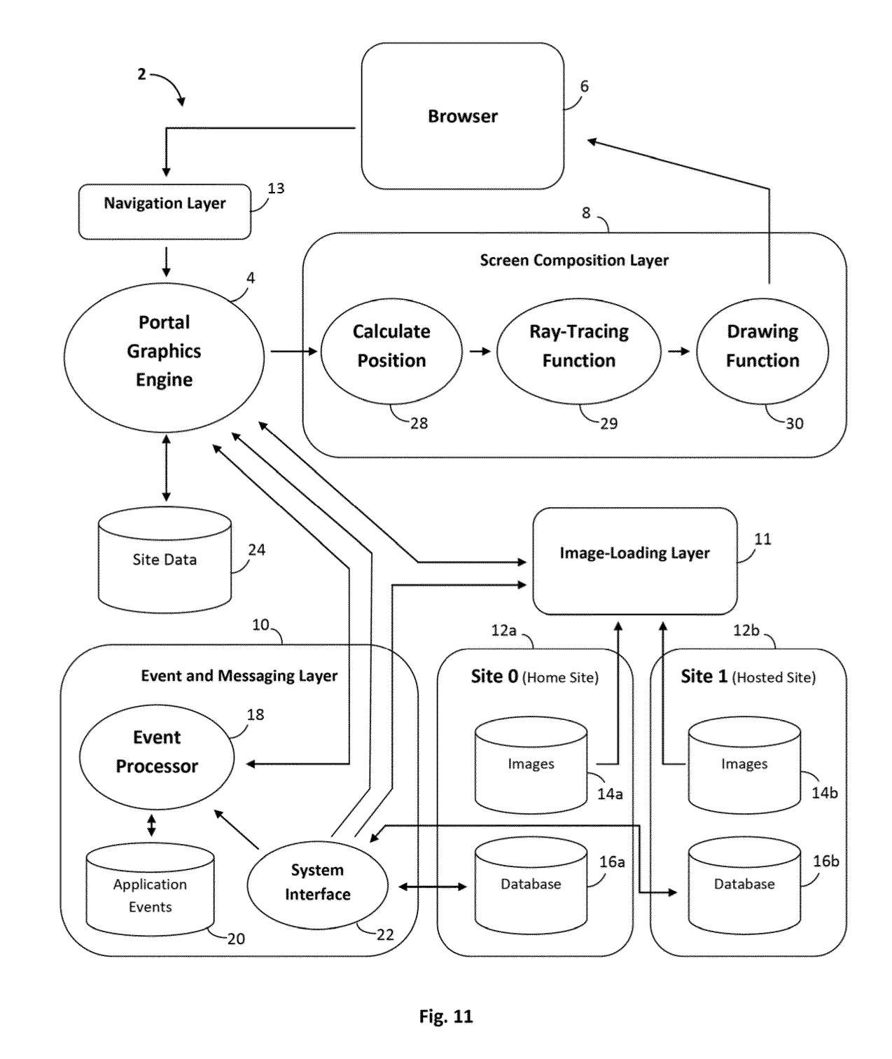

FIG. 11 shows one embodiment of a software architecture 2 capable of implementing a 3D environment including portals. The software architecture 2 may comprise a Portal Graphics Engine 4 (graphics engine) which communicates with a browser 6, one or more sites 12a,b and an Event and Messaging Layer 10 that coordinates user interface behavior. Each site may comprise an image storage 14a,b and a database layer 16a,b. The Portal Graphics Engine 4 may communicate with a database layer 16a,b to retrieve site layout descriptions and images, from which the Portal Graphics Engine 4 may construct a user environment and display the result in the browser 6.

In one embodiment, the database layer 16a,b may comprise a site layout and action descriptions. The Portal Graphics Engine 4 may communicate with the database layer 16a,b through a simple message-passing layer that sends and receives messages as text. In one embodiment, the message-passing layer protocol may be, for example, an SQL query that returns a text string as a response, enabling great flexibility in the types of possible queries. Other text-based protocols may also be used. In one embodiment, because the protocol is text messages, the protocol abstracts from the Portal Graphics Engine 4 the location and exact mechanism that a site may use to store and retrieve the descriptions. As long as the protocol is properly supported, a site is free to manage its descriptions as it chooses. The descriptions may be implemented as, for example, true SQL databases, a small set of simple text files (such as in PHP format), or other file formats. This abstraction permits the graphics engine to reduce or eliminate the number of distinctions to support and display local sites and remote sites equally.

The Portal Graphics Engine 4 may further comprise an image-loading layer 11, a screen-image composition layer 8 and user-position navigation layer 13. The 3D Virtual Reality screen image is composed using a modified form of a “real-time ray-tracing” algorithm. In one embodiment, the modified ray-tracing algorithm and the navigation algorithm are aware of portals, and are designed to make them work smoothly.

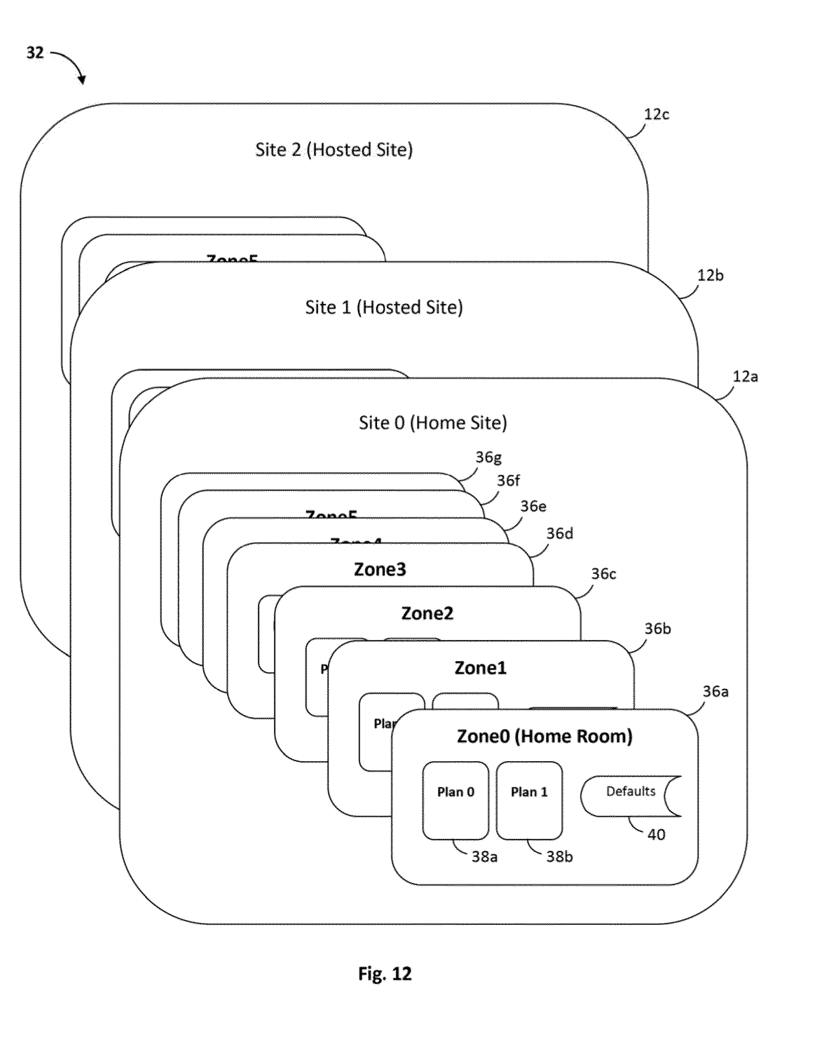

FIG. 12 shows one embodiment of a user environment 32, which may comprise one or more data groupings 12a, 12b, 12c (site objects). In one embodiment, the data groupings 12a, 12b, 12c, may each comprise a database address (or URL) (not shown) and one or more spatial dataset objects 36a-g (zones). The data groupings 12a, 12b, 12c, may further comprise an image storage. Each zone 36a-g may comprise one or more spatial layout objects 38a, 38b (plans). Within the VR environment, the zones 36a-g may be connected to each other through wormhole doorway objects (Portals) as shown in FIGS. 10A-10G.

In one embodiment, the initial startup configuration may be of one site (the Home site 34a) containing an SQL database, a directory of graphic images, one zone (the Home Room 36a) whose spatial layout is described by one plan (the Home plan 38a). Making the base zone small and simple helps to minimize the time required for loading during initialization. The Portal Graphics Engine 4 may construct new zones with images, such as, for example, spatial areas such as rooms, hallways, galleries, and showrooms, to name just a few. The new zones may comprise a base plan. In one embodiment, the Portal Graphics Engine 4 may connect a zone to other zones using one or more portals. A portal may form an invisible splice that joins two zones together at a specified point, in such a way that is indistinguishable from the two zone spaces being truly contiguous. Once a portal is opened, the Portal Graphics Engine 4 may comprise a display layer to manage all visual presentation so that to the user the two zones are in every perceivable way a single larger zone. In one embodiment, zones and the portals to them may be created on-the-fly and the resulting zone layout may be ad-hoc. In one embodiment, a site designer may create only one fixed zone, the home room zone, and allow the user to create the rest of the layout as they choose. This free-form layout capability is one advantage of a portal architecture.

In one embodiment, the site object 12a,b,c may be a simple data structure containing fields to store site-specific information including, but not limited to, the site name, a list of its zones with their names, layouts, and contents, URL of the site location, database-query sub path within that URL, default event handlers, locations of the various image and video files, and descriptions of site-specific behaviors.

In one embodiment, the zone object 36a-g may be a simple data structure containing fields to store site-specific and zone-specific information including, but not limited to, the zone's name, primary and secondary plans, default preferred portal locations, default event handlers, default wall types, and default wall face images. In one embodiment, the zone's primary plan may define a solid structure that affects navigation (user movement), such as, for example, the location of walls, doorways, open spaces, and component objects. The zone's secondary plan may define visual enhancements that do not affect navigation, such as, for example, transparency (or ghosting), windows, and other visual effects where the user can see something but could potentially move through or past it. The default portal locations may be a suggestion as to the best locations for another zone to use when opening a portal to it. While connection at those points may not be mandatory, unless a zone is in the same site as the zone it is connecting to, using the suggested points helps avoid possible image confusion and behavior anomalies.

FIG. 14B further shows one embodiment of a plan object as a simple two-dimensional array of boxes (cells). Each zone may comprise at least one plan array (the primary plan), as a sub-field of the zone object. In one embodiment, a plan array (or plan) may represent its cells as integers, storing plans as two-dimensional arrays of integers. Cells may be, for example, solid, transparent or empty (open floor). The Portal Graphics Engine 4 may display solid and transparent cells by drawing their surfaces (or faces) using texture maps. Texture maps are flat images, typically in standard graphics formats such as, for example, JPEG, BITMAP, GIF, PNG or other formats supported by browsers. The Portal Graphics Engine 4 may read in images from their files stored for the site, and store them internally. The Portal Graphics Engine 4 renders images at the correct locations and with the correct perspective. In one embodiment, the Portal Graphics Engine 4 determines location and perspective by a calculation that walks through the plans, and locates solid or transparent wall objects, based upon their numerical values.

In one embodiment, the visual effect presented to the user is a set of full-height walls with images on their sides. In another embodiment, the visual effect may be a true 3-dimensional layout. Each non-empty cell may have four sides or wall faces, and each wall face (or panel) can have its own unique image projected upon it.

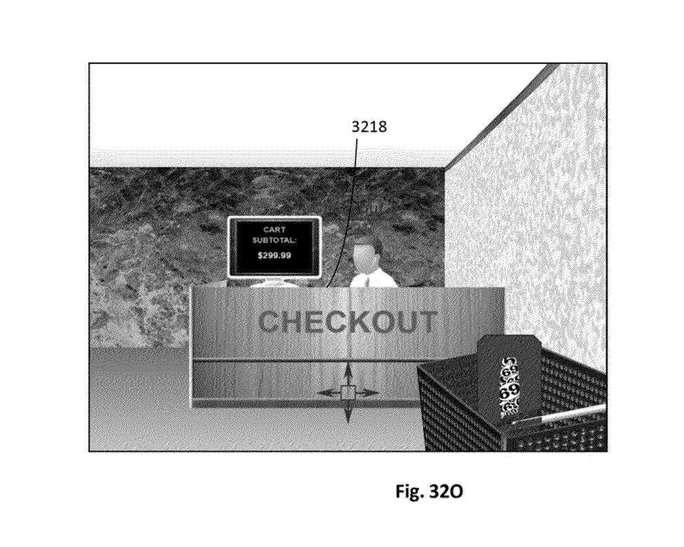

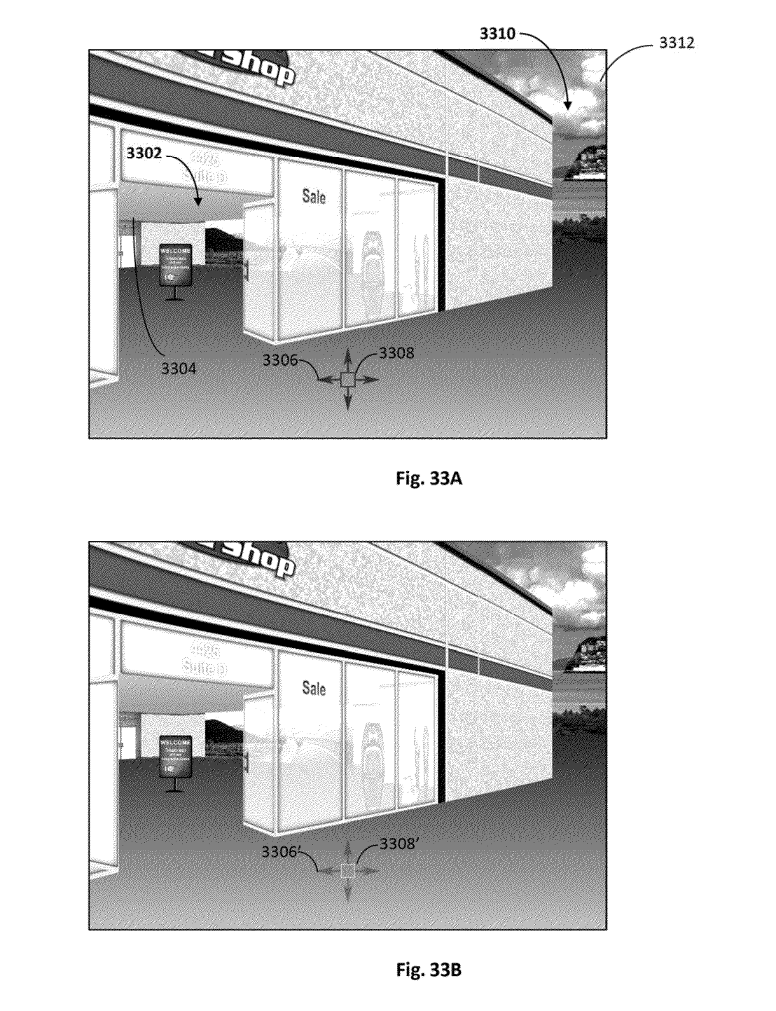

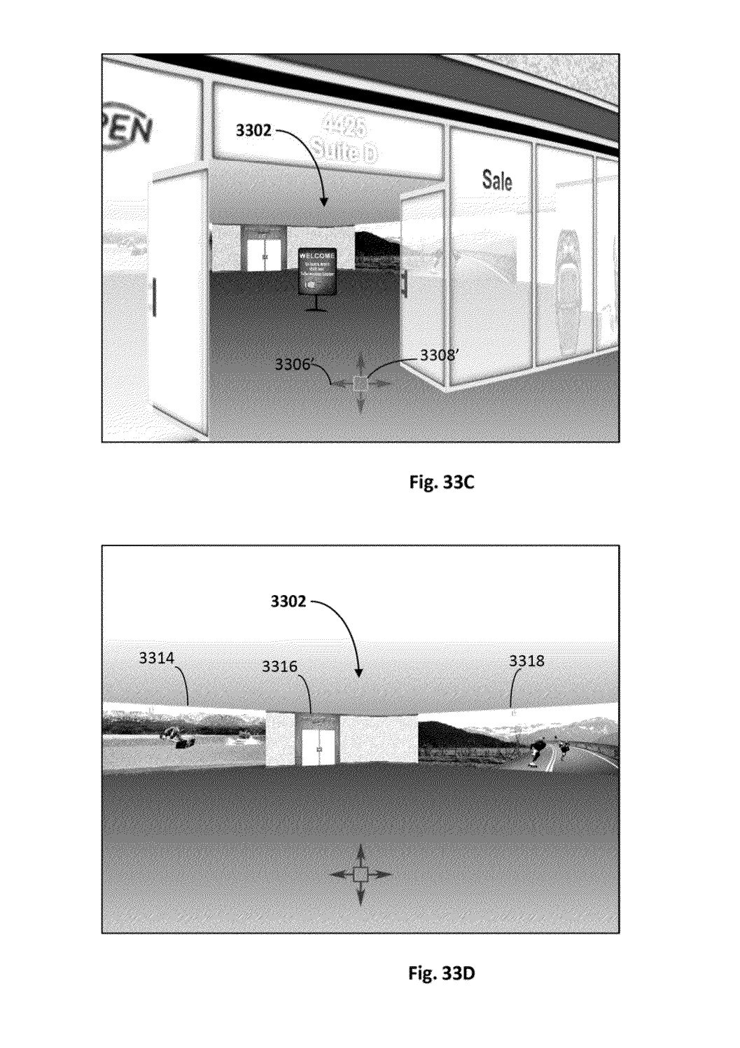

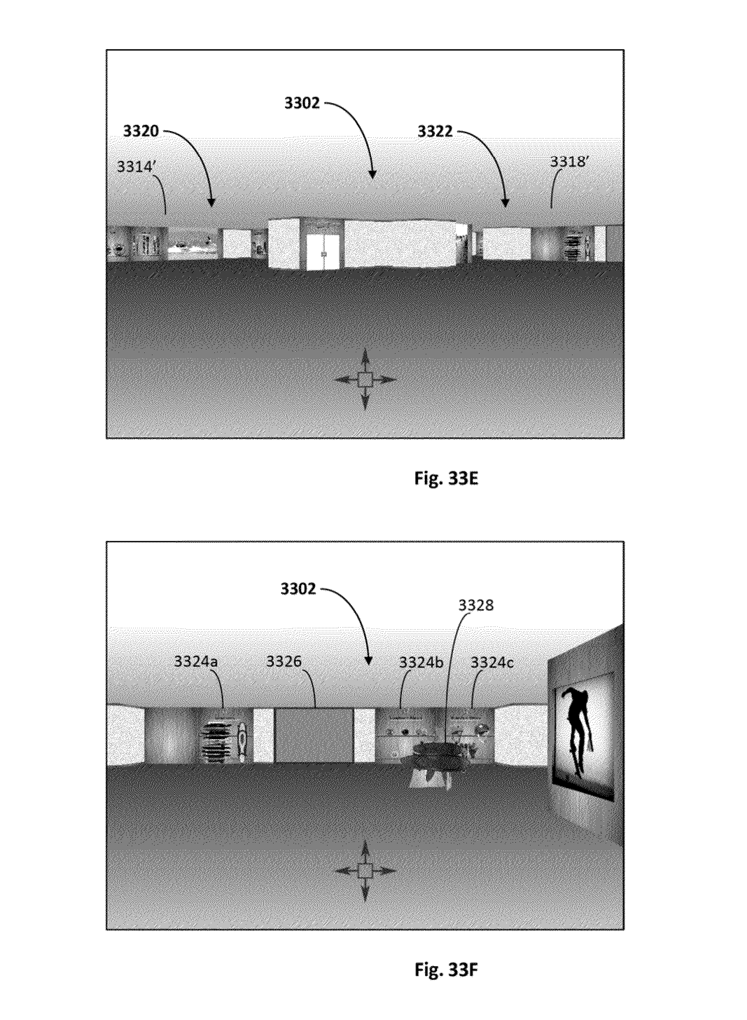

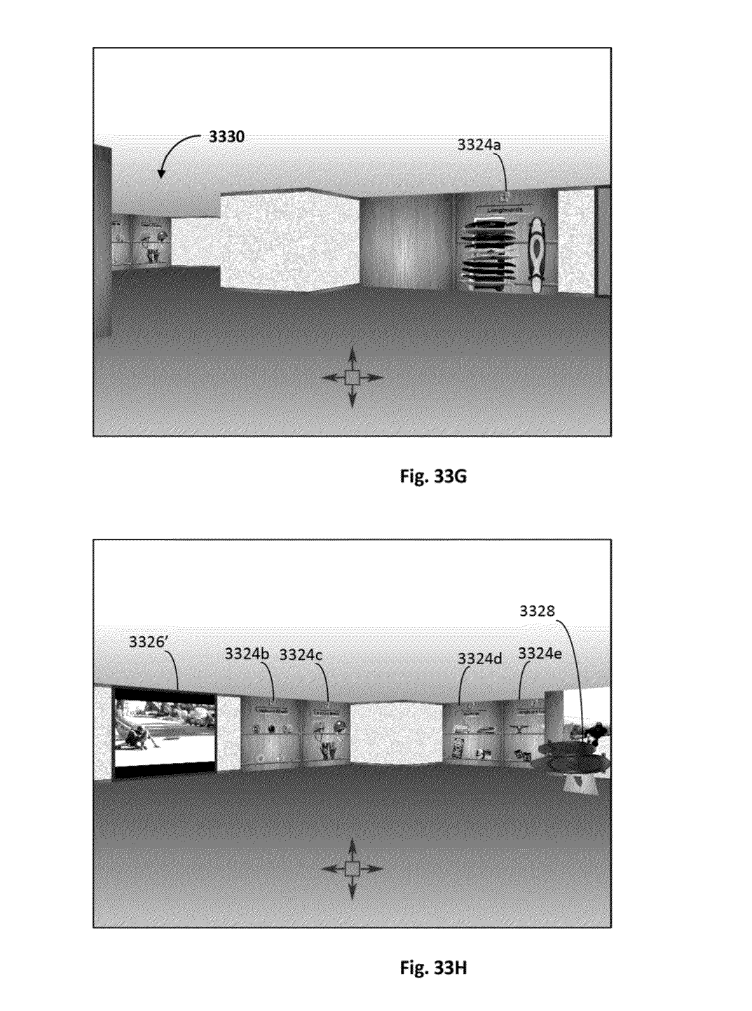

In another embodiment, zones can contain free-standing graphical objects that are not walls. In one embodiment, these ‘component’ objects can comprise one or more single images that combine to form a single graphical entity. Component objects allow visual elements to be placed inside of the rooms of the zones, enhancing the sense of a 3D virtual world. For example, as shown in FIGS. 33F and 33H, a component object such as a board rack with two skateboards 3328 may be placed inside of a room. In one embodiment, the images that are used to create component objects share the same image architecture as do wall images.

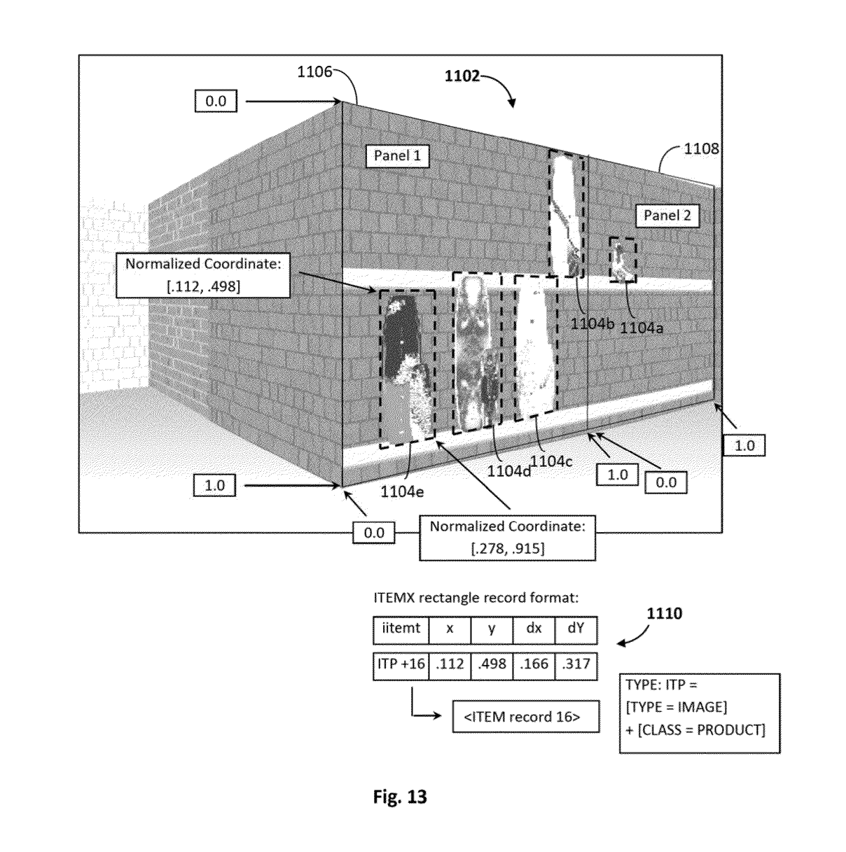

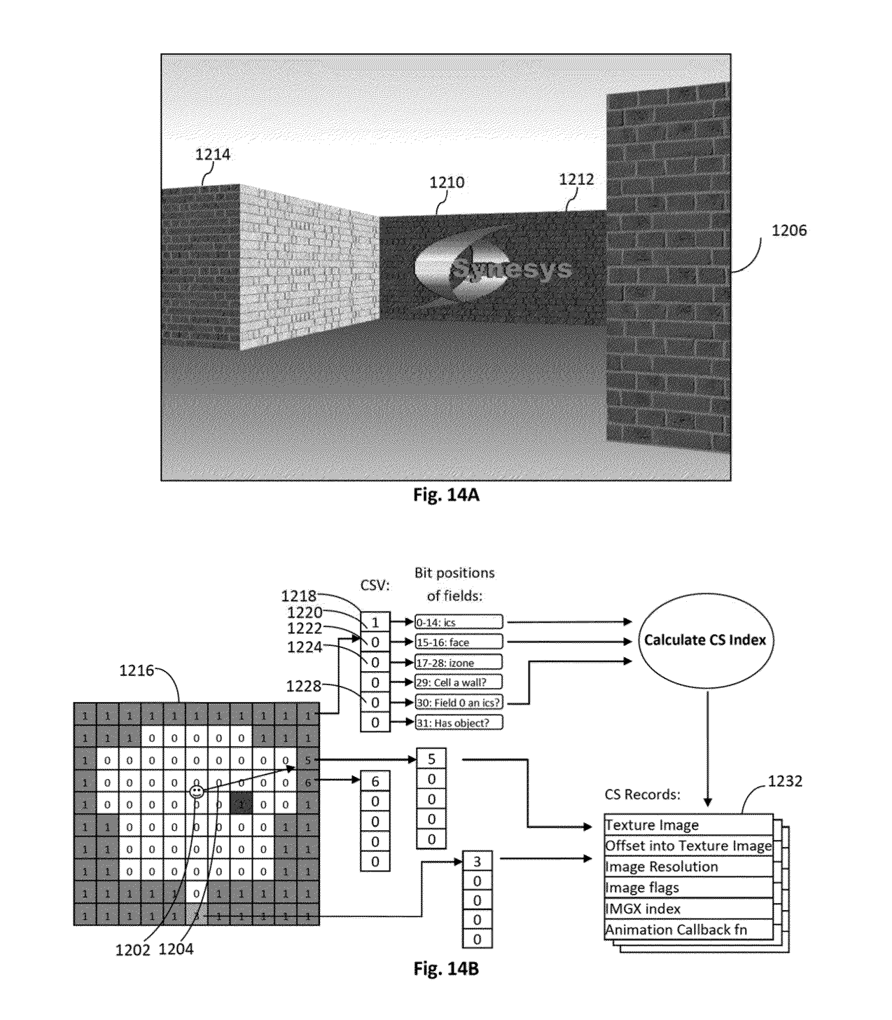

In one embodiment, the images may be stored and referenced through cell-surface (CS) objects, which may comprise a storage index of a texture-map image (IMG), a bit offset and region size within the texture-map image, the texture-map image's dimensions in pixels, and one or more pointers to callback functions for special effects and special functions. The texture-map images may be stored separately in an image-extension (IMGX) object, so that they can be shared and regions defined within their boundaries. In one embodiment, each image-extension object comprises an HTML domain image object, and the images pixel dimensions. The image-extension object may further comprise an image-map array (IMGXMAP). The image-map array may comprise one or more region-definition records (ITEMX) for items that can appear or refer to regions within the image (ITEM). As shown in FIG. 13, in one embodiment, each ITEMX record 1110 may be a structure that contains a minimum of the item type, the index to the ITEM record, and a set of coordinates and dimensions that are normalized to the dimensions of the IMGX object. For example, an ITEMX region that defined a rectangle that was half the width and half the height of the image and centered vertically and horizontally, would have normalized coordinates of [0.25, 0.25] and normalized dimensions of [0.5, 5.]. The ITEM records are simple objects that can contain an item type and a number of sub-fields which the graphics engine stores on behalf of the application. Some base types such as “text” and “image” are defined, but each application, and even each site, is free to add any item types it needs. The graphics engine only directly reacts to the item type field, specifically for whether the item registers the field for an event callback or not. Examples of event callbacks can be for events such as but not limited to when a mouse is clicked on or hovers over the item, when the user's position approaches or retreats from the item, or when the user can see the item. The graphics engine supports a number of such callbacks, and invokes the function specified by the callback when the event's criteria is satisfied. For example, mouse-events are supported by a callback function that the graphics engine calls when an component object or wall is selected or hovered over. Approach-events are supported by a callback function that the graphics engine calls when the user approaches or retreats away from an component object or wall. The result of this design is that any image can be projected upon any wall or component object surface (panel), and have any number of graphical objects projected on it, with any number of event-sensitive regions defined within it.

FIG. 13 shows one embodiment of a wall image 1102 with multiple items 1104a-1104e displayed thereon. The wall image 1102 is divided into two panels, panel 1 1106 and panel 2 1108. Each panel 1106, 1108 has a normalized coordinate plane expressed in terms of x, y coordinates. The normalized coordinate planes begin at 0.0, 0.0 in the upper left corner and extend to 1.0, 1.0 in the bottom right corner. The region-definition records (ITEMX) for each item 1104a-e displayed on the wall contains a set of normalized coordinates indicating the location of the upper left hand corner of the object on the normalized coordinate plane and values for the change in the x and y locations for the bottom right of the item, shown in FIG. 13 as array 1110. For example, item 1104e has an initial normalized coordinate value of x=0.112 and y=0.498. This indicates that the upper left corner of the item is displayed on the normalized coordinate plane at location 0.112, 0.498. The change in coordinate values, dx=0.166 and dy=0.317, indicate that the bottom right of the displayed item are located at 0.112+0.168=0.278 (the initial x coordinate value+the change in coordinate location=the x coordinate value for the bottom right hand corner) and 0.498+0.317=0.915 (the initial y coordinate value+the change in coordinate location=the y coordinate value for the bottom right hand corner). Each of the displayed items 1104a-e has a corresponding set of values for determining the location and size of the displayed image.

In one embodiment, each plan object represents each of its cells with a composite numerical value (CSV), as shown in FIGS. 14A and 14B. Each CSV (value) is a composite of 32 bits, broken into 6 sub-values. Bits 0 through 14 store an index to an array of texture map images (ICS). Bits 15 through 16 store an index to a wall face (face) that indicates which face to apply the image indicated by the ICS field. Bits 17 through 28 store an index to the array of zones (izone). Bit 29 is a flag that marks whether the CSV is a solid wall. Bit 30 is a flag that indicates whether bits 0 through 14 are an ICS for a specific face. Bit 31 is a flag that indicates that there is at least one component object occupying the cell. Each ICS is an index to a CS, which contains a pointer to an IMGX object, so each CSV controls which image will be presented on each panel of a cell. This data encoding allows plans to be very compact and use little memory. Within a CSV, the izone field indicates to which zone the plan's cell belongs. While most cell values (CSVs) in a plan will have that plan's zone as the value in the zone field, a cell that specifies a different zone forms the data indication of a cell portal.

FIGS. 14A and 14B show one embodiment of the interaction between the user environment and the CSV. A user 1202 has a perspective view 1206 in a first direction 1204. As shown in FIG. 14B, each cell contains a CSV that is used to determine the image displayed to the user. In the embodiment shown in FIG. 14A, the user is able to see four different texture map images. The first cell 1210 uses texture map image set 5, which displays one half of a graphic image. The second cell 1212 uses texture map image set 6 which displays the other half of the graphic image. The third cell 1214 uses texture map image set 1, which displays a different texture map on each of the two visible faces of the cell. As shown in the perspective view 1206, the user perceives the four different texture map image values as four different types of wall. As can be seen in the cell plan 1216 shown in FIG. 14B, the cells between the user and the walls have a CSV value of zero, indicating that there is no texture in the cell and that the ray user view, in the form of a ray-trace, should continue through the cell. The CSV value 1218 may comprise six bit fields, four of which may be used to identify the image to be displayed in the cell, as an index to a CS record. In one embodiment, if the value of bit field 1228 is not set, the value in bit field 1220 may be an index to an array of 4 CS records, one for each face of the cell, and the value of bit field 1222 may be added to that index. If the value of bit 1228 is set (e.g., is 1) and if the cell face matches the value of bit field 1222, the value in bit field 1220 may be a direct index to a CS for the face given by bit field 1222. If the value of bit 1228 is set and the cell face does not match the value of bit field 1222, the cell faces may be determined through the default values in the zone record indicated by the value of bit field 1224.

In one embodiment, a portal may be implemented as a swap of the CSV values of a set of cells in one zone with a matching set of cells in the other. The navigation and image-generating code (ray tracing) track zone field changes within a plan, and use that information to continue the navigation or ray-tracing in the referenced external zone. The details of the navigation and ray-tracing will be given below. As previously discussed with respect to FIGS. 10A-10E, a portal may be opened by swapping cell values in the plan of Zone A 702 with the same number of cell values in the plan of Zone B 704. Each zone's portal cells' 706′, 708′, 710′, 712′ CSV values get replaced by the CSVs of the cells in front of the other zone's matching portal cell. Once this is done, each zone has cells with CSV values that refer to an external zone (e.g., Zone A 702 contains cells with references to Zone B 704, and Zone B 704 contains cells with references to Zone A 702). The ray-trace and navigation functions detect this zone change when tracing or moving through a zone. The zone change triggers the display features that make the portal behave as a wormhole. Once swapped, the display and navigation engines will make it appear to the user that the two zones are completely joined. A portal is closed by swapping the cell values back to their original values.

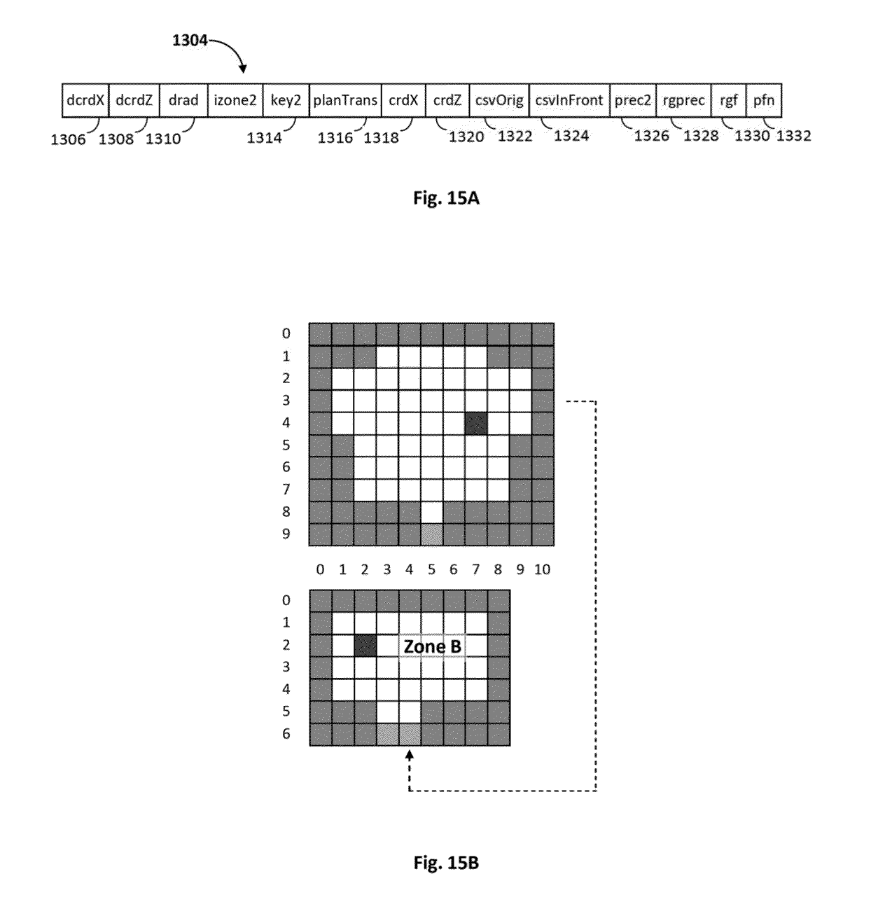

FIGS. 15A and 15B show one embodiment of portal data stored in a portal record or PREC. In the embodiment shown in FIG. 15A, a PREC 1304 is an array of values that comprises the cell-row 1306 and cell-column 1308 offsets with respect to the other zone, the angle of incidence 1310 between the current zone and the other, a hash key 1314 within the other zone to find its matching PREC, a flag 1316 for whether the zone displays semi-transparently, the coordinates 1318, 1320 of the portal within the current plan, the original CSV values of the portal cell 1322 and that of the cell in front of it 1324, and an array 1328 listing the other PRECs that form the group of the portal. In one embodiment, the PREC also contains a list of callback functions 1332 that enable events to be registered on the portal. Such events can include but are not limited to portal open and portal close. A portal can be opened from any PREC in either zone, and from that PREC all of the PRECs in its zone and that of the other can then be found. A portal is opened by locating one PREC, and then processing all of them in a programming loop. For each PREC, the CSV value of the cell of the portal is replaced by the CSV value of the cell in front of the face of the matching portal cell in the other zone, and vice versa. Since each face has a direction (for example in simple cases would be North, East, South, West), which cell is semantically in front depends upon which face the portal is being opened, and therefore there is a shift of plus or minus one row or column for each of the two faces. Each zone has its own portal faces, and they need not be in the same orientation. Because of that, the PREC stores the orientation angle 1310 and the summation of the row 1306 and column 1308 shifts for each zone. The shifted row and column values in the two PRECs are not numerical opposites, because they are the difference in the coordinates of the two zones, adjusted by the offset from face of the current zone.

In one embodiment, each PREC 1304 record has an associated key name 1314 stored as a hash value in the zone object, and the PREC can be found later by from its key name 1314 (key). In one embodiment, the PREC keys contain the coordinates of the portal within that zone as part of the name, combined with a unique identifier to allow multiple PRECs/portals to be defined within the same cell or panel. For example, when a wall panel displays six different products for an online store, each product can have its own unique PREC key, and therefore its own unique portal. In one embodiment, the PREC key names contain the plan coordinates and it is possible to identify all portals that have been created for a particular coordinate pair of a zone, or a particular item on a wall. This makes it simple to close any portal and then re-open it later. Because plans and zones have small memory footprints, a large number of portals can be created and not necessarily cause a major system resource impact.

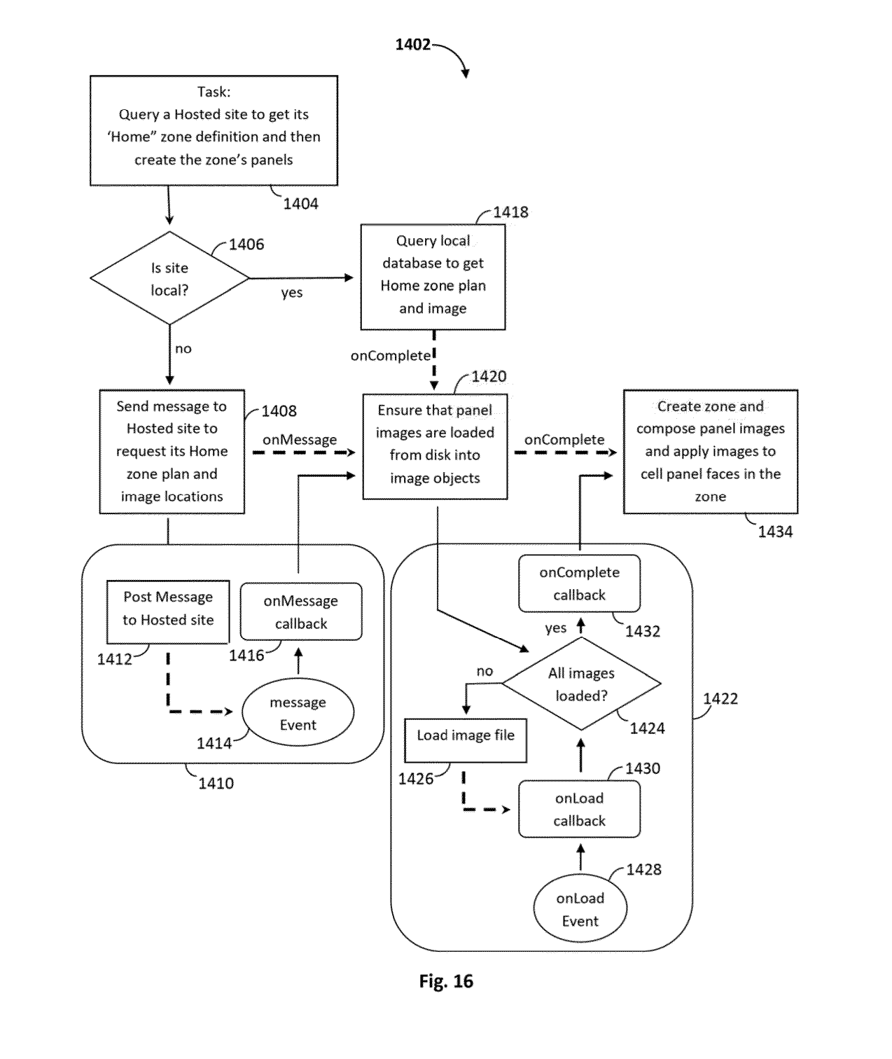

FIG. 16 shows one embodiment of the Image-Loading Layer 11 implemented as an event-driven process 1402. The Image-Loading Layer 11 operates in conjunction with the Portal Graphics Engine 4. Since image files can be quite large and the time to load them could be noticeable to the user, and responses from database queries can also take noticeable time, in one embodiment, operations within the graphics engine that require them are performed in a series of steps, with each step invoking the next when it is completed. To those competent in the art, this is commonly known as “event-driven” operations. As shown in FIG. 16, the basic design is that an operation, such as creating a wall image, is segmented into discrete steps, at points where time-consuming actions may occur, and each step “calls back” the next when it is completed. This permits operations such as loading files and awaiting responses to database queries to run asynchronously, in the background, allowing the foreground user interface to continue to operate normally. When the time-consuming operation is completed, it triggers an “event.” When the operation is internal, then the event may be handled by a direct callback to the next step's function. When the operation is external, such as loading a file or receiving a message from another site, then typically an event handler is registered with the browser or operating system to receive notification of completion, and that handler then calls the next step's function. Then that next step's function resumes the main operation. Certain operations may involve several such steps before the final result is completed.

For example, as shown in FIG. 16, when constructing a zone, it may be necessary to load several image files before the wall images can be drawn, then the code that would construct the zone might result in the following segmented steps: (1) query 1404 the database layer for the site to get the filenames to be loaded; (2) load each of the image files 1420; and (3) when the last image file is loaded to complete 1434 the construction of the zone and then open the portal to it. The process of querying 1404 the database layer for the site to get the file names to be loaded may be comprise the steps of sending 1408 a message to the Hosted Site to request the home plan and image locations. The Hosted Site receives and processes 1410 the message, causing a message event to occur and a response to that message to be sent to the Portal Graphics Engine 4. The process of constructing the zone is then put on hold until a response is received from the Hosted Site. The message sent to the hosted site is posted 1412 to the hosted site for processing. The Hosted Site processes the message from the database layer, and may send a return message event 1414. The message event 1414 may be received by the message-event callback handler 1416, which may call the next step 1420 in the sequence of the event-driven process to load the images. The response from the Hosted Site includes the image files to be loaded, which are then loaded by the Image Loading Layer 1422 using a recursive, or other, process at the Portal Graphics Engine 4. In one embodiment, a recursive process comprises checking 1424 to see if all images of the site have been loaded. If all of the images have not been loaded, the next image file is loaded 1426 into the system. A callback 1430 is then processed to determine if all of the image files have been loaded. Once the check 1424 indicates that all image files have been loaded, a callback completion 1432 may be activated to call the next step 1434 for the caller of the Image Loading Layer 1422. Once all of the images have been loaded, the Portal Graphics Engine 4 completes the creation of the zone and opens the portal to the new zone. The user would see the portal closed, and then a short time later, it would open. Various visual cues can be provided to the user, on a site-by-site basis, to indicate that such a delayed operation is in progress. For example, a common technique is to have a type of status bar show the loading by elongating as time proceeds. A more sophisticated example might be to show an elevator window passing floors. In one embodiment, an icon at the top of the portal doorway changes colors.

In one embodiment, such segmented asynchronous operations are used throughout the design of the graphics engine, for any operation that might not complete in a tiny amount of time, so that the user interface remains interactive at all times. This is critical to maintain the real-time aspects of the user interface: every operation must compete within the time frame of a timer tick.

In one embodiment, the Event and Messaging Layer 10 provides the mechanism by which time-dependent data (events) such as user actions and system notifications are interpreted and acted upon. The Event and Messaging Layer 10 may allow the application code, and therefore the zones, to attach user interface functions to such events. The Event and Messaging Layer 10 may comprise two parts: event hooks and the event processor. Event hooks are built-in routines that receive or intercept input and system event messages, and signal an internal event to the event processor. Examples of event hooks include, but are not limited to: mouse clicks, keystrokes, user position and movement, proximity to and user movement with respect to zones or walls or objects, database message received, and file load complete. These event hooks may be the primary interface between the graphics engine and the environment outside of the program. In one embodiment, the event hooks comprise direct call-back functions associated with them, and directly invoke the response to the event. In one embodiment, directly invoking the response event completes the response to the event. Examples of this are the image-loading events and the database-message received events. In one embodiment, the event hooks invoke the event processor, which then dispatches the events associated with the hooks.

In one embodiment, the event processor is a simple table-driven automaton that provides call-back dispatching for internally-defined events. The event processor may support two user-definable data types: event types and events. Event types are objects that are containers for events which enable groups of events to be processed together. In one embodiment, each event type has one or more evaluation queues. In one embodiment, each event is a data object, and has an event type as its parent data object. In one embodiment, each event has a list of other event objects that depend upon it, a link to its parent event type, and an evaluation level within that event type. To evaluate an event, the application may schedule an event with the event's parent event type. The application invokes the event processor on the parent event type. In one embodiment, the event processor evaluates events in a series of event queues within their parent event types, and schedules any other event objects that depend upon the current event being evaluated. In one embodiment, events may be conditional or unconditional.

Conditional events have an associated function that the event processor calls when it is evaluating the event object. This function is allowed to have side-effect upon the application, and is one mechanism by which the event layer calls back the application for an event. Conditional event functions return a status, true or false, indicating whether the condition they represent tested true or false. When the status returned from a conditional event is true, the event processor will then schedule any events that depend upon it. Otherwise, those events are not scheduled.

Unconditional events may behave in the same manner as conditional events, except that there is no test function, and the dependent events are always scheduled when the event processor evaluates an unconditional event.

In one embodiment, the event processor's scheduling function may make a distinction between scheduling dependent events that are conditional and unconditional. Unconditional events may scheduled by recursively calling the event scheduler on the list of dependent events. Conditional events may be inserted into an evaluation queue within the parent event type. In one embodiment, each conditional event has an evaluation level, which is an index into the array of evaluation queues for its event type. The event processor may evaluate the event queues for an event type in order, starting with queue 0, and removing and processing all the event objects in that queue, before moving to the next queue. This process continues until all queues that contain event objects for an event type have been processed. The conditional event's evaluation level provides a sorting mechanism, that allows the application or site to ensure that a conditional event does not run until after all of the events that it depends upon have been processed first. The correct evaluation level for a conditional event may be set by, for example, the application or remote site.

In one embodiment, the event processor processes one event type at a time. In one embodiment, a conditional event can be added that when evaluated recursively invokes the event processor on another event type. Since each event, conditional or not, has a list of dependent events, this allows multiple callbacks to be registered for the same event. This is the main purpose of the event processor: to allow the application or sites to register for events without colliding with other uses of the same event.

In one embodiment, the graphics engine registers events with the event layer, to get callbacks on user actions. Callbacks may include, for example: user mouse clicks, user positional movement, and user keystrokes. In one embodiment, the event layer allows the construction of higher-level events, based upon complex conditional-event test functions, allowing the creation of high-level events such as “LOOKING_AT”, “STARING_AT”, “APPROACHING”, “ENTER_ZONE”, “LEAVE ZONE”, and “CLICK_ON_ITEM” to name just a few. In one embodiment, application and site definitions can include event declarations as well as layout descriptions. This means that any particular site may define its own events and event types, specific to the purposes of that site.

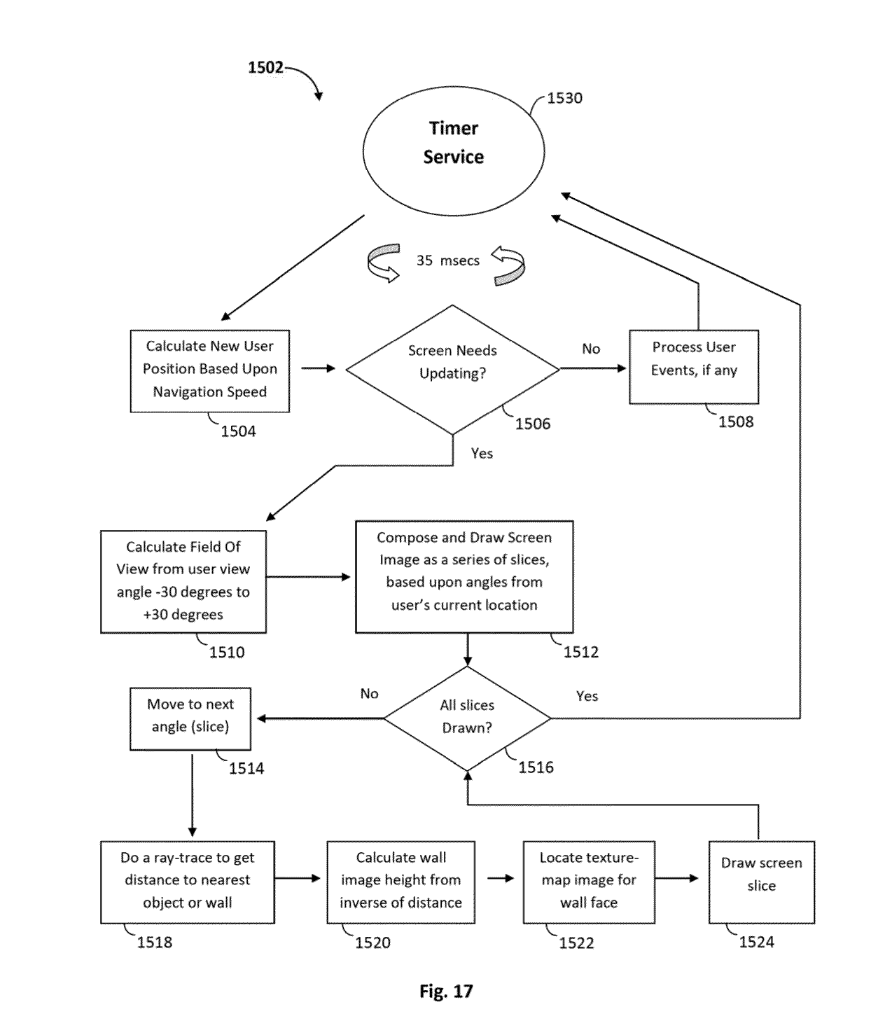

In one embodiment, shown in FIG. 17, the real-time screen-composition layer employs a real-time ray-tracing algorithm that comprises: calculating the change of the user's visual position within the zones, calling the ray-tracing function that calculates a series of image slices, calling the drawing function that displays those image slices, and reconstructing the screen image. When the process of reconstructing the screen image is repeated fast enough, it presents the illusion of a moving 3D virtual reality. To make this work, the screen must be regenerated in a small enough amount of time that the screen does not appear too jerky. That means it has to be very fast.

As shown in FIG. 17, the real-time behavior is sequenced by a simple timer service layer 1502 that calls back the graphics engine on regular time intervals. In one embodiment, the regular time interval may be about 35 milliseconds, or a frame rate of about 28.5 frames per second. Thus, every 35 milliseconds the timer service 1530 calls back an application function to do some work. This callback is sometimes referred to as a “tick.” On each tick, the application callback function must do whatever it needs to, but be done before the next tick fires, or the system will slow down. Real-time systems have to be very fast, in order to not overlap with the next timer tick event.

Real-time ray-tracing is ray-tracing done fast enough to keep up with the timer ticks, so as to provide a smooth animation effect to the user. To achieve real-time ray tracing, in one embodiment, on each timer tick the screen-composition layer is called, which then calls the navigation function 1504 to calculate the user's movement through the zones, then calls the ray-trace function 1506 to update the screen image, and then calls the event processing function 1508. The combination of the three functions generates one “frame” of an animation sequence.

In one embodiment, the process will repeat every 35 milliseconds. In one embodiment, the timer service 1530 activates an application to calculate 1504 a user's position based on the user's navigation speed. The application checks 1506 to see if the screen needs updating such as, for example, based on a change in the user's position, orientation, or if the screen is marked for update by other screen changes. The application updates the screen if it needs updating, then may check to see if any user events have occurred, and may process 1508 the user events, if any. If the user's position or orientation has changed or update was marked since the last tick, the application begins a process for updating the screen.

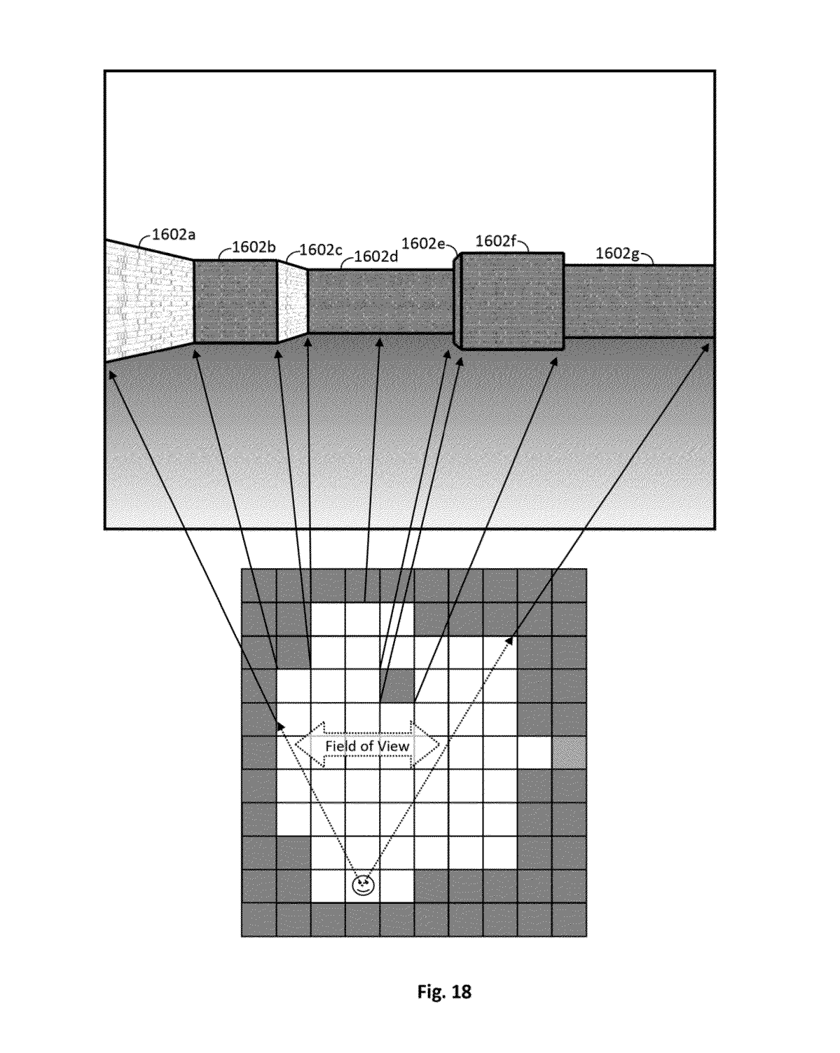

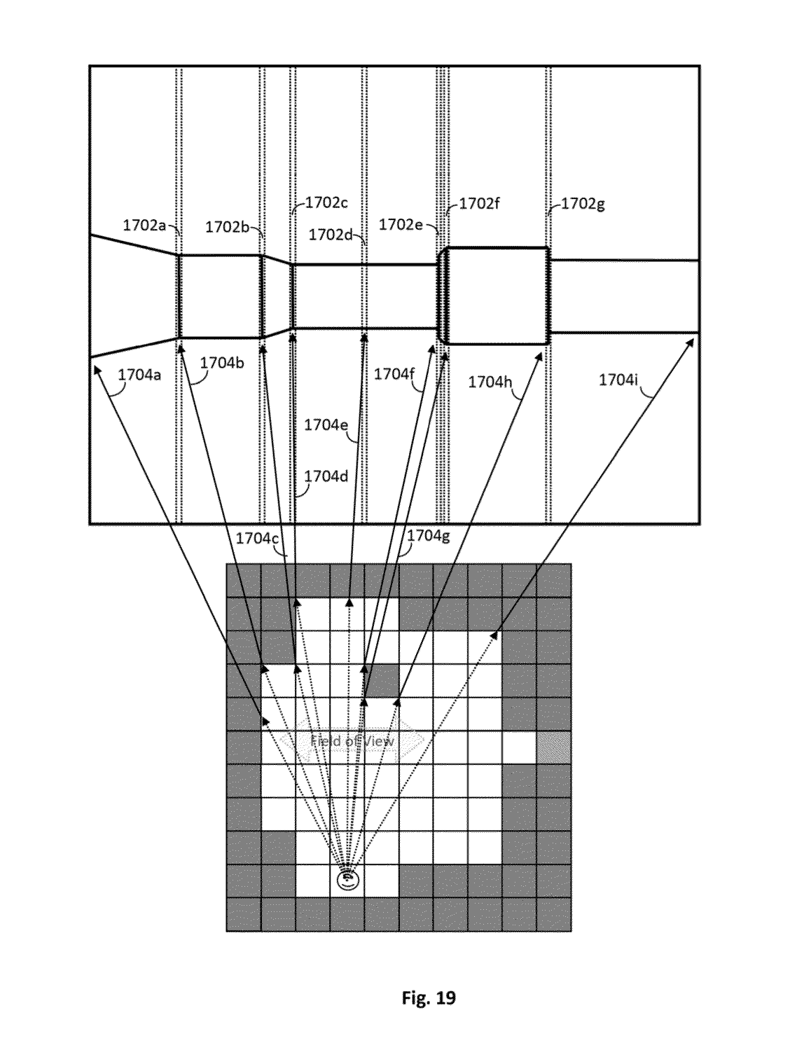

In ray tracing, at each timer tick, the image must be reconstructed. FIG. 18 shows one embodiment of a completed ray-trace showing wall panels 1606a-g. To achieve this, as is shown in FIG. 19, the visible portion of the screen is sliced into sections, such as example slices 1702a-g. For each section, the ray-trace algorithm calculates the angle of that slice 1702a-g with respect to the user viewpoint. It then simulates the path a ray of light 1704a-i might take when emitted from that point. This in turn indicates what would be visible from the user's viewpoint at that precise angle. The process of determining what would be visible at that angle is called a “ray trace.”

For each angle, the ray-trace algorithm scans out from the point of the user at that angle, until it encounters a solid object. That object could be a wall panel 1606a-g, or some other solid object, such as a component object. For example, inside of a room, a ray trace might intersect with a chair in that room. When it encounters a solid object, the ray-trace then captures a sliver of an image of that solid object. How big that sliver is depends upon the scan resolution of the ray-trace, and whether the trace is simulated 3D or true 3D. In one embodiment, a true 3D ray trace is used. In true 3D, the “ray” being traced is a single line, and there are two angles to be considered, horizontal and vertical. In another embodiment, simulated 3D is used. In simulated 3D, sometimes known as 2.5D, the ray-trace ignores any depth differences in the vertical direction, and just copies the image as a vertical slice. Some realism is lost in this technique, but it has large performance benefits.

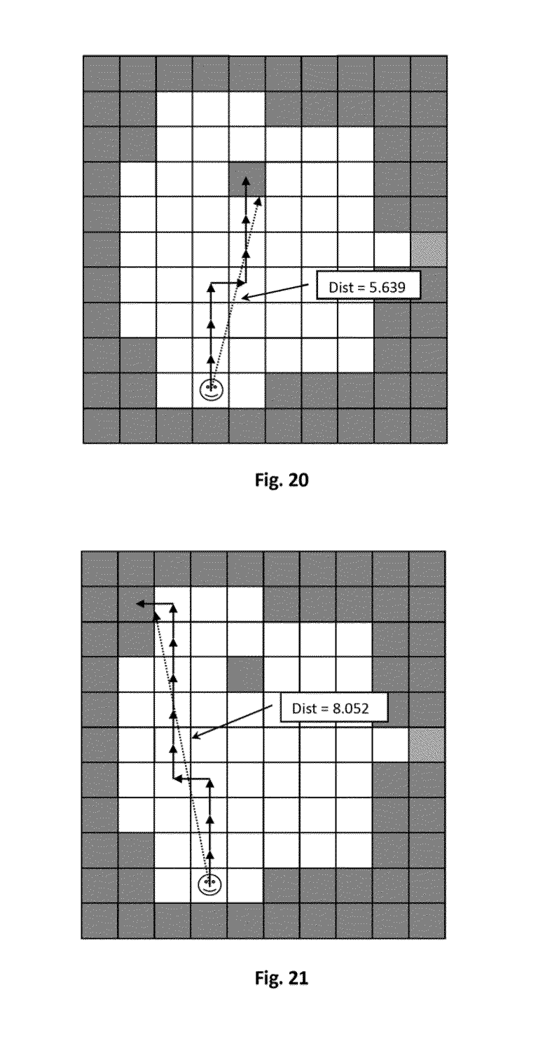

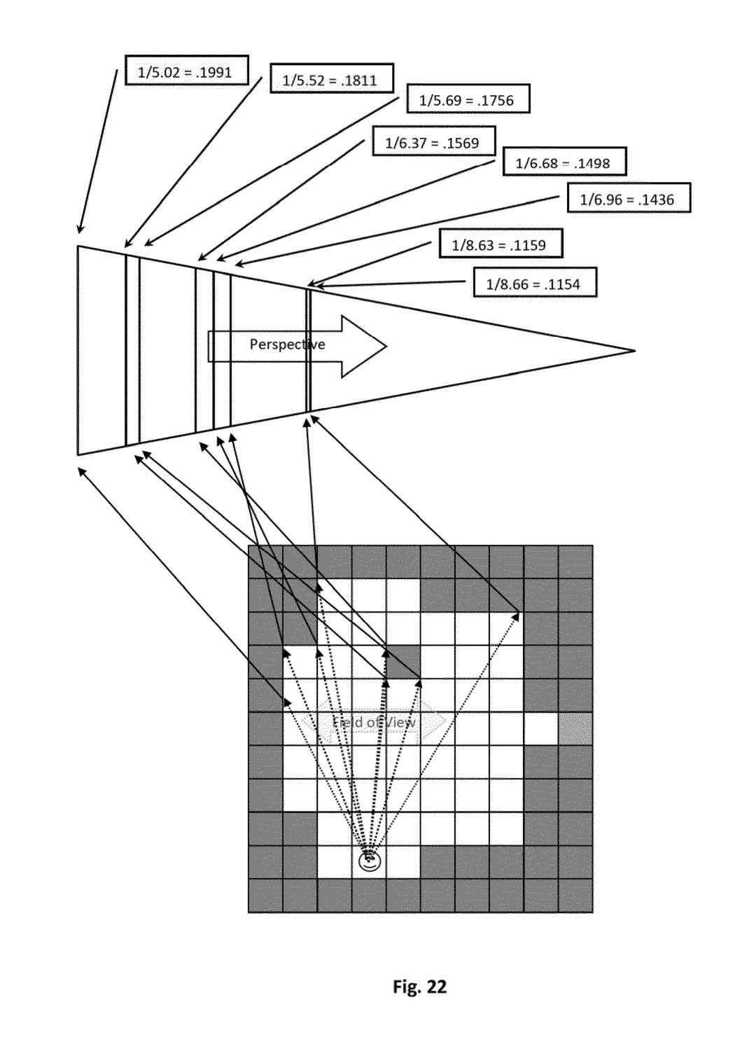

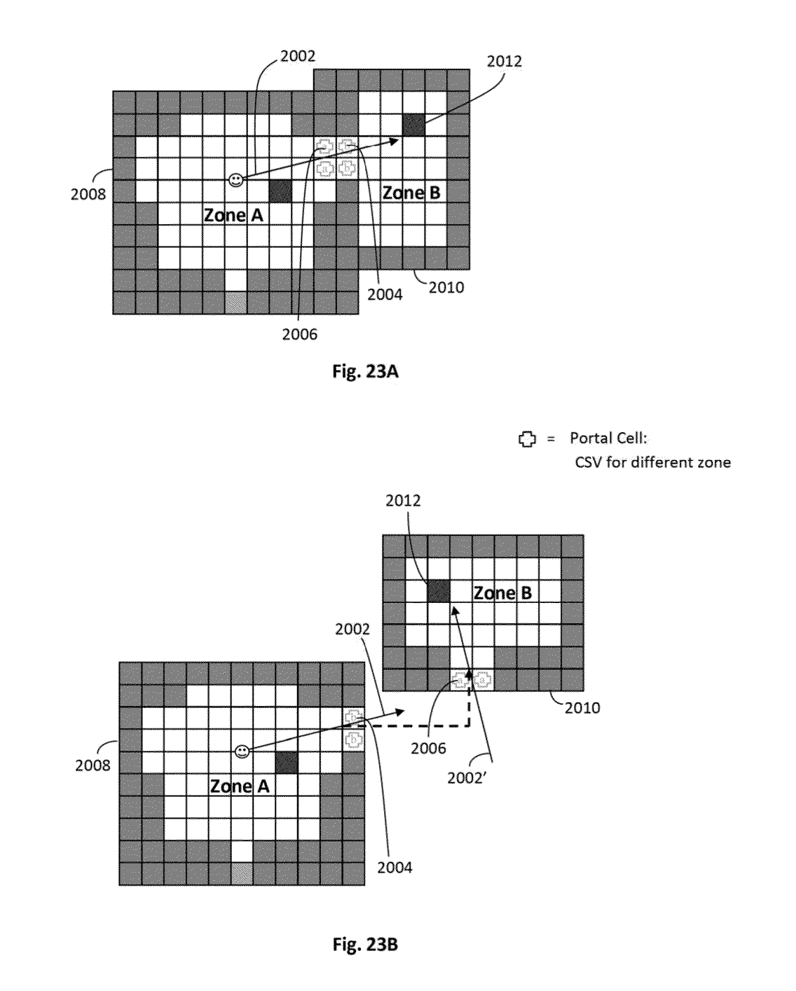

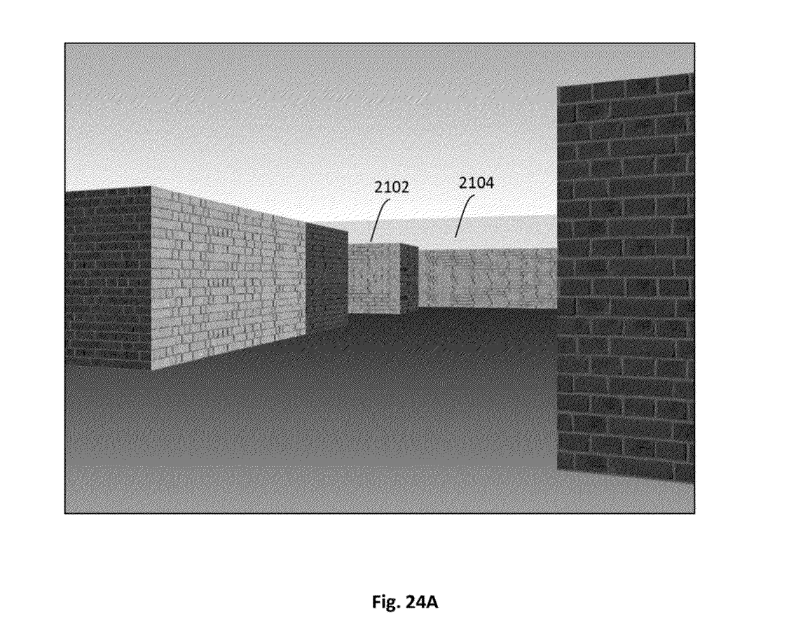

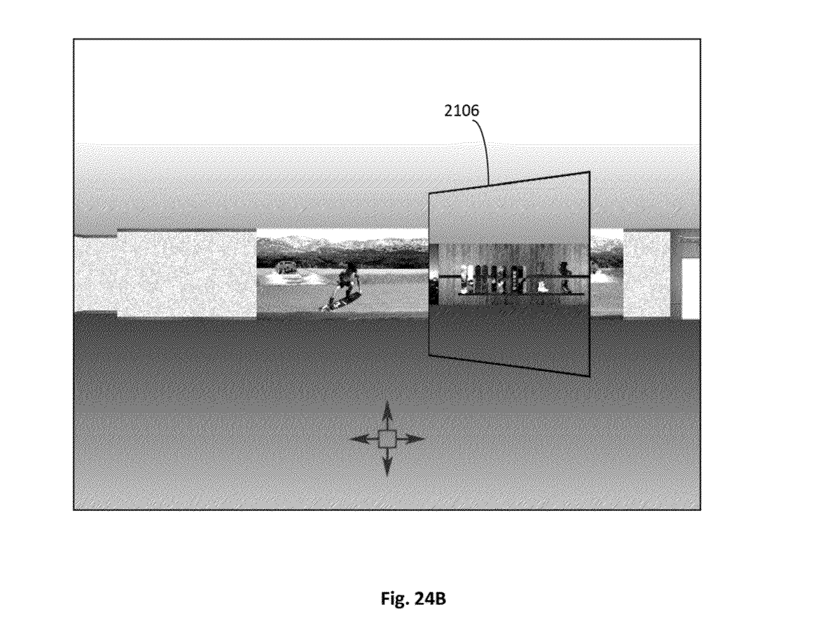

In one embodiment, a simulated 3D ray-trace algorithm is used, as shown in FIGS. 18-22. As shown in FIGS. 18 and 19, for each slice, the ray-trace function returns the distance to the first solid wall or object. That distance is used to calculate the wall or object height to generate the perspective effect. In one embodiment, a simple 1-point perspective is used, and so the perspective is proportional to the inverse of the distance. Thus for example, walls or objects that are twice as far away are one-half as big, and objects that are 8 times as far away are ⅛ as big. FIGS. 20-22 show a graphical representation of the perspective effect for a simple room plan. The overall effect of ray-tracing is that the image presented to the user has perspective. Objects that are further away are smaller, and objects that are closer are larger. This gives the user the sense that they are “in” the 3D environment, and provides an immersive experience.

In one embodiment a modification is made to normal ray-tracing techniques to support the wormhole portal effect. As shown in FIGS. 23A and 23B, the ray-trace algorithm detects when a ray trace 2002 enters a cell in a zone's 2008 plan that is marked in its CSV cell value as being in another zone 2010 (portal cell 2004). When this occurs, the ray-trace algorithm loads the PREC for that portal cell 2004 by looking up the cell coordinate in the zone 2008. To translate the ray 2002 to the new zone 2010, it is necessary to convert its coordinates and direction in the current zone 2008 to the equivalent coordinates and direction in the new zone 2010. The PREC contains these corrections. The ray-trace algorithm adds the coordinate offsets in the PREC to the current coordinates to get the new translated coordinates. It then checks the direction angle adjustment. When the new zone 2010 has a different orientation than the old zone 2008, then the position that the ray has entered the cell 2004 has to be rotated by the angular difference. Further, the trace variable values have to be rotated as well, so that the orientation of the two zones 2008, 2010 behaves as if the ray 2002 continued in a straight line. Once this adjustment is completed, the ray-trace 2002′ continues normally within the new zone. This process continues until the ray-trace 2002′ encounters a solid object 2012, in whatever zone it ended up in. Some ray-traces might cross several portal boundaries before encountering a solid object. But in all cases, the resultant generated display image appears to all be in one direction. FIG. 24A shows one possible rendering of the ray-trace algorithm when displaying the open portal in FIG. 23a. The block 2012 renders as a box 2102 behind a semi-transparent portal wall 2104.

In some embodiments, a modification is made to normal ray-tracing techniques to support a wormhole portal effect on surface portals. As shown in FIG. 10G, the ray-trace algorithm may detect when a ray trace 1014 encounters a component object that contains a surface panel 1006′ marked as a portal. When encountering a surface panel 1006′ marked as a portal, the ray-trace algorithm may load the PREC for the surface portal, which may be stored within the surface panel 1006′. The ray-trace algorithm may add the coordinate offsets and rotations in the PREC to the current coordinates to get the new translated and rotated coordinates. The ray-trace algorithm may further recalculate the trace variable values. Once the coordinate offsets, rotations, and recalculation are complete, the ray-trace 1018 continues normally within the new zone. In some embodiments, surface portals may span multiple cells. FIG. 24B shows an example of an open surface portal defined as a flat surface 2106.

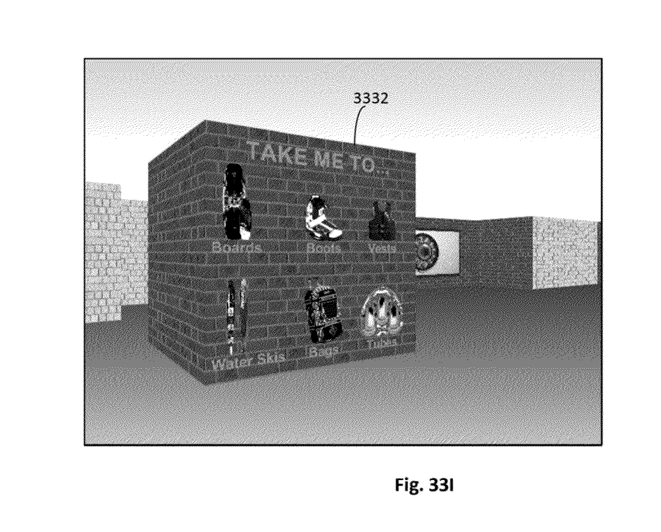

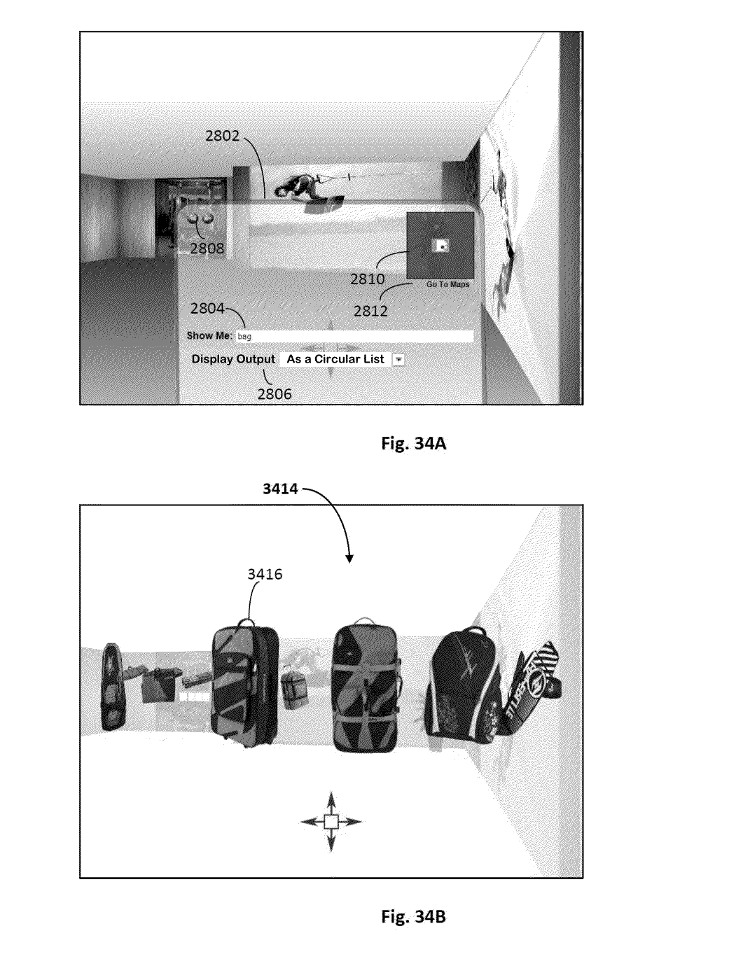

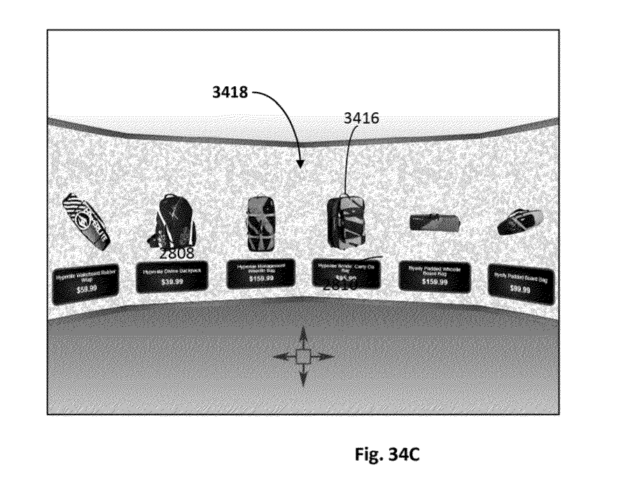

In some embodiments, any number of surface portals may be present within a single cell, and may intersect each other. In one embodiment, a “circular room” may be created in which the wall panels are component objects connected together to form a closed polygon, such as, for example, the room shown in FIG. 34C. Each panel may become a surface portal based upon the user interacting with it. It will be appreciated by those skilled in the art that any number of other shape combinations may be possible using component objects and surface portals.

In one embodiment, a zone 2010 that is attached using a portal is modified so that its orientation and coordinates are compatible with the originating zone 2008, which can increase run-time performance because the rotation and translation calculations are unnecessary. Such embodiments are less flexible than when the calculations are done during ray-tracing, and can have the limitation that generally only one portal can be opened to the modified zone 2010 at a time.

In one embodiment, the screen-composition layer can draw multiple plans for a zone on top of one another, to create special effects. In one embodiment, each plan may be drawn on a separate canvas, and one or more secondary canvases may overlay a primary layer to create a layered or matte effect. Each zone can have one or more secondary plans in addition to a primary or base plan. These secondary plans are used to generate special effects, such as the transparency effect in FIG. 24A and FIG. 25. In one embodiment, secondary plans may be active or inactive. An inactive secondary plan is a plan which is stored for the zone, but may not be displayed to the user. In one embodiment, the screen-composition layer may track whether a zone has any active secondary plans, and invoke the ray-trace and drawing functions for each additional plan after drawing the primary plan. The screen-composition layer may perform this function for each screen update. Secondary plans allow the site to create various special effects, by having wall or object details that differ from the primary plan or the other secondary plans. Secondary plans may create a performance hit when active, as it can take nearly as much or more CPU time to draw the secondary plans as for the primary plan. Thus, for example, when a zone has a single active secondary plan, and the entire secondary plan were processed, the performance will be approximately twice as slow while the user is in that zone than it would be when the user is in a zone with no active secondary plans. In one embodiment, the ray-trace function reduces the performance impact by only processing the portions of a secondary plan where slices (or samples) intersect a wall or component object. Processing only a portion of the secondary plans increases the performance of displaying those plans.

In one embodiment, semi-transparent (or temporary) portals are displayed by creating and activating a secondary plan for a zone. The transparency plan for a zone usually contains the original structure of the primary, as it was before the portal modifications were added. To achieve transparency, the cells that are not portals are marked with a CSV that is completely transparent, and the cells that are portals are marked with a CSV that is partially transparent. The ray-trace sees all of the walls, fully-transparent or partially, so that the images clip to wall boundaries correctly and normally. The special effect occurs in the drawing function, which skips over fully transparent wall images, but draws the clipped semi-transparent ones on top of the rendered screen image of the original plan. Because the semi-transparent screen image overlays the original screen image, the effect is a semi-transparent “ghosting” of the original zone's imagery where the semi-transparent portals are open. In some embodiments, portals may be created that allow visual images to be displayed, but do not allow a user to pass through them. Portals which allow visual images but do not allow a user to pass through may be used to generate solid windows. In some embodiments, the solid window portals may be generated by modifying the ray-trace algorithm to interact with solid window portals and modifying the navigation algorithm to prevent interaction with the solid window portals.

FIGS. 25 and 26 show one embodiment of a user view in a 3D virtual reality space with an open portal. FIG. 25 shows a user view 2212 from the perspective of a user standing in the first location 2208 as shown in FIG. 26. FIG. 26 shows a floor layout 2202 as perceived by the user 2208. As shown in FIG. 26, two zones, Zone A 2204 and Zone B 2206 are connected by a portal 2210. The portal 2210 connects the two zones so that they are perceived as a single zone by the user 2208. Although Zone A 2204 and Zone B 2206 are shown physically connected, the connection corresponds to only the perception of a user 2208, and Zone A 2204 and Zone B 2206 may not be physically connected and may be, in one embodiment, located in different spaces.

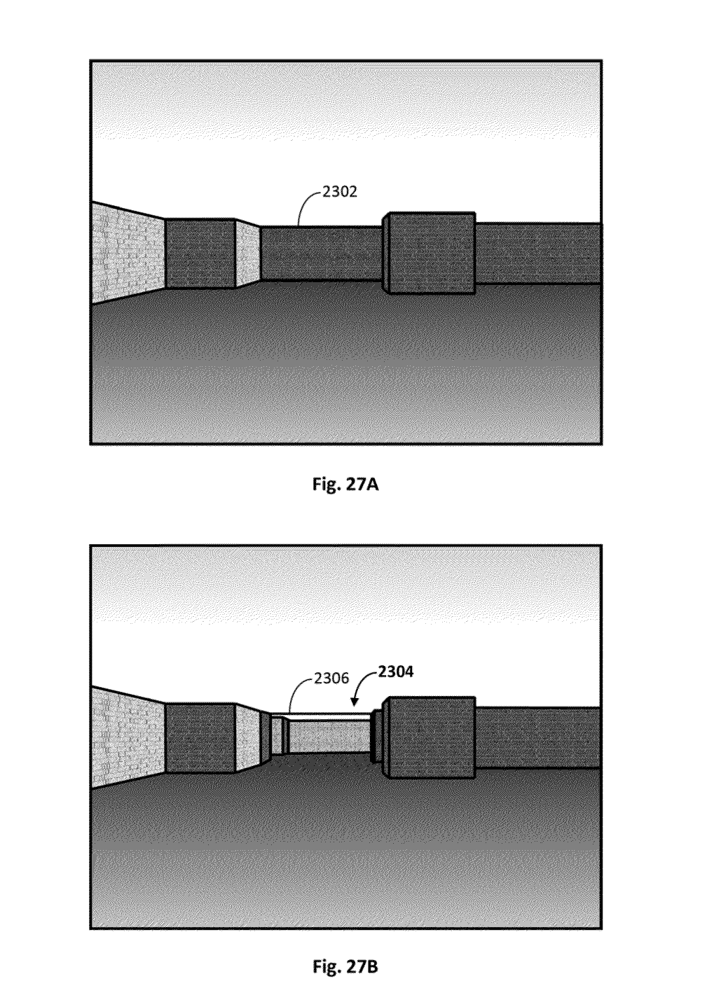

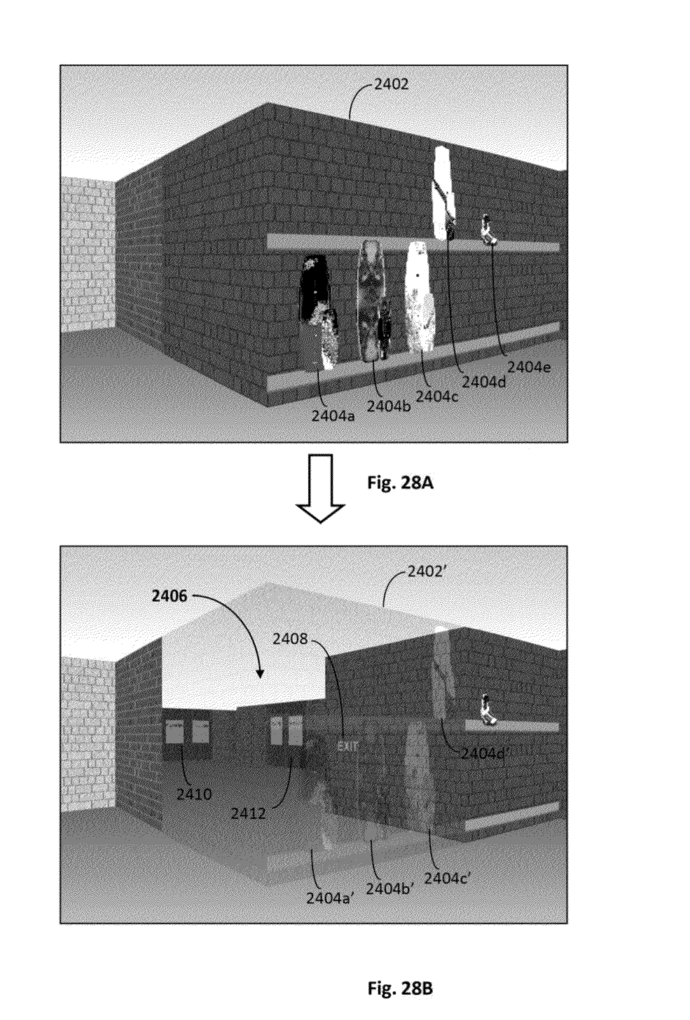

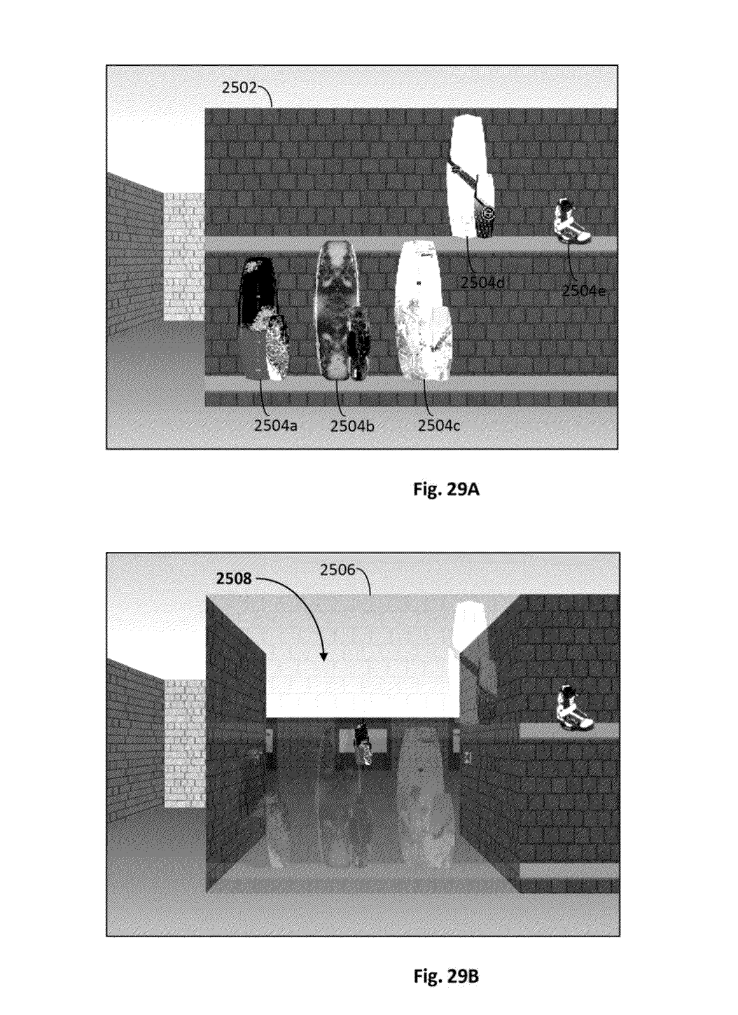

FIGS. 27A and 27B show one embodiment of a user view in a 3D virtual reality space before and after a portal is opened in a wall. FIG. 27A shows a user perspective before the portal is opened. Directly in front of the user is a wall 2302 which is a solid object and cannot be navigated through. The user may initiate the creation of a portal at the location of the wall 2302. In one embodiment, the user may initiate the creation of a portal by clicking on the wall. In another embodiment, a portal may open by the user approaching it. In another embodiment, a portal may open in response to some other user action. FIG. 27B shows the resulting user view. After the new zone has been loaded, the portal 2304 is opened in the location of the wall 2302, which is no longer present. A transparent image of the wall 2306 remains as an indication to the user that the portal opened in the location of the wall 2302. After the portal 2304 has been opened, the user perceives a new zone of the layout seamlessly connected to the first zone.

In one embodiment, once a portal splice has been established, the screen-composition layer merges all of the zones seamlessly into one large virtual reality spatial area. Any movement by the user within the VR environment will appear in all respects as one single space. The portal interface allows interesting interactions between the layout.

In one embodiment, the movement calculation comprises adding an angled vector to X and Z coordinate values. The movement calculation may further comprise a user velocity algorithm, which gives the perception of acceleration or deceleration. In one embodiment, the velocity combined with the user view angle provides the dX and dZ deltas that are added to the current user position coordinates on each timer tick. The new calculated position is then the input to the ray-trace algorithm, which then displays the image from the new viewpoint. As the user navigates around, the user's current location is changing within the plan coordinate system, crossing from cell to cell within that plan, and displaying the new viewpoints. The result is that on each timer tick, the user's “camera” view may change slightly, either forward, back or turning, giving the illusion of movement.

In one embodiment, the basic navigation algorithm is modified by adding in the same portal-boundary detection as is used in the ray-trace algorithm. The navigation layer may detect when the user has moved (navigated) into a cell within the current zone's plan that has a CSV value that indicates another zone. When the navigation layer detects a cell with a CSV that indicates another zone, the navigation layer adjusts the user coordinates and view angle to the new plan position and orientation. The user experience is that of smoothly seeing forward, moving forward, and operating in a single zone. There is no perception of changing zones.

The net effect is that any two zones can be seamlessly spliced or merged together at their portals, into what appears to the user as a single larger spatial area. All visual effects and movement effects present the illusion of a single space. In some embodiments, the navigation algorithm may be modified by adding a portal boundary detection for surface portals, similar to that discussed above with respect to the ray-trace algorithm. When the navigation layer detects a surface portal within a component object, the navigation layer may adjust the user's coordinates and view angle to the new plan position and orientation. In some embodiments, the surface portal may indicate a different zone. The navigation layer may use the adjusted coordinates and view angle to seamlessly move the user into the new zone.

In one embodiment, the 3D environment comprises the ability to merge multiple websites. In this embodiment, a remote site would provide a database layer that presents read-only responses to database queries for the remote site descriptions. A host site may use the database queries to display the remote site locally, allowing users to visit that site while still on their original site. The user may navigate to the remote site through a portal to a zone containing the remote site.

In one embodiment, the Portal Graphics Engine 4 creates a new site object, queries the remote site's database, retrieves the home room layout description, creates a new zone for it, and creates and opens a portal to that new zone. The Portal Graphics Engine 4 may retrieve the database-access information from each site object, allowing actions on local sites to communicate with the local database layer, and actions on remote sites to communicate with the remote site's database layer in the same precise manner. Once a portal is established to the remote site, that remote site's zones become indistinguishable from the local zones.

In one embodiment, the initialization code for a site (local or remote) provides the ability to define a wide range of descriptions, including but not limited to: defining zone and plan layouts, loading images, applying images to panels, applying text to panels, drawing graphic primitives on panels, declaring events and event types, and binding call-back functions to events. In one embodiment, the initialization descriptions are in the form of ASCII text strings, specifically in a format known in the industry as JSON format. JSON format specifies all data as name-value pairs, for example: “onclick”:“openWebPortal”. The details of JSON format are published and well-known.

JSON-format parsers and converters (“stringifiers”) are built into HTML-5-compatible browsers which offer a degree of robustness to the application. In one embodiment, by specifying the initialization data in JSON format, it is easier for external sites to provide entry points to their sites that will work with other sites with a high probability of correct interpretation.

In one embodiment, any 2D image can be displayed upon a wall or object surface with full perspective, including animated images and videos, such as, for example, video 3326, as shown in FIG. 33H. Animated images and videos may be displayed on wall surfaces by copying each frame to an intermediate canvas image, prior to the call to the ray-tracing function. In one embodiment, the screen composition layer has an animation callback function hook that can point to a function to be called at the start of each composition pass. When an animation is running, or a video is playing, the animation hook is set to an animator function that loops through a list of animation-rendering functions. Each rendering function processes the composition and image transfer of one image to animate. For example, to render a running video image, its rendering function copies the current video frame to a canvas image. That image is then used by the drawing function to display that frame with perspective rendering. This process occurs once per timer tick, so the displayed video frame rate will be that of the timer frequency. The result is a smooth animation that can be viewed at angles, with perspective.

Unlike a 2D website, the large number of possible rooms allows for a potentially large number of videos and other animations. Whereas in a 2D website it might be reasonable for a video to begin running when the page loads, in a 3D website this is generally not practical. Videos and other animations take CPU time to run, render and display. When more than one runs at the same time, it can slow down the entire display. Some videos have sound, and when more than one was running at the same time, the result may be garbled. But even when there is only one such animation, it makes little sense to be running it unless the user can see it.

In one embodiment, videos may be started by a user action. The Event and Messaging Layer 10 may initiate videos on a user action such as, for example, mouse clicks or other user actions. For example, a conditional event can be registered for when a user enters specific zone or cell, or approaches a wall or object, and that event can call the video-start function, which then adds the video's rendering function to the animator's rendering-function list. A second conditional event can be registered for when a user leaves that zone, cell, wall, or object, that calls the video-stop function for that same video. As an example a video could run when the user enters a zone and stop when he or she leaves it. This makes for a simple way to do promo videos and other interesting animations, as shown in the embodiment in FIG. 33H.

In one embodiment, while a video or animation is running, the composition callback function must run on every tick. This can use a significant amount of CPU time. In one embodiment, an event is added to video displays that removes the video rendering function from the rendering function list when the video completes, to reduce unused system resource usage. When the last rendering function is removed from the rending function list, the animation callback hook is set to null, thereby disabling the animator function.

For the user interface environment to be usable in a broad range of contexts, the system needs to exhibit consistent behavior across those contexts. In one embodiment, the graphics engine provides certain built-in behavior standards to ensure a consistent user experience from site to site. While each site will have unique walls or other features, the graphics engine provides default standardized behavior that will occur unless the application overrides it.

In one embodiment, a user can specify a selection of a wall, image on a wall, or component object by approaching directly towards it. When the user gets close enough, the same selection behavior may be triggered as would be triggered from clicking on the target. In one embodiment, the distance at which the behavior is triggered, or approach distance, may vary depending upon the object or object type. The select-by-approaching behavior makes the 3D interface more consistent and easy to use, since the user makes most choices simply by moving in particular directions.

In one embodiment, the Portal Graphics Engine 4 may open a portal anywhere, including in place of an existing wall or other object or in the middle of a room. In one embodiment, portals may be opened temporarily, for the duration of some user action, and the room (zone) is restored to its original condition later. When a portal is opened at the location of an existing wall or object, it can be visually confusing to the user, as the portal will be a doorway to a spatial area that may be visually incompatible with the contents of the current zone. The resulting visual anomaly can be disconcerting or even disorienting to some users.

In one embodiment, as shown in FIGS. 28A and 28B, portals may be opened showing the original wall or object contents (or even some other visual element) as a semi-transparent or “ghost” image in its original position. The semi-transparent effect is created by adding a secondary plan to the zone of the temporary portal, if none already, then activating that secondary plan, as detailed above. For example, as shown, when a portal to a zone is opened on a wall, the original wall texture will still be slightly visible, helping the user visualize the location and nature of the portal. Such portals (temporary portals) are special only in that they display the original wall or object images semi-transparently. But the ghosting effect greatly reduces user disorientation. In one embodiment, the wall transparency (ghosting effect) may be proportional to the distance of the user from the portal. When the user is beyond a certain threshold distance, the wall may appear to be solid. As the user approaches the wall, the wall may become more transparent proportional to the distance of the user from the wall, until the wall reaches a minimum transparency level. In one embodiment, the maximum threshold and minimum transparency may be defined for each portal that uses the effect.

FIGS. 28A and 28B show one embodiment of a user selection causing a portal to be created in the location of a wall, while maintaining a “ghost-image” of that wall for the user. FIG. 28A shows a wall panel 2402 prior to a user interaction. One or more items, 2404a-e, may be displayed on the wall panel 2402. When a user interacts with one of the items, for example the first wakeboard 2404a, a portal may be created to a zone containing content related to the user's selection. FIG. 28B shows the results of a user interaction with one of the items 2404a-d displayed on the wall panel 2402. A portal 2406 has been opened in the location of the wall panel 2402. Ghost images of the wall panel 2402′ and the items 2404a′-d′ are displayed in their original locations, to indicate to the user that a portal 2406 has been opened in the same location as the wall panel 2402. Once the portal 2406 has been opened, a user may pass through the ghost image of the wall 2402′ and enter the connected zone.

In one embodiment, because temporary portals show the original wall or object contents, they can help remind the user that the original wall contents or object are not currently accessible, but nevertheless let them see what they were. For example, when the user opened a portal for a product on a wall, the wall and any products on the wall panel are temporarily not there. For the user to access those other products, it is necessary to close the temporary portal (for example by using the click-inside method discussed below.) Seeing the wall panel and items as a ghost image greatly improves user comprehension of the user interface while the portal is open. The ghosting effect reminds the user that there is a temporary portal open in the location of the original wall panel, and also lets him or her see the original wall contents, and thus provides the visual cue that the portal must be closed first.

In one embodiment, pre-defined portals may be marked with a symbol to assist users in recognizing that a wall or object is a portal location. In various embodiments, the symbol may be located at the top center of a wall panel comprising an unopened portal. The symbol may change configuration to indicate the open/close/loading status of the portal, such as, for example, changing color or shape, as shown in FIGS. 31A-G.

In one embodiment, the standard behavior of the Portal Engine when a user approaches or interacts with (such as, for example, by clicking with a mouse) a wall or other object is to open a portal at that location. At any particular location, there may be several portals already defined for that location, and new ones may be defined by user action at that location as well. In one embodiment, which portal will be opened depends upon where and how the user approaches or interacts with a wall or object.

In one embodiment, users define the context of their interest or purpose by where and how they choose to open portals. In one embodiment, there are two main classes of responses to a user approaching or interacting with a wall or other surface: focusing and un-focusing. When a user approaches or interacts with a specific graphical image that is displayed upon a larger wall, the user has, in effect, expressed that the context of the interaction should be narrowed and more specific, focused around the nature of that selected image. Therefore, in one embodiment, the zone (room) that the portal opens to should reflect that narrowing, with a narrower and more specific range of choices that are offered to the user.

Conversely, when a user approaches or interacts with a wall outside of any specific graphical image, the user may have, in effect, expressed that the context of the interaction needs to be broadened and less specific, and therefore, in one embodiment, the room that the portal opens to should be more general, with more general types of choices offered to the user.

In one embodiment, both types of portals would normally open to a room (zone) that relates to the context and focus of the user's action. Some user selections may go directly to a specific destination location. Others may go to a junction room, a zone which offers the user more choices based upon that context, in the form of doorways or one or more items on one or more walls, or component objects in the room, each a potential portal to yet a more specific location. In a junction, the user refines his or her interaction further by opening one or more of the portal doors or interacting with one or more of the items displayed in the junction room. These portals can themselves lead to destinations, or to other junctions.

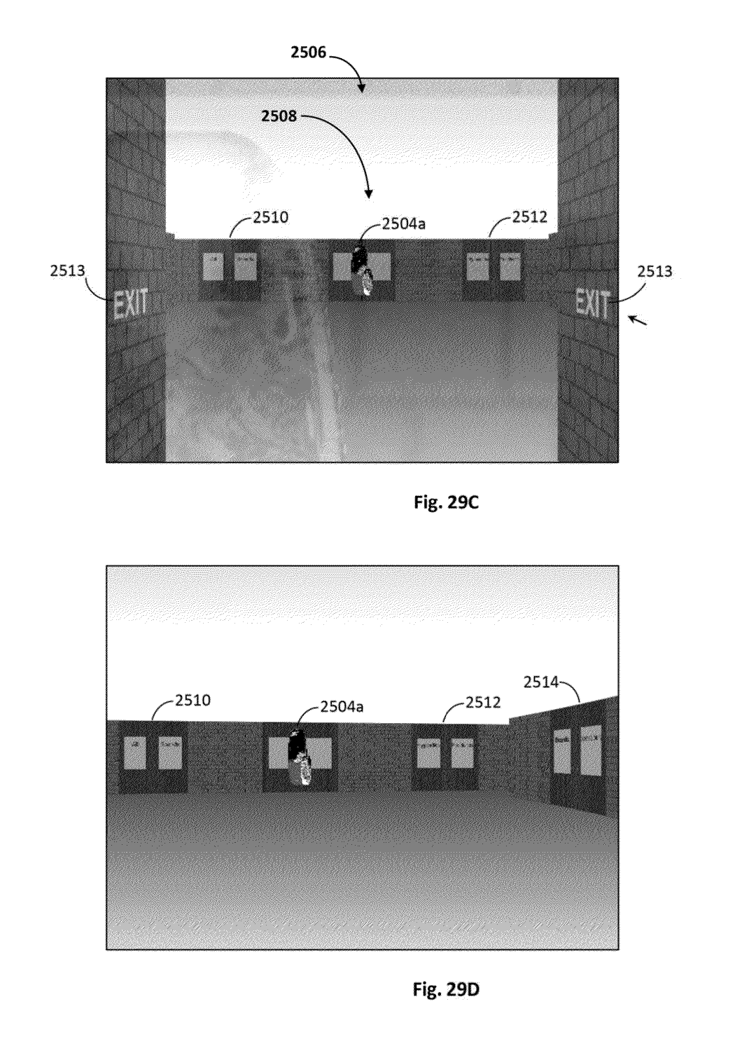

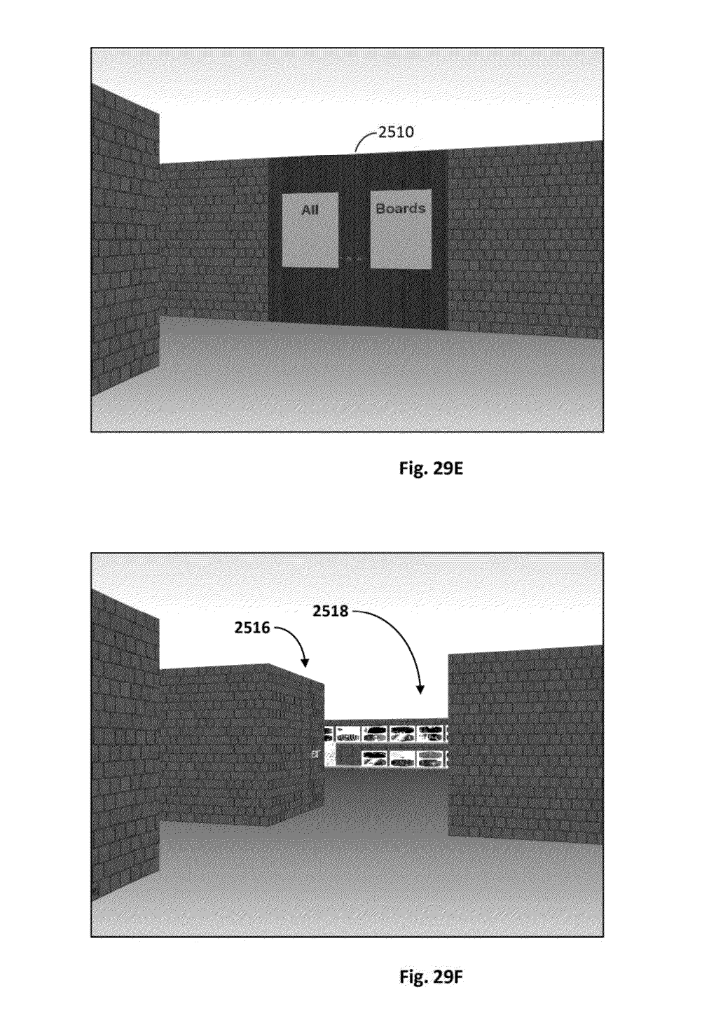

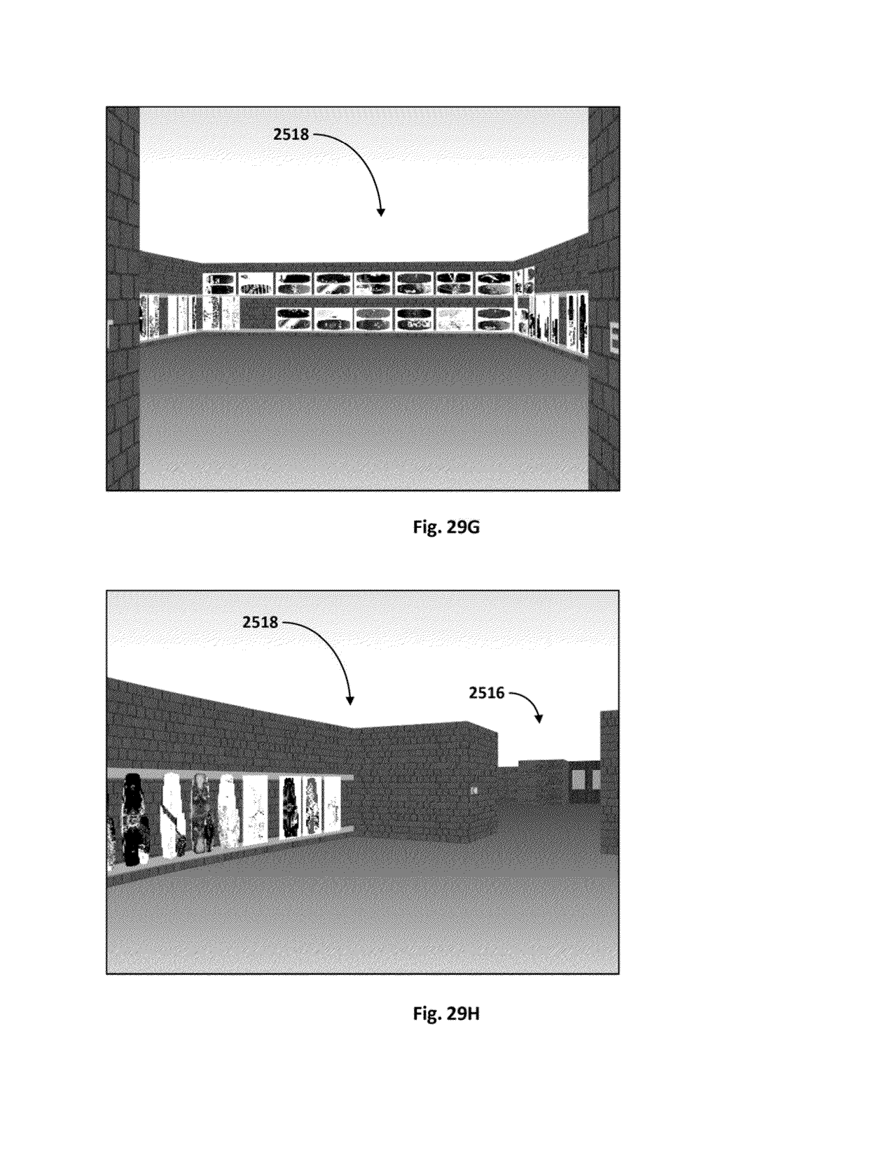

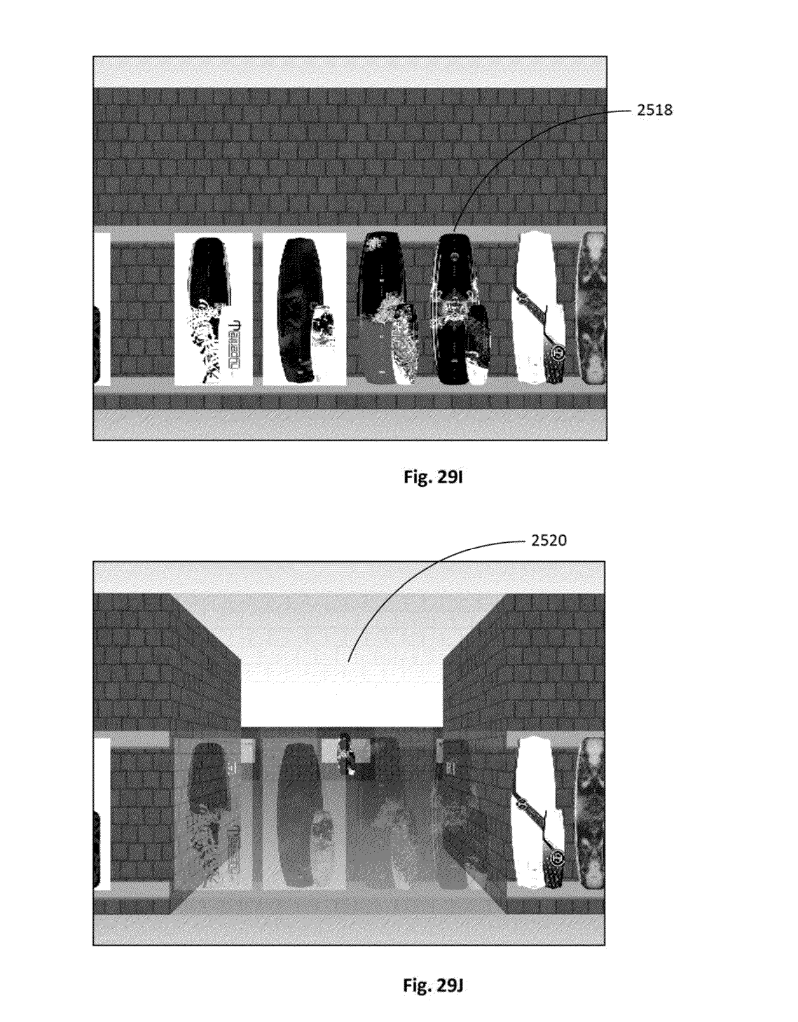

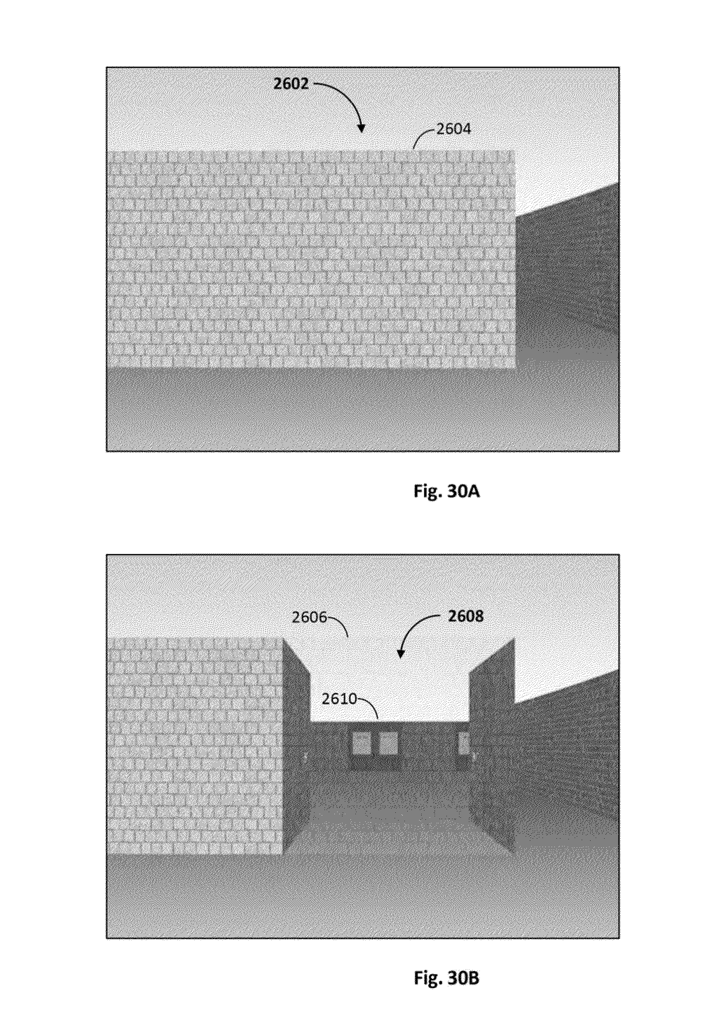

For example, as shown in FIGS. 29A-J, when a user who is shopping in a online toy store selects a wakeboard on a wall, then the portal that opens could be to a junction that offers some specific actions relating to that wakeboard model in particular, relate to wakeboards in general, and perhaps the brand of that wakeboard as well. FIG. 29A shows a wall panel 2502 in an initial state. The wall panel 2502 has items 2504a-e displayed thereon. A user may select one of the items 2504a-e displayed on the wall 2502, causing a portal 2506 to be created in the same location as the wall 2502. FIG. 29B shows the same view after the user has selected the first item 2504a, causing a portal 2506 to be opened. The portal 2506 was created in the same location as the wall 2502, and the wall 2502 and items 2504a-d are shown as “ghost-images” to alert the user that portal is temporary. FIG. 29C shows a user view as the user advances into the zone that has been connected through the portal 2506. The new zone 2508 displays the selected item 2504a on one wall panel. The new zone 2508 further comprises three doorways 2510, 2512, and 2514. When a user interacts with a doorway, a new portal may be created in the location of the doorway leading to a zone corresponding to the content indicated on the door. In the embodiment shown in FIGS. 29C-D, one doorway may lead to a room that displays all wakeboards carried by the online store, another doorway may lead to a room that displays all products by the manufacturer of that wakeboard, and the third doorway may lead to wakeboard accessories, another to a repair station, and so on. FIG. 29E shows a close-up view of the first doorway 2510, labeled “All Boards.” When a user interacts with the door, as shown in FIG. 29F, a portal 2516 is opened to a new zone 2518 containing content corresponding to the door label. In the embodiment shown in FIG. 29F, the new zone 2518 contains all of the wakeboards sold by the virtual store. FIGS. 29G-H show the view from within the “All Boards” zone 2518. FIG. 29H includes a view that shows the open portal 2516, through which the user can return to the zone containing information specific to item 2504a, selected earlier in the process.

In one embodiment, the Portal Graphics Engine 4 provides a default “Exit” junction room that opens when a user clicks on an empty portion of a wall. The Exit Junction Room is discussed in detail below.

In one embodiment, when a user clicks through a portal to a wall or floor in the zone on the other side, the portal closes, and a portal door appears in its place. In one embodiment, the exact design of a portal door graphic may be site-specific. The portal door graphic may be a graphic image that conveys the notion of a door or doorway. In another embodiment, a portal doorway may include components such as a door frame and door topper and might include a door title. A user may close a portal for any number of reasons, the most common being to close a temporary portal to restore a room (zone) to its original appearance. In one embodiment, when a user approaches or interacts with a portal door of a portal that was once opened, it re-opens the portal.

In one embodiment, the Portal Graphics Engine 4 allows multiple portals to be created that have the same source or destination. This can create a conflict. When two portals which share a common zone destination coordinate are open at the same time, it would create an anomaly. For example, a user might move through one of two portals to a shared zone, but when that user tries to go back, he or she would end up at the location of the second portal. In one embodiment, to prevent the creation of an anomaly, when a portal is opened or created that intersects an open portal to either of the new portal's sides, the Portal Graphics Engine 4 closes the other conflicting portals before opening the new portal.

One of the possible complications of the portal design is that the capability of the system to create arbitrary arrangements of rooms and spaces can result in a layout that is too complex for users to understand. The ad-hoc nature of portals combined with the ability of those rooms to fold back on themselves and link to other portals to great depths can result in layouts that are in effect labyrinths or mazes. Worse, these labyrinths cannot necessarily be displayed as a single flat map, due to the ability of zones to appear to overlap each other.

To alleviate this problem, in one embodiment, the graphics engine may provide three common features: Exit signs on all normal portal doorways, an Exit Junction Room and a Map Room. The two rooms are special zones that are maintained by the system. An additional three ways may be provided through a console window 2802, described in connection with FIG. 34A, for example, where the user can pop open the console window, and interact with the “Home Map” 2810, interact with the “Map Room” button 2812, or interact with the “Back Button” 2808.

In one embodiment, the Portal Engine may insert “Exit” signs on both sides of the inside of each portal doorway that it creates. When a user clicks on the word “Exit” on either wall, a temporary portal opens that leads back to the original site's Home Room, at that room's default portal location. One example of the “Exit” signs is shown in FIG. 29C. As a user passes through portal 2506, the Exit signs 2513 are displayed on either side of the portal, giving the user an easy way to return to the Home zone.

Because of how easy it can be to get lost in a maze of their own construction, Exits may keep the user oriented and feeling comfortable, by providing a ubiquitous escape route from almost any location. The “Exit” signs may be visible in most rooms past the Home Room, and so provide a visible element that user's can naturally expect to help them return to a known place. In one embodiment, sites can suppress the Exit signs for specific portals, but it is strongly recommended that they be left in place for most portals.

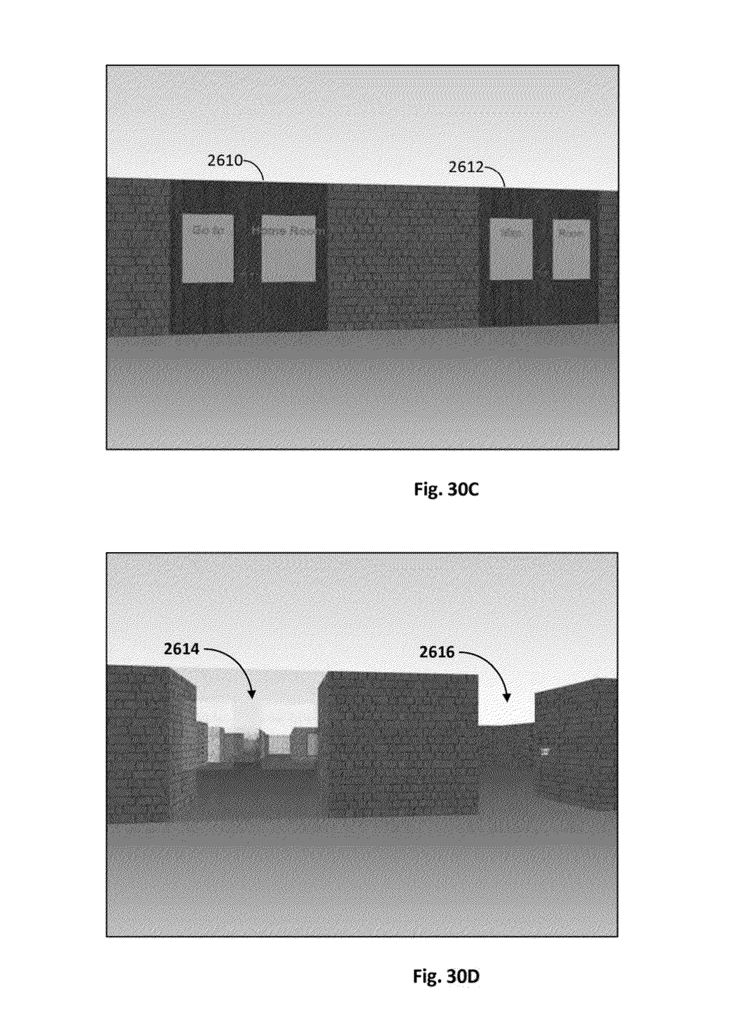

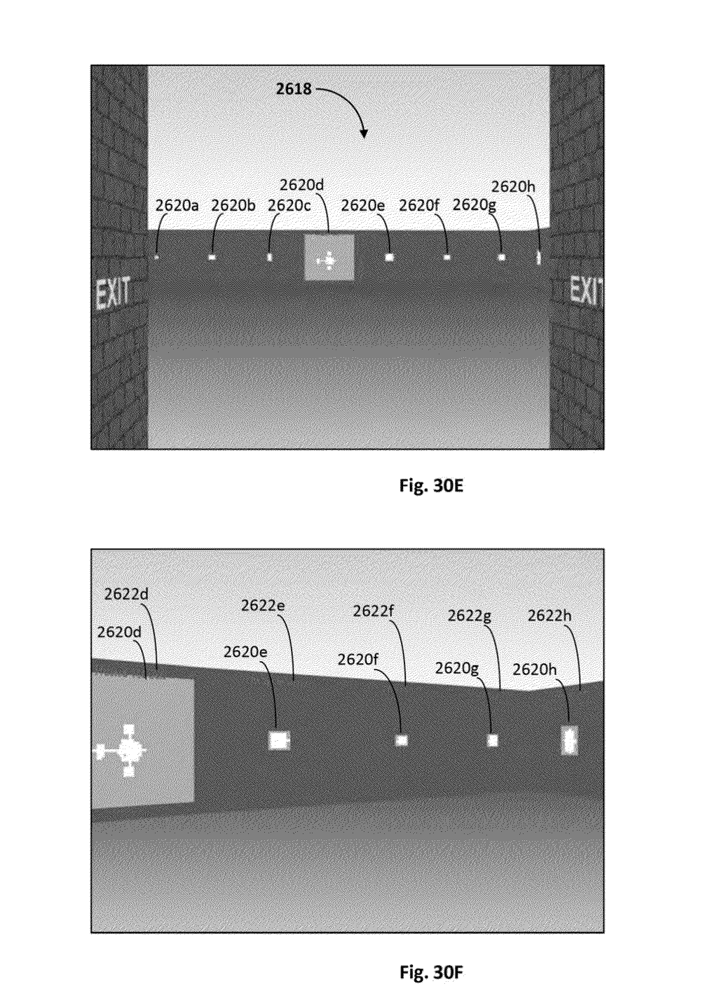

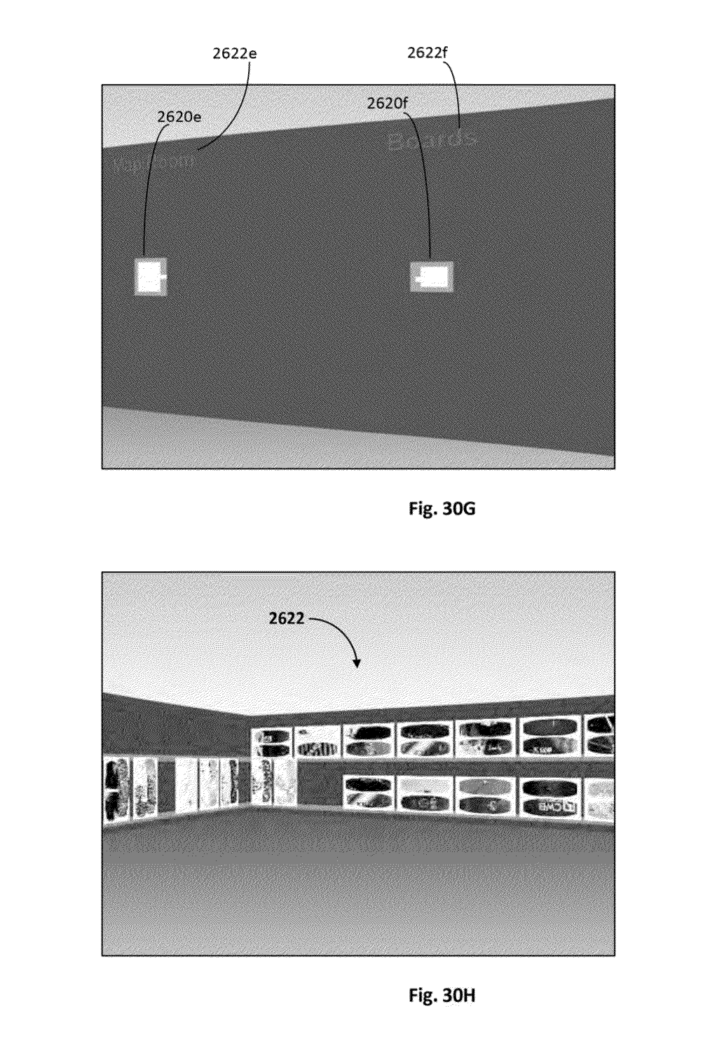

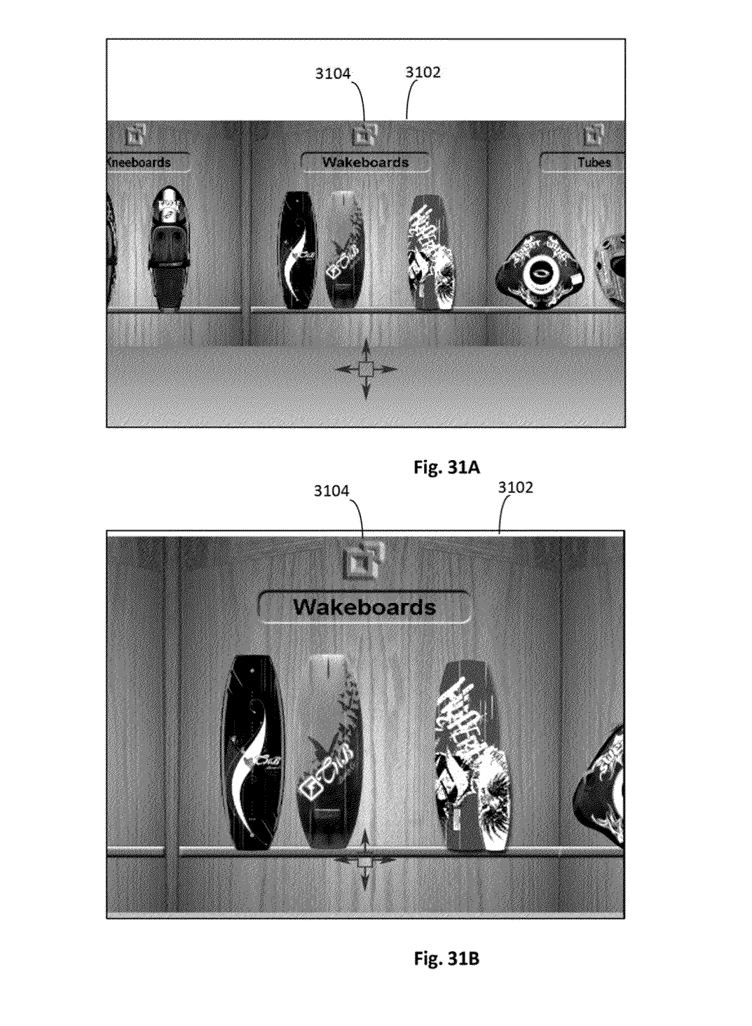

In one embodiment, shown in FIGS. 30A-H, the Portal Engine provides a common user interface element called an Exit Junction Room, or just Exit Room. An Exit Room is a junction room (zone) whose purpose is to help the user leave their current location, or get to another location that is not currently connected to the current zone. It is a more general version of an Exit, with options for user actions beyond merely going to the Home Room. In one embodiment, each zone may support its own Exit Room which can be customized, allowing context-specific user Exit Rooms as well as standard ones.

In one embodiment, shown in FIGS. 30A-H, a temporary portal to an Exit Room 2608 may be automatically opened when a user interacts with (such as, for example, by double-clicking) an otherwise empty space on a wall surface. FIG. 30A shows a zone 2602 with an unused portion of wall 2604. After the user interacts with the wall portion 2604, a portal 2608 may be opened to an Exit Room 2606 as shown in FIG. 30B. The Exit Room 2606 is easily closed again by clicking inside the room across the portal 2608 boundary (the normal portal-close behavior). This allows the user to escape from any room at any time by simply finding an unused portion of some wall and double-clicking on it. In one embodiment, a temporary portal is created and no actual modification to the wall occurs, the wall just opens to an Exit Room to let the user go somewhere else.

In one embodiment, shown in FIG. 30C, an Exit Room always has two standard doors, in addition to any others that might be specific to that site or zone. One door may be marked “Exit to Home Room” 2610 and opens a portal 2614 into the Home site's Home Room at its default portal location. The user can get back to the original Home room of the original site at any time from any place by double-clicking on a wall, entering the Exit Room, and approaching or interacting with the “Home Room” door. In one embodiment, the “Home Room” door functionality may be the 3D portal equivalent of a web page's navigation menu bar with a “Home” link. Whereas exiting via an “Exit” sign requires that the user locate the word “Exit” in order to escape the current location, an Exit Room can be opened practically anywhere on any wall, without any further user movement.

In one embodiment, the Home Room portal 2614 remains open both ways between the Exit or Exit Room and the Home Room, so the user can easily go back through it from the Home Room side and get back to wherever they were when the Exit or Exit Room portal was opened. This portal may be closed however, when the user opens another Exit or “Home Room” door in a different zone or Exit Room, due to the system's portal-conflict-detection behavior.

In the embodiment shown in FIGS. 30A-H, the other standard door in the Exit Room is marked “Map Room” 2612, and opens a portal 2616 to the Map Room. The user can get to the Map Room at any time from any place by interacting with a wall (such as, for example, by double-clicking a location on the wall), entering the Exit Room, then approaching or interacting with the “Map Room” door.

In one embodiment, the Map Room 2618 is a room (zone) that contains one or more layout images 2620a-h of the plan of each zone that has a zone name. Any zone can be given a name, either as it is constructed or later and, in one embodiment, any zone with a zone name will be displayed in the Map Room. In one embodiment, for each displayed zone the zone's plan is drawn upon a wall panel for that zone with the zone's name displayed, along with the plans for any named zones to which it has direct portals. In one embodiment, the zone's plan is displayed in a different color than the wall background, typically a lighter color, but each primary (non-hosted) site is free to define both the background of the zone and the display colors, fonts and font sizes. In another embodiment, the maps are displayed as individual component objects in the Map Room.

In one embodiment, as shown in FIGS. 30G-H, when a user approaches or interacts with a plan on a Map Room panel, the graphics engine jumps to the corresponding coordinates in the zone the plan was representing. This allows the user to jump to any specific location that they have visited in that session. FIG. 30G shows the layout panel 2620f for the “Boards” zone. A user may interact with the layout panel 2620f and is transported to the Board zone 2622 at the location indicated by the user interaction with the layout panel 2620f.

In one embodiment, the Map Room also allows the user to set bookmarks on the plans. When a user clicks on a map wall outside of a plan, a button appears on the wall, that when pushed allows the user to set a bookmark anywhere with that map. Such bookmarks are saved as cookies when the session ends, and those maps are re-loaded when that user's next session starts, allowing a user to revisit locations that they were at in earlier sessions.

In one embodiment, the Exit Room may contain other elements besides the two standard doorways. In one embodiment, a common element in the Exit Rooms for an online store would be a Product kiosk and a Help kiosk, which would allow users to go directly to specific product rooms or help rooms, respectively.

In one embodiment, large sets of visual data are presented by creating a room (zone) within which to display it, then display the images or text on the walls of that room. In one embodiment a room may have four walls and because the user can zoom in an out by merely approaching an image, a very large number of images or text can be displayed at the same time. It will be appreciated by those skilled in the art that a zone (room) may be created with any number of walls or layout. Whereas in an ordinary site, only a limited amount of visual data can be presented at a single time, with a large 3D room, the user effectively can peruse the equivalent content of dozens of pages in a single viewing. This in turn increases user comprehension and decreases user decision time.

In one embodiment, the Portal Graphics Engine 4 provides a set of functions to assist in the construction of such data display zones. These functions allocate panel images and render images upon them, with results automatically laid out upon the panels, controlled by application-specified layout routines. Other functions may allocate new zones based upon the number of panels to display, and apply the panel images to the walls of the zone room according to an application-specified allocation routine.

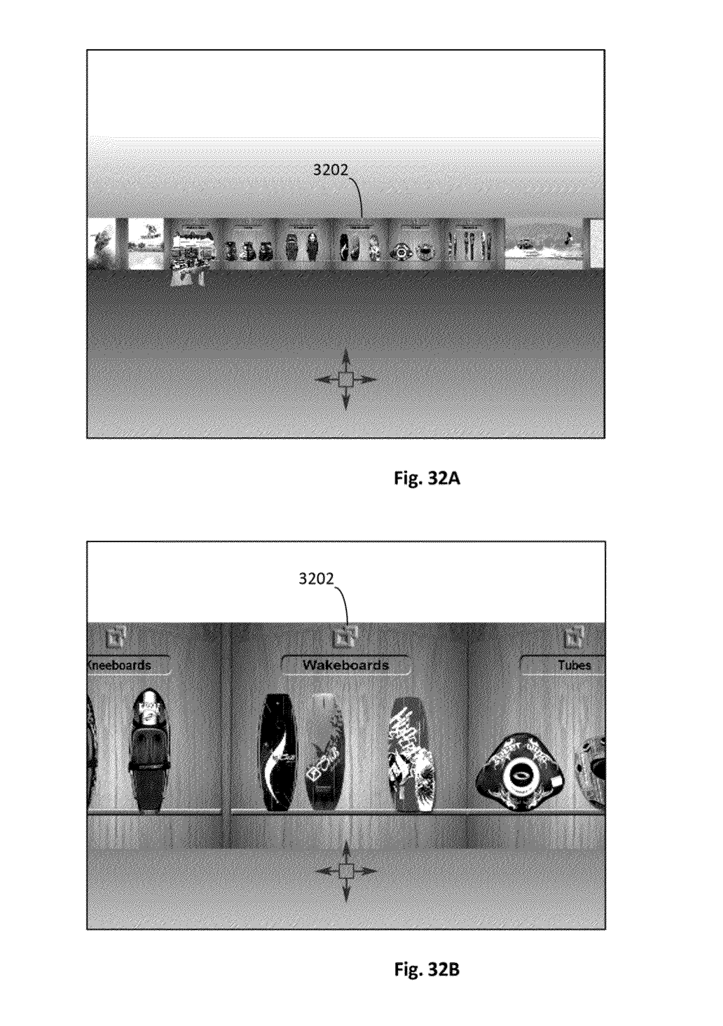

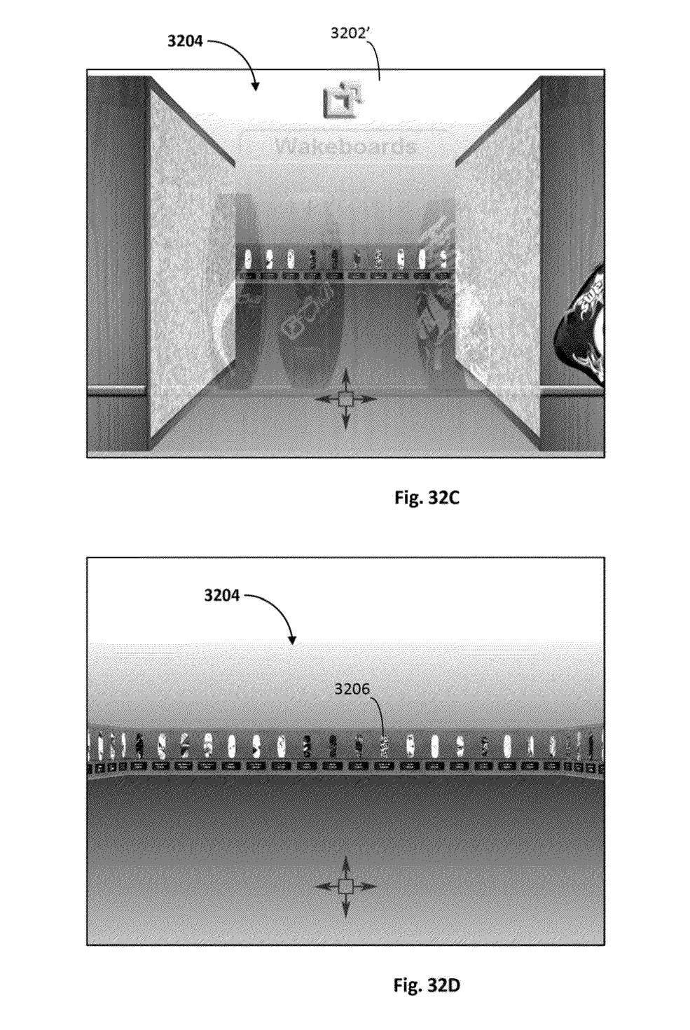

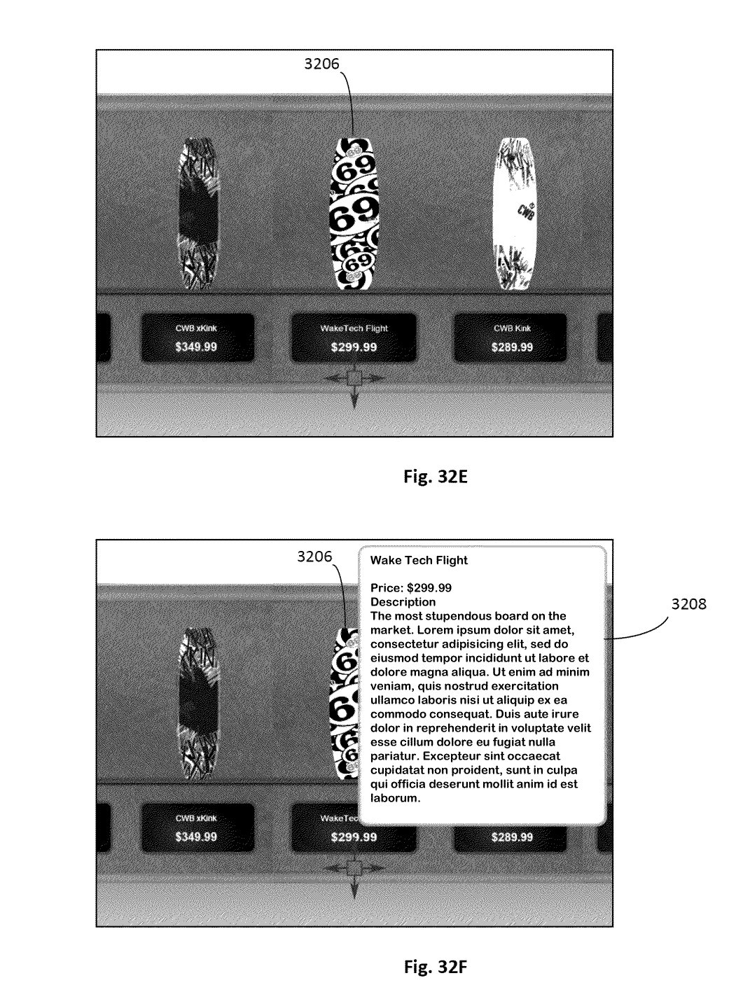

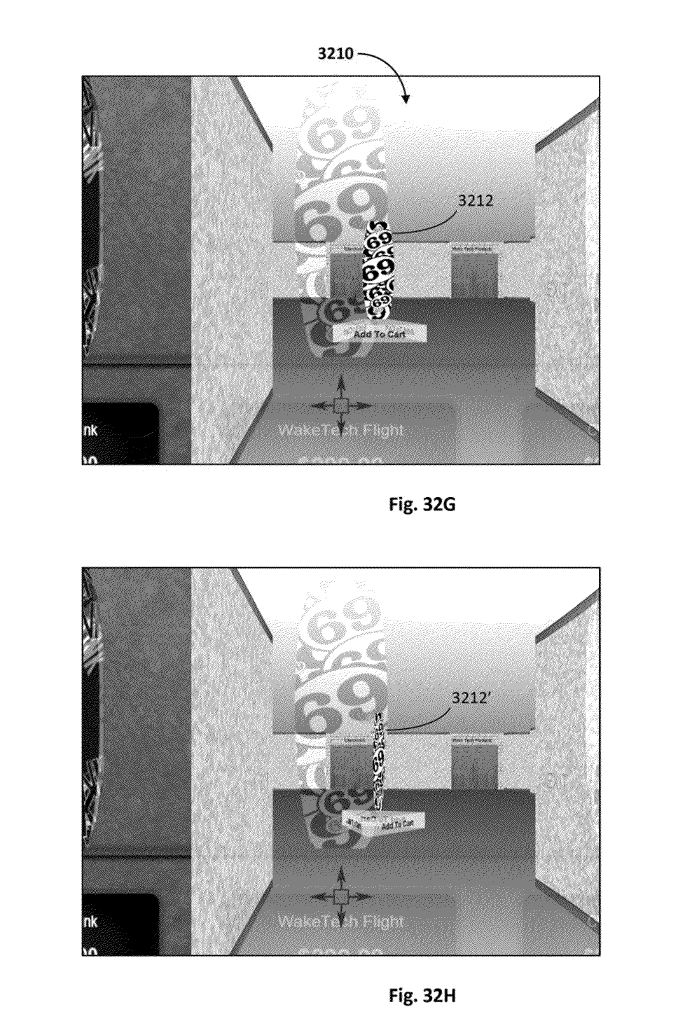

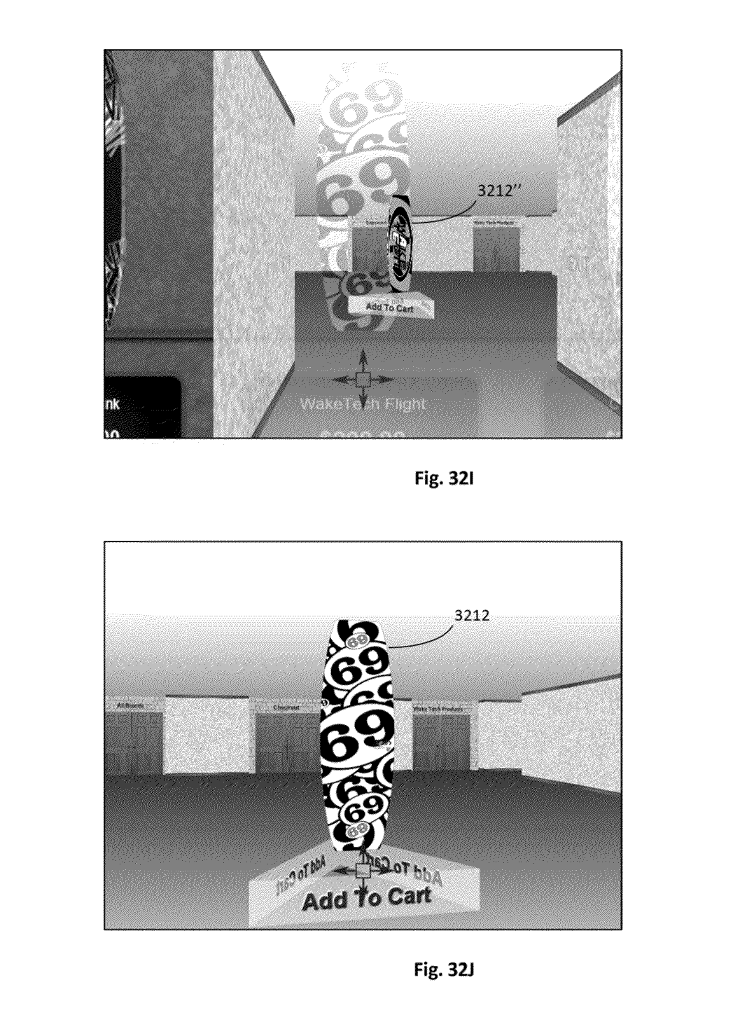

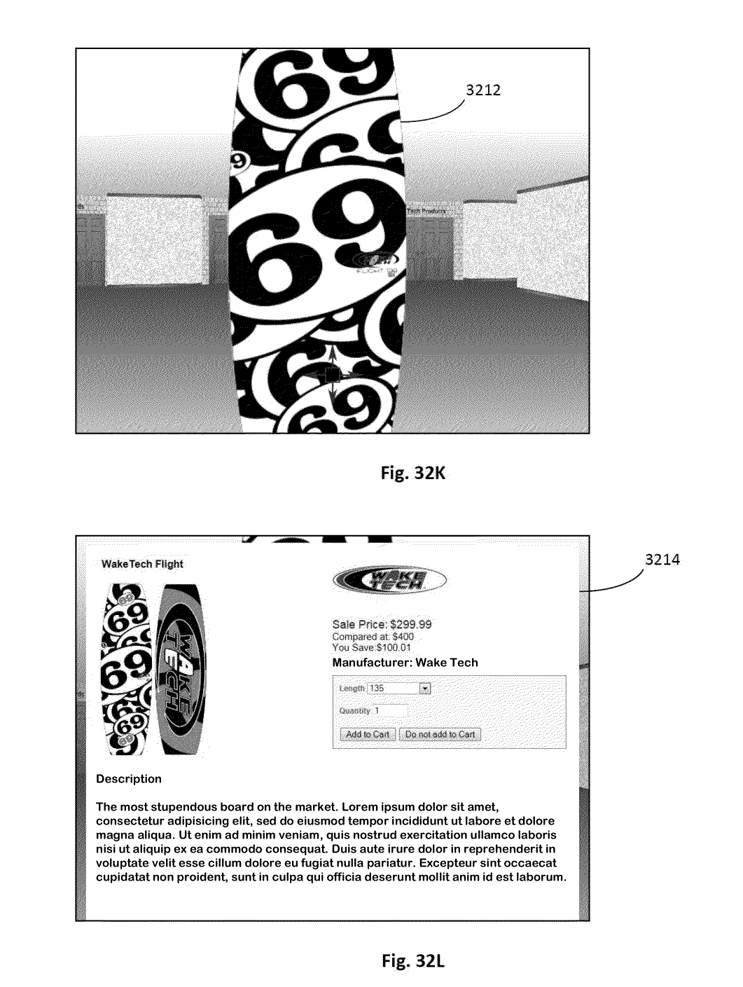

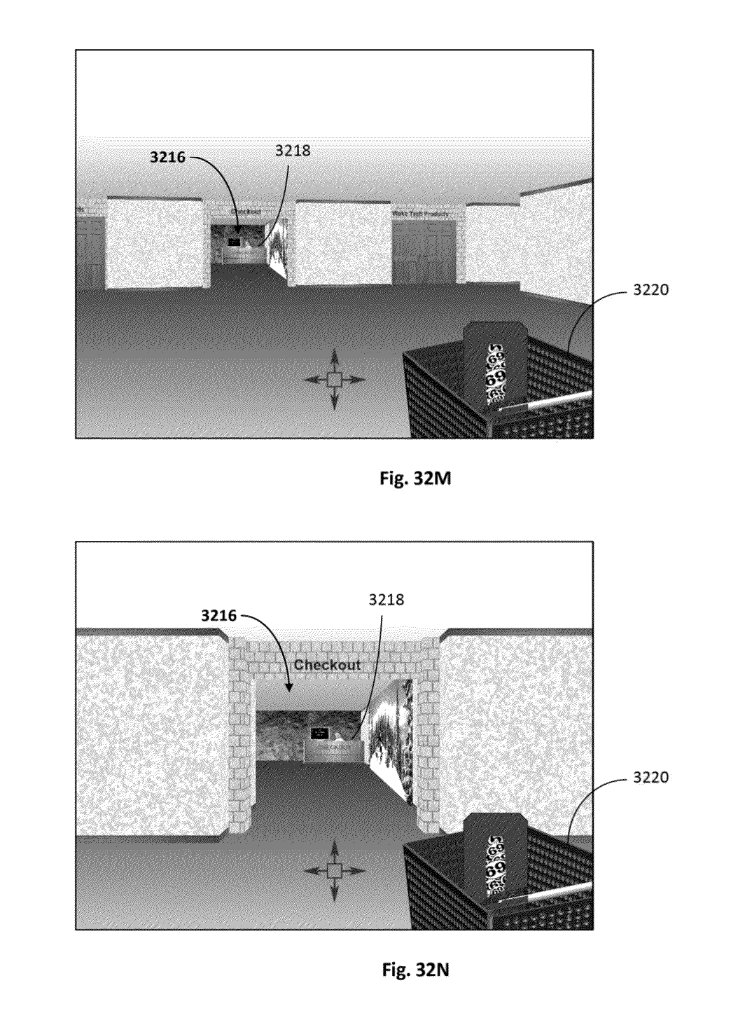

For example, an online-store site might want to display all of its custom widgets. It would send a query to the database layer to get the widget list. The return message event would invoke a function that fetches all of the widget images. The load-completion event would then invoke the panel allocation and layout functions, which would create the panels. Then a zone would be created that is large enough to hold all of the panels. The panel images would then be applied to the walls of the zone room, starting on one side and proceeding around the walls of the room. Finally, a portal would be opened to the new display room. An example of such a constructed zone is shown in FIG. 32D.

In one embodiment, a “Console” window 2802 may be provided for the user, that allows direct access to specific areas, as shown in FIGS. 34A-C. The “console” window 2802 may allow the user to directly go to a place or see results of a search. The console window 2802 has a text area 2804 where the user can type in a query string that the application will look up to present results. In one embodiment, the console window 2802 may graphically offer the user the choice of how results will be displayed. In one embodiment, a multiple-selection drop-down list 2806 may be provided which may allow a user to choose how to display the results, such as, for example, as a 3D circular list 3414 where the products appear to be hovering in space as shown in FIG. 34B or by opening a Results Room directly in front of the user, such as the “circular room” 3418 shown in FIG. 34C. The different display choices may offer different ways of showing the same product item, such as, for example, item 3416, depending upon the user's preferences. In one embodiment, the choices may be offered using one or more radio buttons.

In one embodiment, the Console window or main window may also include a “Back” button 2808 that allows a user to return to a point where the user was in before entering the current zone. In one embodiment, when the user crossed into the current zone via a portal, the back button 2808 will jump the user back to the spot of the portal in the previous zone. When the user jumped to the zone by using a map or query, the back button 2808 will return the user to the spot in the previous zone where he or she was at when the jump occurred. The back button 2808 will continue to take the user back through each previous zone in the reverse order from which the user originally visited those zones.

In one embodiment, the Console window may have additional controls, such as but not limited to a “Home Page” map 2810 which can be used to jump the user directly back to their home site's Home page, and a button 2812 that takes the user directly to the map room or displays the maps as a 3D circular list, depending upon the user's display choice.

In one embodiment, the Console window 2802 is invoked by the user pressing the “Escape” (or Esc) key on the user's keyboard. When Esc is pressed, the console window pops up directly in front of the user. The console window 2802 may be semi-transparent, so a user can continue to see the current zone. In one embodiment, the console window 2802 closes when the user presses the Esc key a second time, when a Results Room opens, or when the user moves more than a small distance.

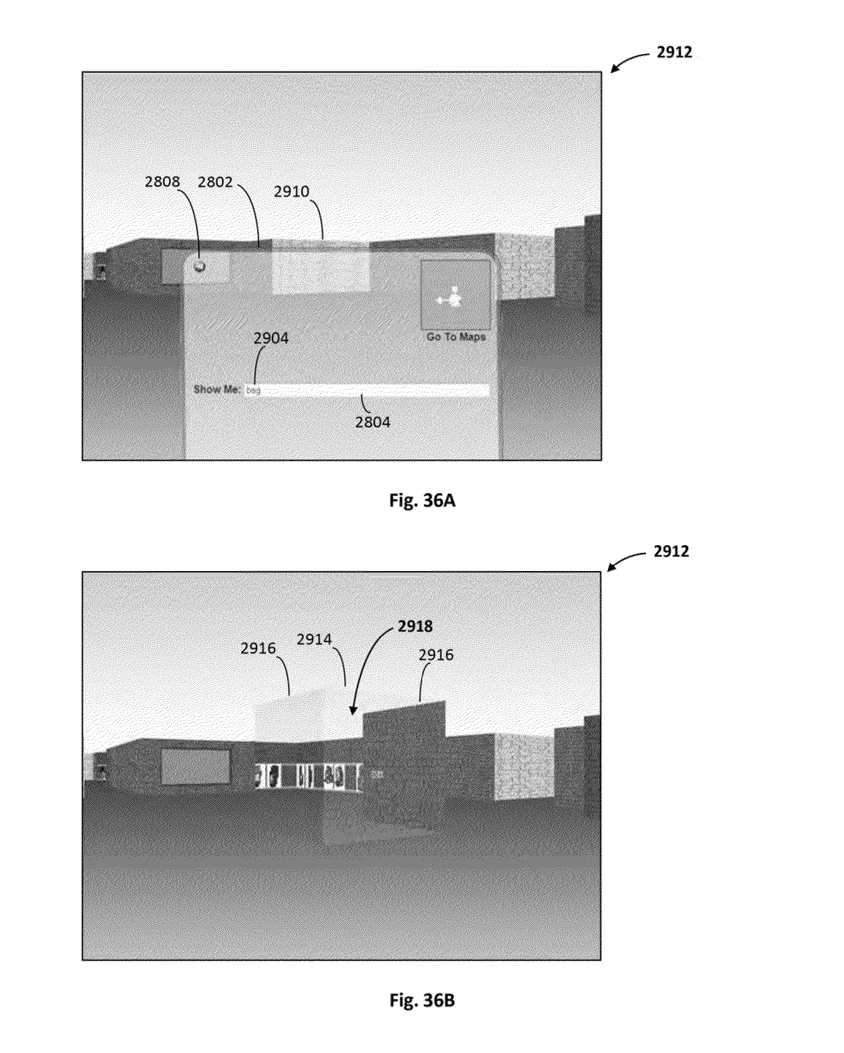

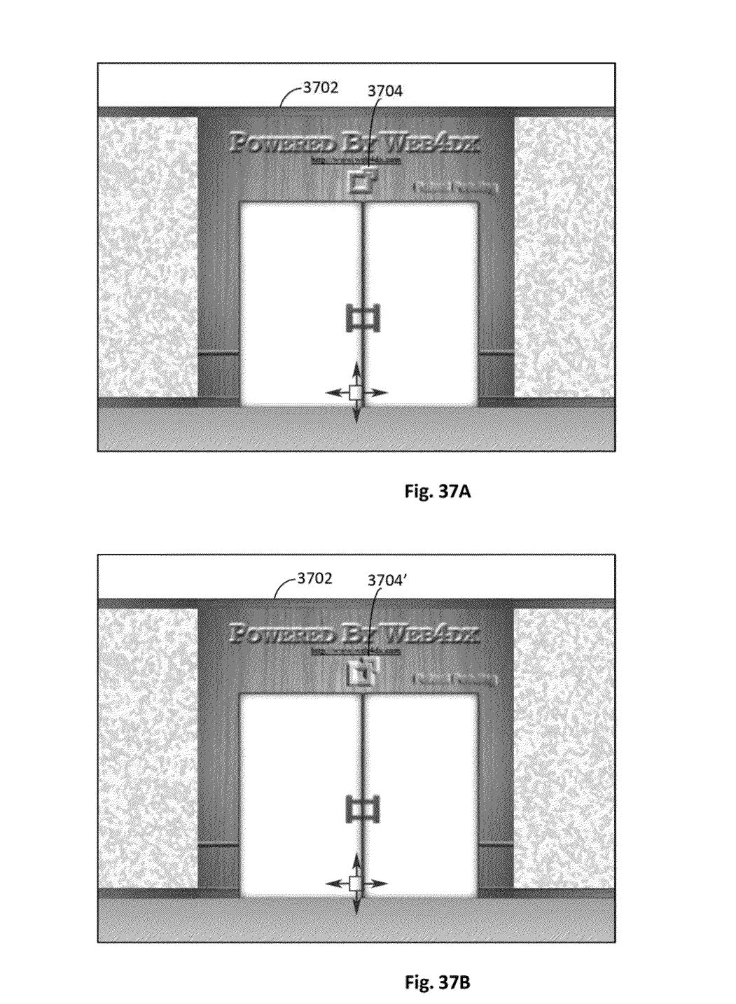

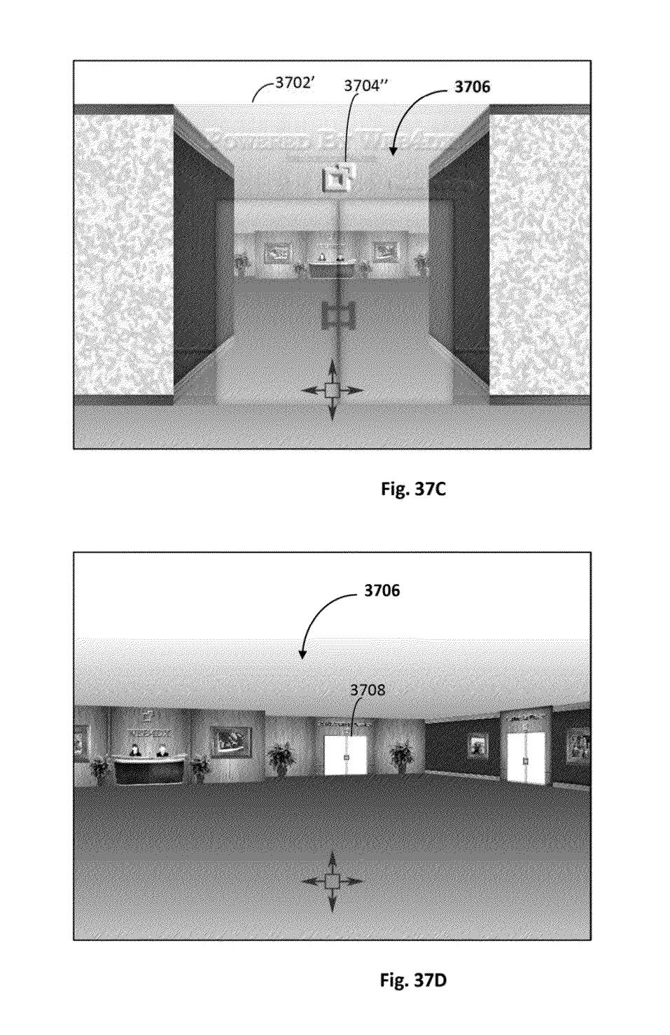

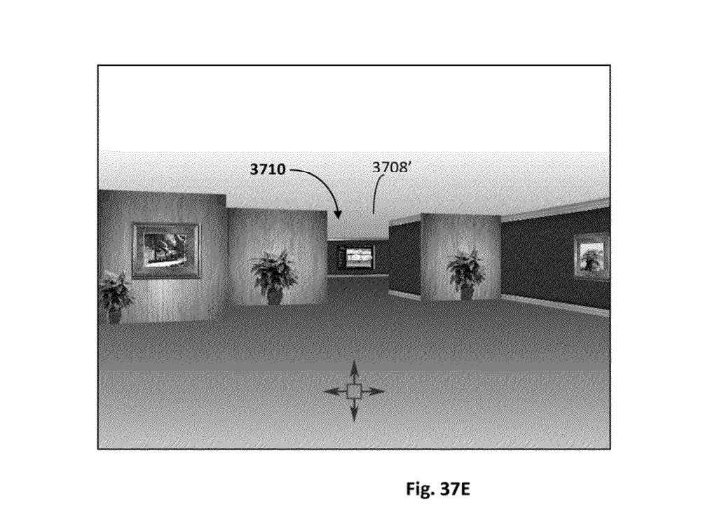

In one embodiment, a specification for the text-based protocol for a website to be hosted by another is included. Sites that implement the protocol can participate in a hosting session. In one embodiment, each site is free to implement the functionality of the protocol however it chooses, but the specification includes a sample implementation. As illustrated in FIGS. 37A-E, a portal to another website may appear and behave the exact same way as does a portal to the local site. In FIGS. 37A-C, for example, the user approaches or interacts with a web portal 3702, which may be marked by a portal icon 3704 as described above. As the user approaches or interacts with the web portal 3702, the web portal 3702 may open as described above. In FIGS. 37D-E, the user enters the main lobby 3706 of a second website and interacts with the second site by approaching doorway 3708, causing a portal to open to a new zone 3710.

Hosting another site presents a security risk, due to the ability of the Portal Graphics Engine 4 to seamlessly splice the two sites together. It might be difficult for a user to detect when they have entered the zone of another site, so the user must be constrained when in hosted zones for their own safety. In particular, access to the user's session must not be available to the hosted site.

In one embodiment, a hosted site can be visited, but access to the site is essentially “read-only”, that is, zones can be opened and images displayed but for security, database queries are limited to zone display requests only. No direct user input is allowed to be sent to the other site.

In one embodiment, the Portal Graphics Engine 4 allows hosting security restrictions to be reduced or removed, when the host and hosted sites establish a mutual trust relationship. For security reasons, allowing privileges for “write-access” and transmission of user input must be initiated by the host, and should only be done when the host lists the client (hosted) site as a trusted site in its database.

In one embodiment, a host may permit a higher privilege level by adding the client (hosted) site in a special table in its own database. The Portal Engine queries its own database for the client site name when it opens the site, and the response to the query, if any, alters the privilege level for that site. For security, in no cases does the extended privilege allow the client site to extend any privileges of itself or any other sites.

In one embodiment, the method and system of creating a 3D environment using portals may be used to create a virtual store that displays products and lets users shop in a manner that is much closer to a real-world shopping experience that is possible with 3D online retail stores. FIGS. 29A-J and FIGS. 32A-0 display embodiments of a virtual store.

In one embodiment, such an online store can contain, but is not limited to: Product items, product shelves, product display racks, rooms for products and accessories of various types, video- and image-display rooms, specialty rooms (such as Repair, Parts, Accessories), a shopping cart and associated Checkout room or Checkout counter. Such an online store can also provide portals to other stores as hosted sites, so that users can view not only that stores products, but those of partner store sites as well.

In one embodiment shown in FIGS. 32D-E, products may be displayed upon walls, whose background images portray shelving, cubbyholes and other display or rack features to enhance the sense that the user is looking at products that are on a wall, not just a picture. These display rooms may be standardized for the site, so that users will be able to recognize when a room is meant to be a display, as opposed to other types of rooms. In one embodiment, the walls of these display rooms have graphics that convey the notion of shelving, and the products are automatically aligned with the shelf images so that they appear to be resting upon them. In one embodiment shown in FIG. 32F, a Product Data Sheet 3208 dialog panel may be displayed if the user hovers a cursor over a product. The Product Data Sheet 3208 may provide a user with a quick overview of the different products shown by moving the cursor onto each of the displayed products to show a Product Data Sheet 3208 for that product.

In one embodiment, when a user approaches or interacts with a product item in a display room, a portal may open in place of the wall panel that contained the product, as illustrated in FIG. 32G. The portal may be semi-transparent, so the original wall, including the original product, may be still visible as a “ghost” image. Beyond this image may be a room, a Product Choice Room, which has several doorways, each marked for a purpose. The portal may open directly in front of the user, so that all user choices related to the selected product item remain within the field of view of the user. In one embodiment shown in FIG. 32G, the selected product is displayed in the center of the room, perhaps on a pedestal or other display presentation, as a visual confirmation of which product was selected. In one embodiment, as illustrated in FIGS. 32G-I, the product and pedestal may rotate, offering the user a quasi-3-dimensional view of the product. The pedestal may be marked with “Add To Cart”, to let the user know that moving over or interacting with the product image will add it to their shopping cart. When the product on the pedestal is moved over or interacted with by the user, a dialog may be displayed to let the user make one or more choices, such as, for example, size, number ordered, or other options, such as those shown in FIG. 32L. The dialog may contain an “Add to Cart” button. If a user clicks on the “Add to Cart” button, the product may be added to the user's cart and the “Checkout” doorway may open showing the “Checkout” counter visible beyond the doorway, as shown in FIG. 32M. In some embodiments, when the user moves over or interacts with the pedestal, the product on the pedestal may be immediately added to the user's cart and may allow the user to make product choices, such as size, number, etc., at a later point in the checkout process. In some embodiments, the room does not contain a product on a pedestal and instead the room may contain a doorway that is marked “Add To Cart” and contains a full-size image of the product that the user chose. The user may approach or interact with the door itself to add the item to the cart and open the door in a similar manner as described for the pedestal embodiment. The user selection of an item may place the next logical user choice directly within the user's field of view so that the user may choose the next action by a simple forward motion, for example, moving forward to a final checkout. In one embodiment, a user may finalize the purchase of the product by moving through the “Checkout” doorway toward the “Checkout” counter, which may trigger the transfer of the user to a final financial transaction in which the user's purchasing information is collected and the purchase is completed, such as, for example, the approach to the “Checkout” counter to start the final financial transaction shown in FIG. 32O.

In one embodiment, the Product Choice Room may comprise at least three standard doorways. For example, a doorway marked “Checkout” may be located in the center of the room and may open a portal that leads to the Checkout counter, as discussed above. On the left may be a doorway, marked with the type of product that was chosen, that when approached or interacted with opens a portal to a room containing more products of the same type the one that as the user originally chose. On the right may be a doorway, marked with the manufacturer's name, that when approached or interacted with opens a portal to a room containing more products by the same manufacturer. Beyond the three standard doorways, other common doorways may include “Accessories,” “Repair” and “Exit to Home Room”. A particular product may have more doorways that are specific to that product. In one embodiment, the database entries for product types contain a field that details what doorways will be offered for that product type. At initialization, the program loads the product catalog table, which contains that field from that table. In some embodiments, Product Choice Rooms may be created dynamically, based upon the products that the user chooses. The rooms are populated with doorways based upon the database field value. This allows great flexibility in what is offered to the user for each product type. Those skilled in the art will appreciate that any number of doorways may be used.

In some embodiments, the Home Zone (Lobby) of a site or virtual store may be a room that has several doorways that lead to other areas of the site. Each doorway is a portal, and the other rooms load as added zones. One skilled in the art will appreciate that there is both a performance advantage and memory resource advantage to only loading rooms as they are needed by the user. Due to the large resource requirements to support 3D VR environments, dynamically loading the rooms (zones) greatly reduces the amount of memory it takes to display new rooms, as well as greatly reducing the time required to display them. By having the doors from the Lobby to the other rooms start off as closed, the 3D site can be ready for the user to visit enormously faster than if all of the rooms had to load first. In one embodiment, major wings of the site may initially appear as large murals that open to the zones of those wings as the user approaches the murals, as illustrated in FIGS. 33D-E. In this embodiment, the user does not need to click on a doorway for it to open. Instead, most doorways open automatically just by the user's movement towards them. As shown in FIG. 33D, a user moves toward each of the two murals 3314, 3318, causing the portals of the two murals 3314, 3318 to open. FIG. 33E shows the portals 3314′, 3318′ open, with two zones 3320, 3322 now available for entry. The user may move freely, and the rooms may open before them. Because only one room loads at a time, the performance of such a design is often fast enough that the user's motion is hardly or not at all restricted.

In one embodiment, because some walls open to rooms and some do not, a visual indicator is provided to the user, to mark which walls automatically open. In one embodiment, this indicator takes the form of a icon, logo or some other recognizable marker that walls that open all are marked with, as illustrated by the embossed icon 3104 shown in FIG. 31A.

In one embodiment shown in FIGS. 31A-G, an indicator may also indicate the loading state of the portal, as a visual aid to the user when the loading response time is slow. FIG. 31A shows an unopened portal 3102 with a portal indicator 3104. The portal indicator 3104 may have the color of the texture of the wall, as an embossed icon. FIG. 31B shows portal 3102 as the user approaches close enough to trigger the portal to open. FIG. 31C shows portal 3102 as the portal is about to load the zone contents of the other side of the portal. The portal icon 3104′ may turn red to give the user a visual cue that something is changing. FIG. 31D shows the portal 3102 as it begins to load the zone contents of the other side of the portal. Portal icon 3104″ may turn a combination of orange and green to show the user the progress of the portal load. In this embodiment, the left side of the icon is green to show what proportion of the zone content has loaded, and the right side is orange to show what proportion is yet to load. FIG. 31E shows the portal icon 3104′″ when the portal contents are 50% loaded, with the left side of the icon green and the right side orange. FIG. 31F shows the portal icon 3104″″ when the portal contents are 100% loaded, with the entire icon now green. Finally, FIG. 31G shows the portal 3102′ when it opens, with indicator icon 3104″″ still showing green to indicate to the user that the portal is fully open. In one embodiment, this icon continues to display even if the portal becomes solid, such as when the portal has a variable transparency that is proportional to the user's distance to the portal.

In one embodiment, the Home Room (Lobby) of a virtual store may be a room that has two main 4-sided kiosks visible to the user's line-of-site as they enter the store. As illustrated in FIG. 33I, one of the two kiosks 3332 may be marked “Take Me To . . . ”, and directs users to various main parts of the store. Each of its four sides has a routing purpose. On the first side is a map of the main floors of the store. It shows the layout of the main floors, with labels indicating what purpose each zone is for. When the user clicks on any portion of that map, they will be transported to that location instantly. On 2 or more sides are images of the main products of the store, and when the user clicks on one of them, a portal opens to a room that showcases the products of that type. The other kiosk is marked with an “Information” question-mark symbol, and offers the user help or information. On one side is a set of instructions on how to use the website.

In one embodiment, a visual indication of a selection may be provided. Because the user can move around in a 3D environment, it is not sufficient to just highlight the selection where it is. When they move away, they will no longer be able to see it. In one embodiment, shown in FIG. 32M, a “shopping cart” 3220 may be added to the 3D environment. The cart may stay with the user, and show selected items within the cart, providing a visual indication to the user of which items have been selected for purchase.

In one embodiment, the user-interface may include the ability for the user to navigate using a mouse or touch surface control. Navigation by mouse or touch surface control may be accomplished by having a mouse or touch-selectable target that the user clicks upon to activate a mouse/touch mode, as illustrated by FIGS. 33A-C. Once the mouse or touch surface control navigation mode is activated, the user-interface calculates user movement by tracking the current mouse or touch position, and comparing it to a base coordinate. In one embodiment, the base coordinate may be the location of the center of the mouse/touch target used to initiate the mouse/touch mode, thus providing a visual cue to the user as to what effect the mouse/touch will have. The target may change configuration, such as, for example, changing color, as a visual cue to the user that the mouse/touch mode is active or inactive. In one embodiment, the relative direction and movement speed are proportional to the distance between the current mouse/touch coordinate and the base coordinate. For example: when the cursor is above the base coordinate, the user may move forward; when the cursor is below the base coordinate, the user may move backward; when the cursor is to the left of the base coordinate, the user may turn left, and when the cursor is to the right of the base coordinate, the user may turn right. In one embodiment, additional types of movement, such as, for example, horizontal (side to side) shifting or vertical shifting, may be possible. A user may access the additional types of movement by, for example, holding down one or more keys of a keyboard. In one embodiment, the keys may be the Shift and Ctrl keys. The mouse/touch mode may turn off when the user clicks anywhere within the display area or the mouse/touch mode may turn off when the user moves the mouse or touches a location out of the display area.

FIG. 33A shows one embodiment of the user-interface, comprising a target area, the square 3308, which marks a zone that the user may interact with to start the mouse/touch mode. The center of the square may be the base coordinate. The square 3308 may have one or more accompanying arrows 3306 to help the user see and understand the intended purpose of the mouse/touch control. In FIG. 33A, the mouse/touch mode is inactive, and the square 3308 is red to signal that the mode is stopped. The one or more arrows may be solid when the mouse/touch mode is inactive. FIGS. 33B-C show the user-interface after the user interacted with the square 3308, activating the mouse/touch mode. The square 3308 may be green to signal that the mouse/touch mode is active, and the arrows may be semi-transparent and appear gray. FIG. 33C shows the user moving toward an open doorway.

In one embodiment, the graphics engine may support multiple ceiling and outside sky images. FIG. 33A illustrates a sky 3312 that has a different image from the ceiling 3304 inside. In some embodiments, each zone may have its own ceiling image.

In one embodiment, a user-interface graphics engine comprises a web browser that supports HTML5 or later web standards upon which runs a client-side software architecture that generates a 3-dimensional virtual-reality environment. In one embodiment, the client-side software architecture is written in JavaScript. In this embodiment, the Portal Graphics Engine 4 provides a presentation mechanism to display content to the user in a 3-dimensional (3D) virtual-reality (VR) format which allows the user to visit and interact with that data in a manner that simulates a real-world interaction. In one embodiment, the engine may provide a user with the ability to navigate and access to their content and manage their 3D environment, by dynamically constructing spatial areas and connecting them with one or more portals.

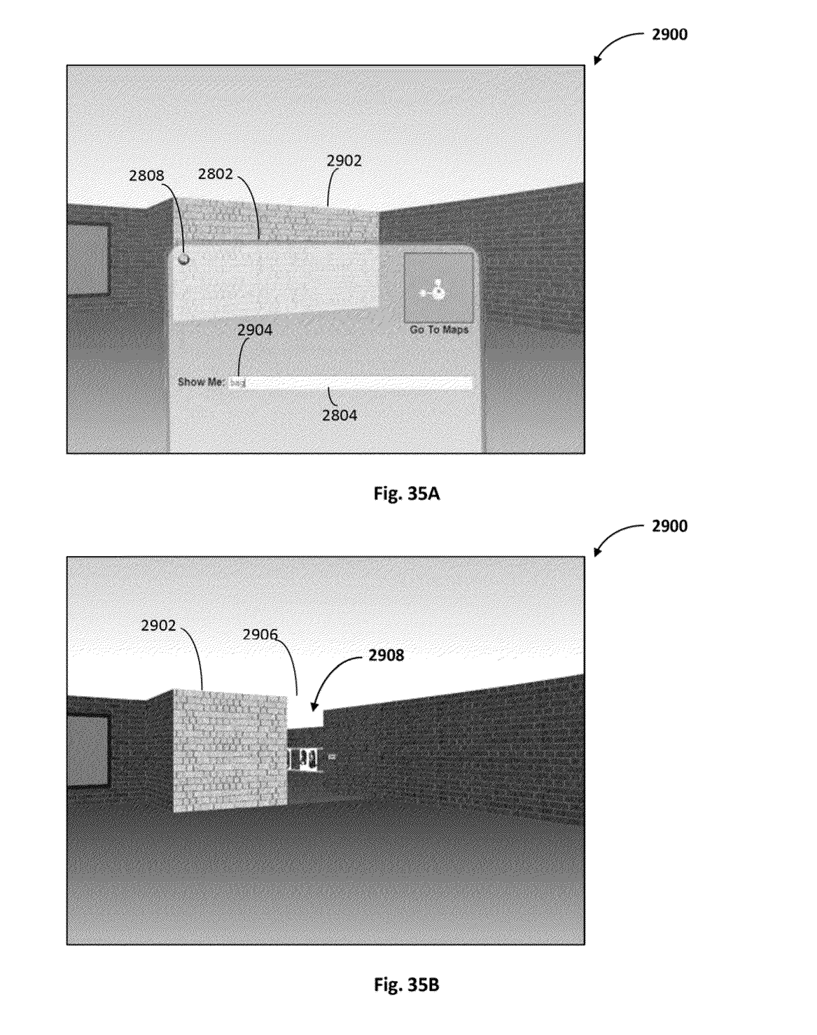

FIG. 35A shows a window console display 2900 where the console 2802 is used to open a portal 2906 near a wall 2902. The user is looking directly at the wall 2902 segment in the corner of the room. The user enters the product type to be shown in the search text area 2804, e.g. “bag”. FIG. 35B shows a display 2900 in which a portal 2906 opens in the wall in front of the user. The portal 2906 opens to a Results Room 2908 in the wall directly in front of the user. FIG. 36A shows a console window display 2912 where the console window 2802 is used to open a portal 2914 that is far from a wall 2910. The text area 2804 still shows the item “bag”, which was previously entered. The user is looking directly at a wall segment in the corner of the room, but the wall 2910 is located far away. FIG. 36B shows a display 2912 where a portal 2914 opens to a Results Room 2918 in the middle of the room, directly in front of the user. A temporary wall segment 2916 is displayed to show the location of the portal 2914. When the portal 2914 is closed, the room will revert to its original appearance.

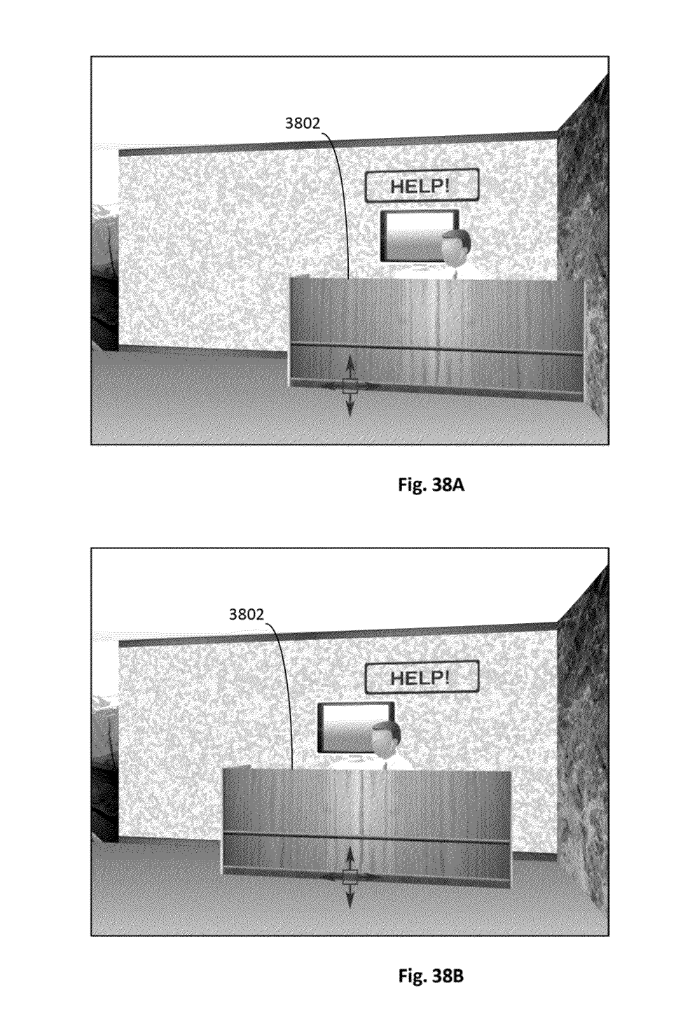

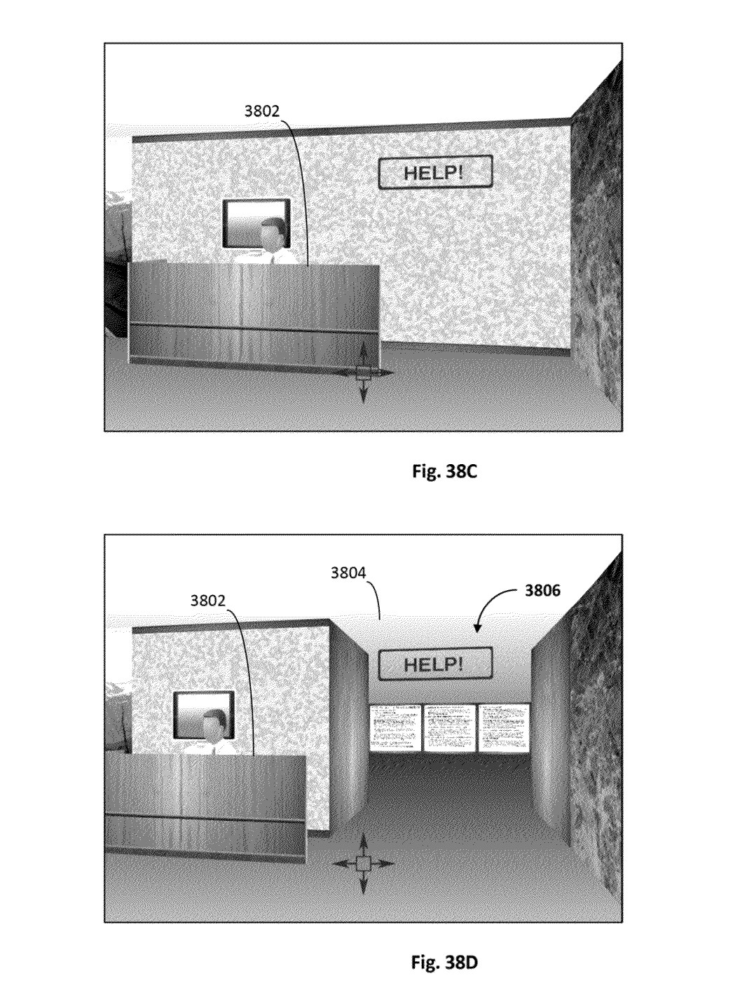

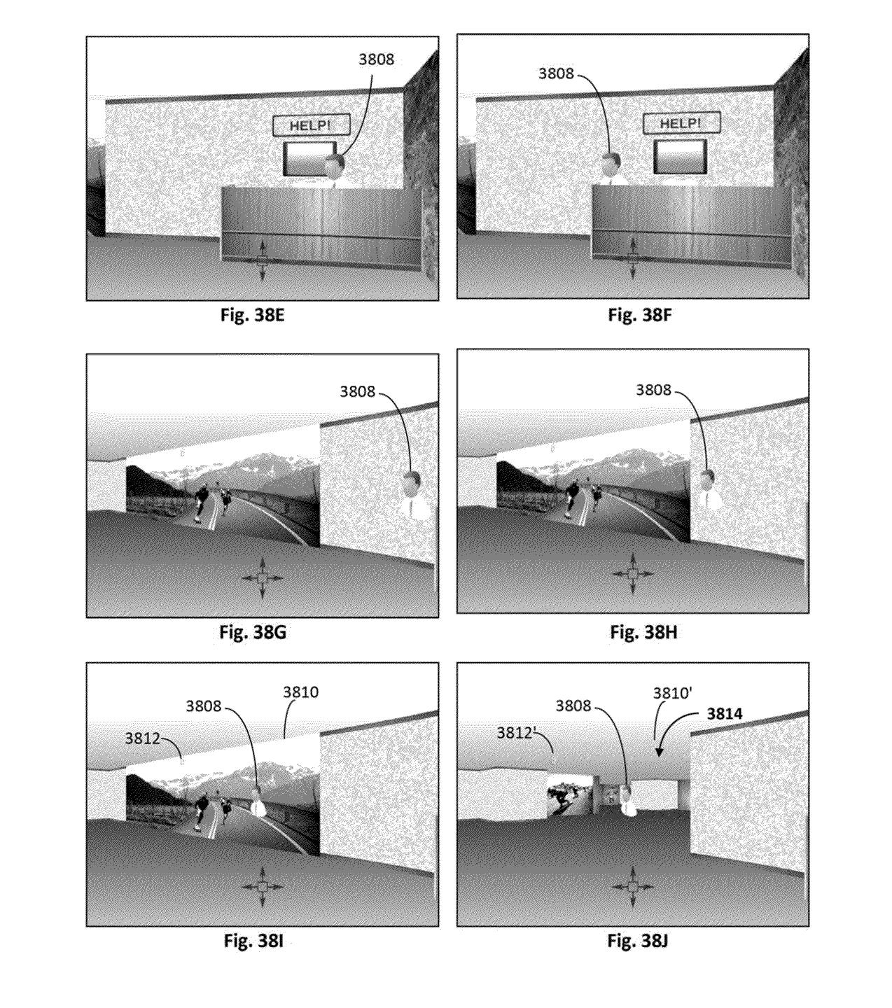

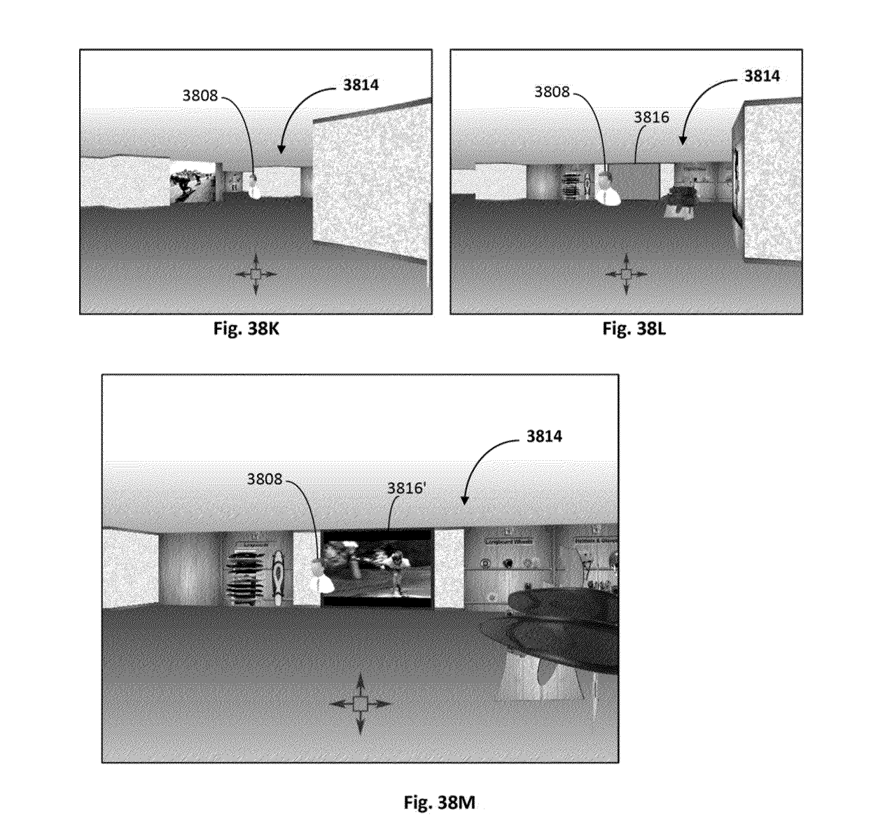

In one embodiment, component objects may move or be moved within the 3D space of a zone or across multiple zones, including independent or automatic movements. FIGS. 38A-38D illustrate one embodiment of a component object containing a Help Desk 3802 comprising a graphical representation of a person and a monitor. As a user approaches the Help Desk 3802, the Help Desk 3802 may automatically slide sideways to indicate and reveal a portal 3804 that opens to a Help Zone 3806.

In one embodiment, component objects or movements may be used to create anthropomorphic character images or ‘avatars.’ In one embodiment, an avatar may be used to provide visual guidance or help familiarize users with a site's features by leading the user around the site. FIGS. 38E-M illustrates one embodiment of an avatar 3808 leading a user on a tour through a portal 3810 marked by a portal icon 3812. The portal 3810 may connect to a new zone 3814. The avatar 3808 may demonstrate to a user how to interact with a video 3816 in the new zone 3814. The interaction with the video 3816 may include playing 3816′ the video. In various embodiments, avatars may be displayed as animated images or videos, static images, or any combination thereof. Avatars may have one or more associated audio recordings that may be coordinated to play with the avatar's movements, one or more text messages, such as, for example, speech balloons, coordinated with the avatar's movements, or any combination thereof.

In one embodiment, an avatar may be used to provide multi-user interactions within a site, such as, for example, virtual meetings or games. In one embodiment, users may register with or log in to a central server to communicate with each user or client during the multi-user interactions.

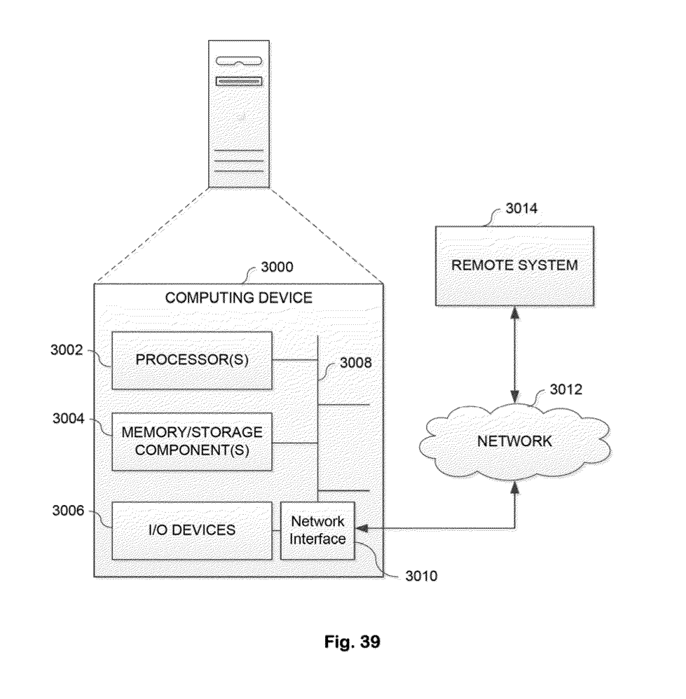

FIG. 39 shows one embodiment of a computing device 3000 which can be used in one embodiment of the system and method for creating a 3D virtual reality environment. For the sake of clarity, the computing device 3000 is shown and described here in the context of a single computing device. It is to be appreciated and understood, however, that any number of suitably configured computing devices can be used to implement any of the described embodiments. For example, in at least some implementation, multiple communicatively linked computing devices are used. One or more of these devices can be communicatively linked in any suitable way such as via one or more networks (LANs), one or more wide area networks (WANs) or any combination thereof.

In this example, the computing device 3000 comprises one or more processor circuits or processing units 3002, on or more memory circuits and/or storage circuit component(s) 3004 and one or more input/output (I/O) circuit devices 3006. Additionally, the computing device 3000 comprises a bus 3008 that allows the various circuit components and devices to communicate with one another. The bus 3008 represents one or more of any of several types of bus structures, including a memory bus or local bus using any of a variety of bus architectures. The bus 3008 may comprise wired and/or wireless buses.

The processing unit 3002 may be responsible for executing various software programs such as system programs, applications programs, and/or module to provide computing and processing operations for the computing device 3000. The processing unit 3002 may be responsible for performing various voice and data communications operations for the computing device 3000 such as transmitting and receiving voice and data information over one or more wired or wireless communication channels. Although the processing unit 3002 of the computing device 3000 includes single processor architecture as shown, it may be appreciated that the computing device 3000 may use any suitable processor architecture and/or any suitable number of processors in accordance with the described embodiments. In one embodiment, the processing unit 3000 may be implemented using a single integrated processor.

The processing unit 3002 may be implemented as a host central processing unit (CPU) using any suitable processor circuit or logic device (circuit), such as a as a general purpose processor. The processing unit 3002 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 3002 may be coupled to the memory and/or storage component(s) 3004 through the bus 3008. The memory bus 3008 may comprise any suitable interface and/or bus architecture for allowing the processing unit 3002 to access the memory and/or storage component(s) 3004. Although the memory and/or storage component(s) 3004 may be shown as being separate from the processing unit 3002 for purposes of illustration, it is worthy to note that in various embodiments some portion or the entire memory and/or storage component(s) 3004 may be included on the same integrated circuit as the processing unit 3002. Alternatively, some portion or the entire memory and/or storage component(s) 3004 may be disposed on an integrated circuit or other medium (e.g., hard disk drive) external to the integrated circuit of the processing unit 3002. In various embodiments, the computing device 3000 may comprise an expansion slot to support a multimedia and/or memory card, for example.

The memory and/or storage component(s) 3004 represent one or more computer-readable media. The memory and/or storage component(s) 3004 may be implemented using any computer-readable media capable of storing data such as volatile or non-volatile memory, removable or non-removable memory, erasable or non-erasable memory, writeable or re-writeable memory, and so forth. The memory and/or storage component(s) 3004 may comprise volatile media (e.g., random access memory (RAM)) and/or nonvolatile media (e.g., read only memory (ROM), Flash memory, optical disks, magnetic disks and the like). The memory and/or storage component(s) 3004 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 3006 allow a user to enter commands and information to the computing device 3000, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The computing device 3000 may comprise an alphanumeric keypad coupled to the processing unit 3002. The keypad may comprise, for example, a QWERTY key layout and an integrated number dial pad. The computing device 3000 may comprise a display coupled to the processing unit 3002. The display may comprise any suitable visual interface for displaying content to a user of the computing device 2000. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 3002 may be arranged to provide processing or computing resources to the computing device 3000. For example, the processing unit 3002 may be responsible for executing various software programs including system programs such as operating system (OS) and application programs. System programs generally may assist in the running of the computing device 3000 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple OS or other suitable OS in accordance with the described embodiments. The computing device 3000 may comprise other system programs such as device drivers, programming tools, utility programs, software libraries, application programming interfaces (APIs), and so forth.

The computer 3000 also includes a network interface 3010 coupled to the bus 3008. The network interface 3010 provides a two-way data communication coupling to a local network 3012. For example, the network interface 3010 may be a digital subscriber line (DSL) modem, satellite dish, an integrated services digital network (ISDN) card or other data communication connection to a corresponding type of telephone line. As another example, the communication interface 3010 may be a local area network (LAN) card effecting a data communication connection to a compatible LAN. Wireless communication means such as internal or external wireless modems may also be implemented.

In any such implementation, the network interface 3010 sends and receives electrical, electromagnetic or optical signals that carry digital data streams representing various types of information, such as the selection of goods to be purchased, the information for payment of the purchase, or the address for delivery of the goods. The network interface 3010 typically provides data communication through one or more networks to other data devices. For example, the network interface 3010 may effect a connection through the local network to an Internet Host Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 3010, which carry the digital data to and from the computer system 200, are exemplary forms of carrier waves transporting the information.

The computer 3000 can send messages and receive data, including program code, through the network(s) and the network interface 3010. In the Internet example, a server might transmit a requested code for an application program through the internet, the ISP, the local network (the network 3012) and the network interface 3010. In accordance with the invention, one such downloaded application provides for the identification and analysis of a prospect pool and analysis of marketing metrics. The received code may be executed by processor 3004 as it is received, and/or stored in storage device 3010, or other non-volatile storage for later execution. In this manner, computer 3000 may obtain application code in the form of a carrier wave.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as when it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

What is claimed is:

1. A computer-implemented method for building a three-dimensional (3D) interactive environment, the computer comprising a processor and a memory coupled to the processor, the method comprising:
generating, by the processor, a first 3D virtual space;
generating, by the processor, a second 3D virtual space;
linking, by a portal graphics engine, the first and second 3D virtual spaces using a portal, wherein the portal causes the first and second 3D virtual spaces to interact as a single, continuous zone.

2. The computer-implemented method of claim 1, wherein first 3D virtual space and the second 3D virtual space are non-adjacent.

3. The computer-implemented method of claim 2, wherein the second 3D virtual space is a remote website.

4. The computer-implemented method of claim 1, comprising:
storing, by the memory, one or more corrections for traversing the portal, wherein the one or more corrections are provided to a ray-tracing engine and a navigation engine, wherein the one or more corrections modify the ray-tracing engine and the navigation engine such that the first 3D virtual space and the second 3D virtual space appear continuous.

5. The computer-implemented method of claim 1, comprising generating the portal in a location common to a displayed image.

6. The computer-implemented method of claim 1, comprising:
receiving an input signal by the processor; and
determining a location of the portal based on the input signal.

7. The computer-implemented method of claim 6, wherein the input signal is indicative of a user movement towards a predetermined area of the first 3D virtual space.

8. The computer-implemented method of claim 1, comprising:
generating, by the processor, an event and messaging layer;
receiving input by the event and messaging layer; and
performing processing by the event and messaging layer within a predetermined time period.

9. The computer-implemented method of claim 8, comprising performing processing by the event and messaging layer within a 35 ms time period.

10. The computer-implemented method of claim 1, comprising:
generating, by the processor, an exit zone;
loading, by the processor, a home zone; and
generating, by the portal graphics engine, an exit portal linking the exit zone to the home zone.

11. The computer-implemented method of claim 10, comprising:
generating, by the portal graphics engine, a map portal linking the exit zone to a map zone, wherein the map zone comprises at least one layout of a currently active zone.

12. The computer-implemented method of claim 1, wherein the first and second virtual spaces comprise a virtual mall.

13. The computer-implemented method of claim 1, comprising:
generating, by the processor, one or more objects located within the first and second virtual spaces, the one or more objects configured to provide a user interaction.

14. The computer-implemented method of claim 13, wherein the one or more objects are animated.

15. The computer-implemented method of claim 14, wherein the one or more objects comprise an anthropomorphic character image.

16. The computer-implemented method of claim 1, comprising displaying, by the processor, an indicator image to indicate a status of the portal, wherein the indicator image transitions from a first state to a second state when the portal is generated.

17. A computer-readable medium comprising a plurality of instructions for creating a three-dimensional (3D) virtual reality environment, wherein the plurality of instructions is executable by one or more processors of a computer system, wherein the plurality of instructions comprises:
generating a first 3D virtual space;
generating a second 3D virtual space;
linking the first and second 3D virtual spaces using a portal, wherein the portal causes the first and second 3D virtual spaces to interact as a single, continuous zone.

18. The computer-readable medium of claim 17, wherein the first 3D virtual space and the second 3D virtual space are non-adjacent.

19. The computer-readable medium of claim 17, wherein the second 3D virtual space is a remote website.

20. The computer-readable medium of claim 17, wherein the plurality of instructions comprises:
storing, in a memory unit, one or more corrections for traversing the portal, wherein the one or more corrections are provided to a ray-tracing engine and a navigation engine, wherein the one or more corrections modify the ray-tracing engine and the navigation engine such that the first 3D virtual zone and the second 3D virtual zone appear continuous.

21. The computer-readable medium of claim 17, wherein the plurality of instructions comprises generating the portal in a location common to a displayed image.

22. The computer-readable medium of claim 17, wherein the plurality of instructions comprises:
receiving an input signal by the processor; and
determining a location of the portal based on the input signal.

23. The computer-readable medium of claim 17, wherein the input signal is indicative of a user movement towards a predetermined area of the first 3D virtual space.

24. The computer-implemented method of claim 17, wherein the plurality of instructions comprises:
generating an event and messaging layer;
receiving input by the event and messaging layer; and
performing processing by the event and messaging layer within a predetermined time period.

25. The computer-readable medium of claim 24, wherein the plurality of instructions comprises performing processing by the event and messaging layer within a 35 ms time period.

26. The computer-readable medium of claim 17, wherein the plurality of instructions comprises:
generating an exit zone, wherein the exit zone comprises:
a home portal linking the exit zone to a home zone, wherein the home zone is a zone initially loaded by the processor; and
a map portal linking the exit zone to a map zone, wherein the map zone comprises at least one layout of a currently active zone.

27. A system for constructing a three-dimensional (3D) virtual environment, the system comprising:
a computer comprising:
a processor;
a graphical display; and
a memory, wherein the memory contains instructions for executing a method comprising:
generating, by the processor, a first 3D virtual space;
generating, by the processor, a second 3D virtual space, wherein the first and second 3D virtual spaces are non-adjacent;
linking, by a portal graphics engine, the first and second virtual spaces using a portal;
applying, by the portal graphics engine, one or more corrections for traversing the portal stored in memory, the one or more corrections configured to modify a ray-tracing algorithm and a navigation algorithm such that the first 3D virtual space and the second 3D virtual space such that the non-adjacent first and second virtual 3D spaces interact as a single, continuous 3D virtual space.
